(19) United States
(12) Patent Application Publication
(10) Pub. No.: US 2012/0212789 A1
(43) Pub. Date: Aug. 23, 2012

(54) HOLOGRAM-MOUNTED MEDIUM, ROLL-SHAPED MEDIUM, DETERMINATION DEVICE, HOLOGRAM-MOUNTED MEDIUM PRODUCING APPARATUS, AND INFORMATION DETERMINATION METHOD

(75) Inventors: Akira Shirakura, Tokyo (JP); Takashi Matsubara, Shizuoka (JP)

(73) Assignees: SONY DADC CORPORATION, Tokyo (JP); SONY CORPORATION, Tokyo (JP)

(21) Appl. No.: 13/358,237

(22) Filed: Jan. 25, 2012

(30) Foreign Application Priority Data
Feb. 17, 2011 (JP) 2011-031670

(51) Int. Cl. G03H 1/00

(52) U.S. Cl. 359/2

(57) ABSTRACT

A hologram-mounted medium includes: visually readable identification information that is holographically formed to be visible within a predetermined angular range when illuminated at a predetermined angle; and mechanically readable identification information that is holographically formed to be visible within a predetermined angular range when illuminated at a predetermined angle. The visually readable identification information and the mechanically readable identification information are associated with each other.

### BACKGROUND

The present technology relates to a hologram-mounted medium as a medium on which at least two pieces of identification information are recorded, and in which at least one of the pieces of identification information is holographic identification information, and relates to a roll-shaped medium, a determination device, a hologram-mounted medium producing apparatus, and an information determination method.

Holograms capable of presenting stereoscopic images are used for authentication of credit cards, identification cards, and the like. At present, embossed holograms which record information using surface unevenness of an interference film are widely used. However, the embossed holograms have a problem in that they are easy to counterfeit. In contrast, volume holograms which record interference patterns using differences in the refractive indices in a recording layer are very difficult to counterfeit. The reason is that a sophisticated technique is used to produce a recording image, and also such a recording material is difficult to obtain.

There are two production methods for producing the volume holograms, that is, a real-scene hologram and a holographic stereogram. To produce a real-scene hologram, a laser is illuminated onto an object. In contrast, a holographic stereogram is recorded on the basis of parallax images from multiple viewpoints. The production process of a volume holographic stereogram generally includes a content production step which includes an image acquisition step, an image editing step, and other processing of the acquired images, a hologram master producing step, and a replication (mass production) step. The images are acquired by image capturing or computer graphics. Each of a plurality of images acquired in the image editing step is converted to a strip-shaped image, for example, by a cylindrical lens. The master is produced by sequentially recording interference fringes between the object light and the reference light of the image on a hologram recording medium as strip-shaped elementary holograms. The hologram is replicated (mass-produced) by contact printing using the master. That is, the hologram recording medium is brought into contact with the master, followed by illumination of a laser light beam, whereby the hologram is replicated.

As mentioned above, a volume hologram itself can be replicated by bringing an unexposed hologram recording material into close contact with the master and illuminating a laser having a wavelength close to the recording wavelength to the recording medium. In many cases, for mass production of holograms, the same hologram designs are used for a number of products.

Therefore, it is desirable to provide a superior authentication function and anti-counterfeit ability to the hologram itself so that individual holograms themselves can be differentiated from each other. In this case, it is preferable that the identification information assigned to the holograms in order to identify the individual holograms should be mechanically or visually readable. Moreover, considering the use of holograms, it is preferable to provide a higher level of authentication functions and anti-counterfeit ability to hologram products coupled with the hologram, thus further improving security.

PCT Japanese Translation Patent Publication No. 2005-535469 discloses a technique that makes counterfeiting of hologram products more difficult. According to this technique, codes are recorded or printed on a volume hologram and a document to be protected, and the hologram is bonded to a document on which the same code as that recorded on the hologram is printed. In this way, a document which is reliably protected by the hologram is produced.

### SUMMARY

However, in the technique disclosed in PCT Japanese Translation Patent Publication No. 2005-535469, it is possible only to reliably associate the respective holograms with the corresponding documents and bond the holograms onto the documents by cross-checking and integrating the codes. Moreover, in addition to the fact that the holograms and the documents are integrated with each other on condition that the code recorded on the hologram is associated with the code printed on the document, the processes of producing the holograms, printing the documents, cross-checking the codes, and integrating the document and the hologram with each other are performed in an in-line manner.

Therefore, if the code assigned to the hologram as the additional information is unique identification information such as a consecutive serial number, when a problem occurs during printing of the hologram, a missing number may occur in the serial number. This means that, when the hologram is produced again in order to fill in the missing number, there is a problem in that the additional production results in management errors or additional cost. Moreover, when the apparatus is configured in an in-line manner, a problem may occur if the time to complete the hologram is different from the time to complete the document. That is, the process management is complicated since the time to complete the hologram product is defined by the process which takes the longest time.

It is therefore desirable to provide a hologram-mounted medium, a roll-shaped medium, determination device, a hologram-mounted medium producing apparatus, and an information determination method capable of providing anti-counterfeit ability and convenience by associating identification information recorded in a hologram and identification information recorded in a form different from the corresponding identification information in an integrated medium on which at least two pieces of identification information are recorded.

According to a first embodiment of the present technology, there is provided a hologram-mounted medium which is an integrated medium on which at least two pieces of identification information are recorded.

One of the pieces of identification information is holographic identification information which is visible within a predetermined angular range when illuminated at a predetermined angle.

Preferably, the two or more pieces of identification information include visually readable identification information that is holographically formed to be visible within a predetermined angular range when illuminated at a predetermined angle, and mechanically readable identification information that is holographically formed to be visible within a predetermined angular range when illuminated at a predetermined angle. The visually readable identification information and the mechanically readable identification information are associated with each other.

According to a second embodiment of the present technology, there is provided a roll-shaped medium having a plurality of holograms disposed on a same separator.

The holograms include visually readable identification information that is holographically formed to be visible within a predetermined angular range when illuminated at a predetermined angle, and mechanically readable identification information that is holographically formed to be visible within a predetermined angular range when illuminated at a predetermined angle and that is associated with the visually readable identification information.

According to a third embodiment of the present technology, there is provided an information determination method including the steps of: reading visually readable identification information and mechanically readable identification information from a hologram that includes the visually readable identification information, which is holographically formed to be visible within a predetermined angular range when illuminated at a predetermined angle, and the mechanically readable identification information which is holographically formed to be visible within a predetermined angular range when illuminated at a predetermined angle and that is associated with the visually readable identification information; determining whether or not it is possible to recover the visually readable identification information, which is read, from the mechanically readable identification information, which is read, on the basis of the association between the visually readable identification information and the mechanically readable identification information; and checking whether or not the visually readable identification information which is read is correct data.

According to a fourth embodiment of the present technology, there is provided a hologram-mounted medium producing apparatus including: a light source that illuminates a reproduction illumination light beam at a predetermined angle onto a hologram in which holographic identification information is recorded; an imaging device that captures an image, which is reproduced from the hologram, from a predetermined direction; a recognition section that performs character recognition and/or image recognition on the image captured by the imaging device; an information acquisition section that reads out a medium on which identification information is recorded; a data registration section that generates information associated with pieces of identification information which are obtained from the recognition section and the information acquisition section; a database in which the information generated by the data registration section is registered; and a bonding section that bonds and integrates the hologram onto a medium on which the identification information is recorded.

According to a fifth embodiment of the present technology, there is provided a determination device including: a light source that illuminates a reproduction illumination light beam at a predetermined angle onto a hologram that includes visually readable identification information, which is holographically formed to be visible within a predetermined angular range when illuminated at a predetermined angle, and mechanically readable identification information which is holographically formed to be visible within a predetermined angular range when illuminated at a predetermined angle and that is associated with the visually readable identification information; an imaging device that captures an image, which is reproduced from the hologram, from a predetermined direction; a recognition section that performs character recognition and/or image recognition on the image captured by the imaging device; a determination section that determines whether or not it is possible to recover the visually readable identification information from the mechanically readable identification information which is obtained from the recognition section; and a sorting section that separates a hologram, through which the determination section determines that the visually readable identification information is unrecoverable from the mechanically readable identification information, from a group of holograms through which the determination section determines that the visually readable identification information is recoverable from the mechanically readable identification information.

According to a sixth embodiment of the present technology, there is provided a hologram-mounted medium producing apparatus including: a light source that illuminates a reproduction illumination light beam at a predetermined angle onto a hologram that includes visually readable identification information, which is holographically formed to be visible within a predetermined angular range when illuminated at a predetermined angle, and mechanically readable identification information which is holographically formed to be visible within a predetermined angular range when illuminated at a predetermined angle and that is associated with the visually readable identification information; an imaging device that captures an image, which is reproduced from the hologram, from a predetermined direction; a recognition section that performs character recognition and/or image recognition on the image captured by the imaging device; a determination section that determines whether or not it is possible to recover the visually readable identification information from the mechanically readable identification information which is obtained from the recognition section; a sorting section that separates a hologram, through which the determination section determines that the visually readable identification information is unrecoverable from the mechanically readable identification information, from a group of holograms through which the determination section determines that the visually readable identification information is recoverable from the mechanically readable identification information; and a bonding section that bonds and integrates the hologram, through which it is determined that the visually readable identification information is recoverable from the mechanically readable identification information, onto a medium on which identification information associated with the mechanically readable identification information or the visually readable identification information is recorded.

The holographic identification information which is visible within a predetermined angular range when illuminated at a predetermined angle is read by a prescribed reproduction illumination light beam. The information associated with the read identification information is recorded on the hologram-mounted medium in which the hologram is integrated with a medium on which the identification information is recorded. A viewer of the hologram-mounted medium determines whether or not at least a part of the holographic identification information coincides with at least a part of identification information different from the holographic identification information.

Preferably, the hologram includes the visually readable identification information and the mechanically readable identification information which are associated with each other. The visually readable identification information and the mechanically readable identification information are read by using the prescribed reproduction illumination light beam. By determining whether or not it is possible to recover the read visually readable identification information on the basis of the association from the read mechanically readable identification information, it is checked whether or not the read visually readable identification information is correct data.

According to the at least one example, it is possible to provide an authentication function, which has a higher level than that of the hologram product used in the related art, to the hologram-mounted medium.

### BRIEF DESCRIPTION OF THE DRAWINGS

FIG. 1 is a schematic diagram illustrating an exemplary configuration of a hologram-mounted medium producing apparatus according to a first embodiment of the present technology;

FIG. 2 is a view viewed from the direction of the arrow II in FIG. 1;

FIG. 3 is a perspective view illustrating an exemplary configuration of a hologram supply roll;

FIG. 4 is a schematic sectional view illustrating an example of a layer structure of a hologram which is formed on the hologram supply roll;

FIG. 5 is a diagram illustrating an example of a hologram-mounted medium in which redundant data including hologram identification information in the last four digits and the barcode corresponding thereto are printed;

FIG. 6 is a diagram illustrating an example of a hologram-mounted medium on which printing is performed on both a label and a hologram in a superimposed manner;

FIG. 7 is a schematic diagram illustrating an exemplary configuration of a hologram-mounted medium producing apparatus according to a second embodiment of the present technology;

FIG. 8 is a schematic sectional diagram illustrating an exemplary configuration of a hologram-mounted medium according to the second embodiment of the present technology;

FIG. 9 is a diagram illustrating an example of a hologram-mounted medium in which redundant data including hologram identification information in the last four digits and the two-dimensional barcode corresponding thereto are printed on a label and in which the label is bonded and integrated onto a non-contact IC card;

FIG. 10 is a schematic diagram illustrating an exemplary configuration of a hologram-mounted medium producing apparatus according to a third embodiment of the present technology;

FIG. 11 is a view viewed from the direction of the arrow XI in FIG. 10;

FIG. 12 is a diagram illustrating an example of a hologram-mounted medium in which a hologram having identification information added thereto and a label having a two-dimensional barcode printed thereon are integrated with each other;

FIG. 13 is a schematic diagram illustrating an exemplary configuration of a hologram-mounted medium producing apparatus according to a fourth embodiment of the present technology;

FIG. 14 is a schematic diagram illustrating an exemplary configuration of a hologram-mounted medium producing apparatus according to a fifth embodiment of the present technology;

FIG. 15 is a top plan view illustrating an exemplary configuration of a hologram-mounted medium according to a sixth embodiment of the present technology;

FIG. 16 is a schematic diagram for description of arrangement of a light source of reproduction illumination light, the hologram-mounted medium, and the imaging device;

FIGS. 17A and 17B are schematic diagrams for description of arrangement of the light source of reproduction illumination light, the hologram-mounted medium, and the imaging device;

FIG. 18 is a perspective view illustrating an exemplary configuration of a roll-shaped medium in which a plurality of hologram-mounted media each including the visually readable identification information and the mechanically readable identification information holographically formed are disposed on the same separator;

FIG. 19A is a schematic diagram illustrating an exemplary configuration of a determination device separating a hologram, through which the determination section determines that the visually readable identification information is unrecoverable from the mechanically readable identification information which is mechanically read, from a group of holograms through which the determination section determines that the visually readable identification information is recoverable from the mechanically readable identification information which is mechanically read;

FIG. 19B is a view viewed from the direction of the arrow XIXB in FIG. 19A;

FIG. 20 is a schematic diagram illustrating another exemplary configuration of the determination device;

FIG. 21 is a schematic diagram illustrating an exemplary configuration of a hologram-mounted medium producing apparatus according to a seventh embodiment of the present technology;

FIG. 22 is a schematic diagram illustrating an exemplary configuration of a hologram-mounted medium producing apparatus according to an eighth embodiment of the present technology;

FIG. 23 is a schematic diagram illustrating an exemplary configuration of a hologram-mounted medium according to the eighth embodiment of the present technology;

FIG. 24 is a schematic diagram of the first embodiment of the present technology;

FIG. 25 is a schematic diagram of a modified example of the first embodiment of the present technology;

FIG. 26 is a schematic diagram of the second embodiment of the present technology;

FIG. 27 is a schematic diagram of a modified example of the second embodiment of the present technology;

FIG. 28 is a schematic diagram of the third embodiment of the present technology;

FIG. 29 is a schematic diagram of a modified example of the third embodiment of the present technology;

FIG. 30 is a schematic diagram of the fourth embodiment of the present technology;

FIG. 31 is a schematic diagram of the fifth embodiment of the present technology;

FIG. 32 is a schematic diagram of a modified example of the fifth embodiment of the present technology;

FIG. 33 is a schematic diagram of the sixth embodiment of the present technology;

FIG. 34A is a schematic diagram of the seventh embodiment of the present technology;

FIG. 34B is a schematic diagram of a modified example of the seventh embodiment of the present technology;

FIG. 35A is a schematic diagram of the eighth embodiment of the present technology;

FIG. 35B is a schematic diagram of a modified example of the eighth embodiment of the present technology;

FIG. 36 is a schematic diagram illustrating an exemplary configuration of a holographic stereogram producing system;

FIG. 37 is a schematic diagram for description of an example of image processing at the time of producing a holographic stereogram;

FIGS. 38A and 38B are schematic diagrams illustrating an example of an optical system of a holographic stereogram printing apparatus;

FIGS. 39A and 39B are schematic diagrams illustrating another example of an optical system of the holographic stereogram printing apparatus;

FIG. 40 is a sectional view illustrating an example of a hologram recording medium;

FIGS. 41A, 41B, and 41C are schematic diagrams illustrating a photosensitizing process of a photo-polymerizable photopolymer;

FIG. 42 is a schematic diagram illustrating an exemplary configuration of a recording medium feeding mechanism;

FIG. 43 is a flowchart of an example of an exposure process;

FIG. 44 is a schematic diagram illustrating a configuration of the first embodiment of a replication apparatus for the previously proposed image recording medium;

FIGS. 45A and 45B are schematic diagrams used for general description of a viewing angle;

FIG. 46 is a schematic diagram used for description of a viewing angle in the first embodiment of the previously proposed image recording medium;

FIG. 47 is a schematic diagram illustrating a configuration of a first modified example of the first embodiment of the previously proposed image recording medium;

FIG. 48 is a schematic diagram illustrating a configuration of a second modified example of the first embodiment of the previously proposed image recording medium;

FIGS. 49A and 49B are schematic diagrams illustrating a part of the configuration of the second modified example of the first embodiment of the previously proposed image recording medium;

FIGS. 50A to 50D are schematic diagrams used for description of a viewing angle of a general hologram;

FIGS. 51A to 51C are schematic diagrams used for description of the control of the viewing angle of the image recording medium which was previously proposed by the inventors of the present application;

FIGS. 52A and 52B are schematic diagrams used for description of the control of the viewing angle of the previously proposed image recording medium;

FIG. 53 is a schematic diagram illustrating a configuration of the second embodiment of a replication apparatus for the previously proposed image recording medium;

FIG. 54 is a schematic diagram illustrating a configuration of the third embodiment of a replication apparatus for the previously proposed image recording medium;

FIG. 55 is a schematic diagram illustrating a configuration of the fourth embodiment of a replication apparatus for the previously proposed image recording medium;

FIG. 56 is a schematic diagram illustrating a configuration of the fifth embodiment of a replication apparatus for the previously proposed image recording medium; and

FIGS. 57A to 57C are schematic diagrams used for description of a modified example of the fifth embodiment of a replication apparatus for the previously proposed image recording medium.

### DETAILED DESCRIPTION OF EMBODIMENTS

Hereinafter, modes for carrying out the present technology (hereinafter referred to as embodiments) will be described. The description will be given in order of the following items.

1. First Embodiment

2. Second Embodiment

3. Third Embodiment

4. Fourth Embodiment

5. Fifth Embodiment

6. Sixth Embodiment

7. Seventh Embodiment

8. Eighth Embodiment

9. Modified Example

10. Hologram Storing Additional Information

In addition, although the embodiments described below are specific examples suitable to the present technology, and technically preferable various limitations are given, the scope of the present technology is not limited to the embodiments unless a statement that limits the present technology is provided in the following description.

### 1. First Embodiment

Next, a first embodiment of a hologram-mounted medium and a hologram-mounted medium producing apparatus according to the present technology will be described. In the first embodiment, identification information recorded in a hologram is read by prescribed reproduction illumination light, the hologram is integrated onto a label to produce a hologram-mounted medium, and information associated with the read identification information is printed on the label. A viewer of the hologram-mounted medium is able to determine whether or not at least a part of the identification information recorded on the hologram coincides with at least one of the pieces of information printed on the label. Therefore, according to the first embodiment of the present technology, it is possible to provide a superior authentication function to the hologram-mounted medium. In the following description, printing is defined to include recording of information other than characters.

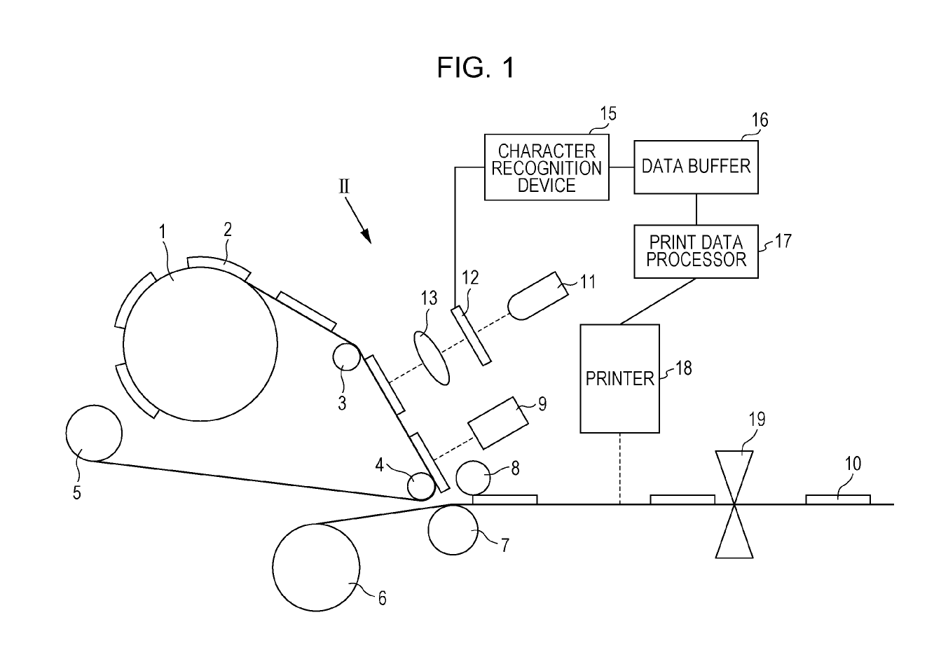

FIG. 1 is a schematic diagram illustrating an exemplary configuration of a hologram-mounted medium producing apparatus according to the first embodiment of the present technology. As shown in FIG. 1, the hologram-mounted medium producing apparatus according to the first embodiment of the present technology includes an illumination-only LED light source 11 (LED: Light Emitting Diode), an imaging device 12, a character recognition device 15 (OCR: Optical Character Recognition), a data buffer 16, a print data processor 17, and a printer 18. A reel-shaped hologram supply roll 1 is one in which adhesive-bonded holograms 2 are formed on a lengthy separator sheet. Each of the holograms 2 has identification information recorded thereon so that the respective holograms can be identified. A reel-shaped carrier supply roll 6 is one in which a label board sheet serving as a carrier of the holograms 2 is rolled in a reel form. Hereinafter, one which is to be combined with the holograms themselves will be appropriately referred to as a carrier.

A hologram which is applied to the embodiment of the present technology is preferably a hologram in which additional information different from a hologram recorded on a hologram master is further recorded when it is replicated from the hologram master, and the additional information is identification information such as unique information (for example, a serial number). More preferably, the hologram is an image recording medium through which additional information is visible within a predetermined range of viewing angles when illuminated at a predetermined angle. The image recording medium is embodied by an image recording medium which was previously proposed by the present inventors, and the image recording medium will be described in detail later. In the description of the embodiment of the present technology given below, the image recording medium is defined as a hologram.

In the first embodiment of the present technology, a hologram-mounted medium producing method includes a step of reading identification information recorded in a hologram, a step of bonding and integrating the hologram onto a label so as to thereby produce a hologram-mounted medium, a step of generating information associated with the identification information read from the hologram, and a step of printing information associated with the read identification information.

Next, the operation of the hologram-mounted medium producing apparatus according to the first embodiment of the present technology will be described with reference to FIG. 1. The holograms 2 are fed out from the hologram supply roll 1, and a separator sheet passes through a positioning roll 3 and a stripping platen roller 4 to be wound around a wind-up roll 5. The stripping platen roller 4 has a small curvature sufficient to separate the holograms 2 from the separator sheet, whereby the holograms 2 move away from the separator sheet towards a label board sheet which is fed out from the carrier supply roll 6. At this time, a feeding amount sensor 9 detects the ends of the holograms 2 so that the holograms 2 can be bonded at prescribed positions of the label supplied from the carrier supply roll 6. The holograms 2 separated from the separator sheet are pressure-bonded by a label bonding platen 7 and a press pinch roller 8 so as to be reliably bonded to the label. After the holograms 2 are bonded to the labels, the printer 18 prints information associated with the identification information recorded on the hologram 2 on the label. A hologram-mounted medium, in which holograms and the label as a carrier are integrated with each other and on which information associated with the identification information recorded on each hologram 2 is printed in the above-mentioned manner, is cut into predetermined dimensions by a cutter 19.

Before the bonding step of integrating the holograms with the label, the illumination-only LED light source 11 illuminates the hologram 2 through a collimator lens 14, which is not shown, with reproduction illumination light 31 having a predetermined wavelength, an incident angle, and a light beam divergence angle. A reproduction light 33 from the hologram 2 passes through an imaging lens 13 and is photoelectrically converted in the imaging device 12. A photoelectrically converted image is converted into text data by the character recognition device 15, and stored in the data butter 16. At this time, the positioning roll 3 and the stripping platen roller 4 maintain the same positional relationship regardless of the residual amount of the hologram supply roll 1.

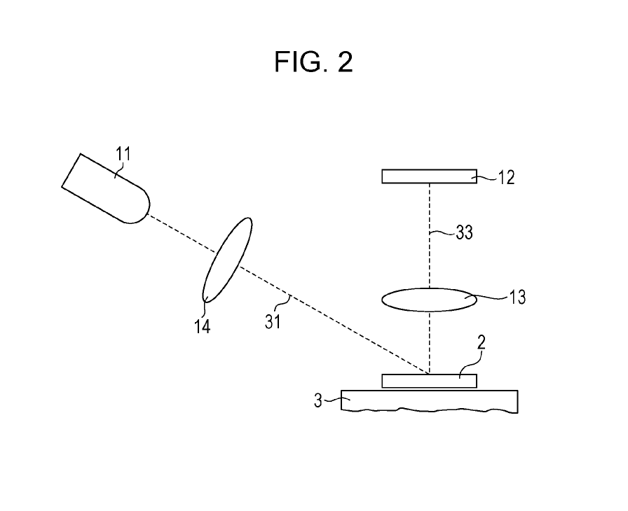

FIG. 2 is a view viewed from the direction of an arrow II in FIG. 1. As shown in FIG. 2, the reproduction illumination light 31 illuminated through the collimator 14 from the illumination-only LED light source 11 is illuminated towards the hologram 2 from a direction in which the identification information recorded on the hologram 2 is appropriately reproduced. That is, the illumination-only LED light source 11, the collimator lens 14, the hologram 2, the imaging lens 13, and the imaging device 12 are arranged such that the reproduction illumination light 31 is illuminated from a direction in which the definition of the identification information as a reproduced image becomes highest, and the identification information is imaged from a direction suitable for viewing.

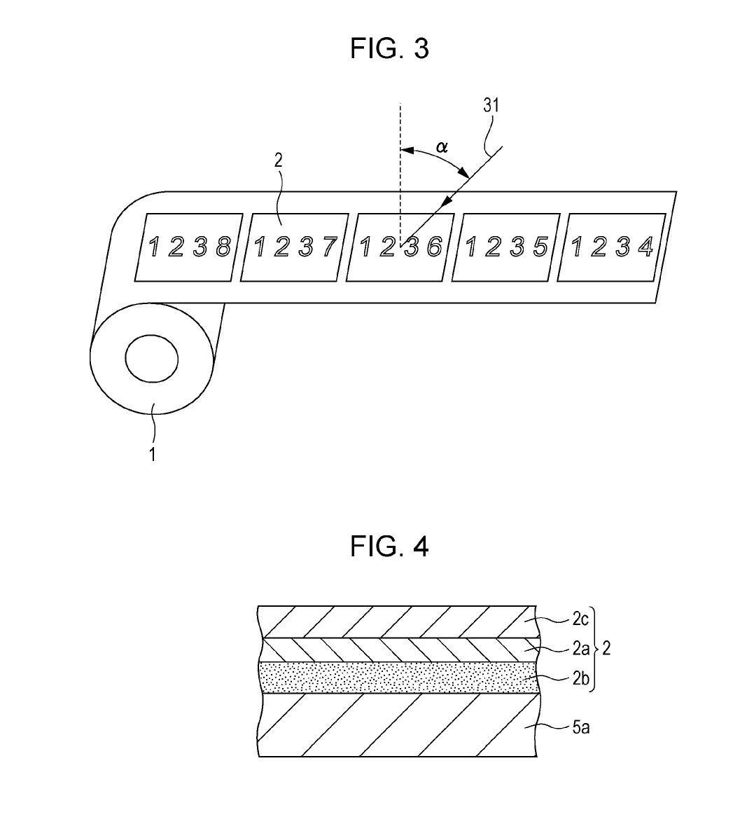

FIG. 3 is a perspective view illustrating an exemplary configuration of the hologram supply roll 1. FIG. 4 is a schematic sectional view illustrating an example of a layer structure of the hologram 2 formed on the hologram supply roll 1. As shown in FIG. 4, for example, the hologram 2 is formed to have a structure in which an adhesive 2b, a hologram recording layer 2a, and a protective layer 2c are laminated in that order on a separator sheet 5a.

As mentioned above, the adhesive-coated hologram 2 is formed on the lengthy separator sheet. In this hologram 2, identification information is recorded as additional information. FIG. 3 shows an example in which an array of 4 digits is recorded as the identification information recorded on the hologram 2. As mentioned above, the reproduction illumination light 31 is illuminated from a direction in which the definition of a reproduced image becomes highest. FIG. 3 shows a state where the reproduction illumination light 31 is illuminated with an angle of α with respect to the normal line of the hologram. Since a high-level recording technique is necessary to record identification information using a holographic means, in many cases, individual pieces of identification (ID) information are recorded in a batch by a special apparatus in order to reduce production costs. Hence, FIG. 3 shows a case where holograms having identification information recorded thereon are supplied in a state of being wound around a reel, but other forms or methods may be used so far as the holograms can be continuously supplied.

After the holograms 2 are bonded to the label, the printer 18 prints the information that is associated with the information stored in the data buffer 16 on the label. For example, when a serial number is recorded on the hologram, the whole serial number itself may be printed, more redundant data partially including the serial number may be printed, or only a part of the serial number may be printed. That is, holograms and labels, which are created individually, are integrated with each other, and are then printed so that they are associated with each other. In such a manner, a hologram-mounted medium 10 according to the first embodiment of the present technology is obtained. The hologram-mounted medium 10 can be used by bonding it to credit cards, identification cards, or the like through, for example, an adhesive or the like.

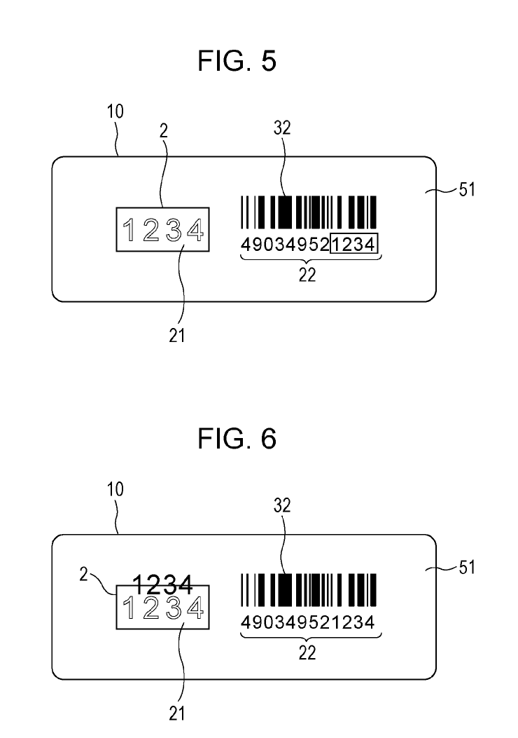

FIG. 5 shows an example of the hologram-mounted medium 10 where redundant data 22, which includes hologram identification information 21 in the last four digits (the last four digits corresponding to the hologram identification information 21 are outlined), and the barcode 32 corresponding thereto are printed on a label 51. Generally, a hologram generally has a small area, and thus the amount of information that can be printed on the hologram is small. Therefore, by increasing the amount of data printed on the label so as to thereby make the data printed on the label mechanically readable through a barcode or a two-dimensional barcode, the convenience of readability is improved. According to the exemplary configuration of the first embodiment of the present technology, it is possible to produce a hologram-mounted medium that satisfies both the anti-counterfeit ability, provided by the holograms which are more difficult to produce than general mass-produced holograms and on which the identification information is recorded, and the convenience provided by mechanically readable data printed thereon. In addition, by allowing users to see that at least a part of the identification information coincides with the data printed on the label, it is possible to provide a superior authentication function to the hologram-mounted medium.

### Modified Example of First Embodiment

The first embodiment of the present technology is not limited to the above-mentioned example, and can be modified into various forms. For example, the hologram supply and the label serving as a carrier are not limited to a roll form, but they may be supplied in a cut sheet form. The label 51 may be formed as a sticker in which an adhesive, a separator sheet, and the like are formed on the rear surface. Besides, the carrier of the holograms 2 is not limited to the label, but may be a document. In this case, holograms and documents which were created at different places may be associated with each other in the future.

The material of the carrier of the holograms 2 is not limited to paper. Resin, metal, glass, or fabric may be used. When resin, metal, or glass is used, embossing or grooving may be used as a form of printing.

The identification information 21 recorded on the hologram 2 may be read after the hologram 2 and the label 51 are integrated with each other.

In the example mentioned above, after the identification information recorded on the hologram 2 is read, the information associated with the information stored in the data buffer 16 is printed on the carrier. However, the order of reading and printing may be reversed. That is, after identification information printed on the carrier is read, information associated with the read identification information may be generated, and the generated information may be recorded on the hologram.

In this case, there are provided a step of forming a carrier with identification information printed thereon, a step of reading the identification information printed on the carrier, a step of generating information associated with the identification information read from the carrier, a step of recording the information associated with the read identification information on the hologram, and a step of bonding and integrating the carrier onto the hologram so as to thereby produce a hologram-mounted medium.

A hologram-mounted medium produced through these steps is the same as the hologram-mounted medium shown in FIG. 5 and is able to provide the same advantages as the hologram-mounted medium 10 of the first embodiment mentioned above. Focusing on the step of bonding and integrating the carrier onto the hologram so as to thereby obtain the hologram-mounted medium, the step may be similar to that disclosed in PCT Japanese Translation Patent Publication No. 2005-535469. However, in the modified example mentioned above, it is not necessary for the steps be performed in an in-line manner. Hence, there is no such problem as the management of the steps being complicated.

The information printed on the label 51 may have no relation to the additional information reproduced from the hologram 2. That is, in terms of producing and supplying the hologram-mounted medium 10, the information, which is to be stored in the data buffer 16, and the information, which is to be printed on the label 51, may have only to be associated with each other, and may not correspond one-to-one with each other. The identification information, which is read from the hologram 2, and the information, which is to be printed on the label 51, may be held in a memory or the like in a table form or the like, or a database thereof may be constructed. In such a manner, encrypted information can be used for one or both of the pieces of information, and thus it is possible to further improve the anti-counterfeit ability. Alternatively, new encryption codes, which are generated from the identification information read from the hologram 2 and the information to be printed on the label 51, may be stored in a database. In such a manner, it is difficult to guess, from the hologram-mounted medium, the encryption information stored at a location distant from the hologram-mounted medium, and thus it is possible to further improve the anti-counterfeit ability. For example, by allowing a prescribed device to read information from a hologram-mounted medium and to perform a query on a database through a network such as the Internet or the like, it is possible to determine whether or not the hologram-mounted medium is authentic using information that does not appear on the hologram-mounted medium. In addition, various methods can be used as the encryption method.

As the printer that prints information on the label 51, it is possible to use various printers, in addition to an inkjet printer, such as a printer that prints information using heat-sensitive paper, a printer that prints information by transferring heat from a heat-sensitive ribbon, a printer that prints information by transferring sublimation heat, and a printer that prints information by forming laser marks. The label itself may be a medium on which information can be rewritten. For example, a heat-sensitive rewritable medium may be used, and in this case, a whole or a part of the identification information recorded on the hologram 2 can be heat-sensitively written in a part of the medium.

Furthermore, as shown in FIG. 6, information may be printed on the label 51 and the hologram 2 in a superimposed manner. In such a manner, the effect of joint sealing is obtained, thereby preventing illegal attempts to peel the hologram 2 off the label 51 to bond it to another label. Moreover, instead of printing data on the label board sheet which is the carrier, data may be printed on the hologram-mounted medium itself, that is on a hologram layer that forms the hologram 2, or on a layer closer to the viewer than the hologram layer or a layer opposite to the viewer-side layer. When the laser marking is performed, the laser marks may be formed inside the hologram-mounted medium as well as on the surface thereof.

### 2. Second Embodiment

Next, a second embodiment of the hologram-mounted medium and the hologram-mounted medium producing apparatus according to the present technology will be described. In the second embodiment, identification information recorded in a hologram is read by the prescribed reproduction illumination light, and the hologram is integrated with an RF (Radio Frequency) tag to produce a hologram-mounted medium, and information associated with the read identification information is written into the RF tag. A viewer of the hologram-mounted medium is able to authenticate the hologram-mounted medium using an RFID (Radio Frequency IDentification) which is already stored in the RF tag. Therefore, according to the second embodiment of the present technology, it is possible to authenticate the hologram-mounted medium the first time that it is read by an RFID reader and provide a sophisticated encrypted authentication system.

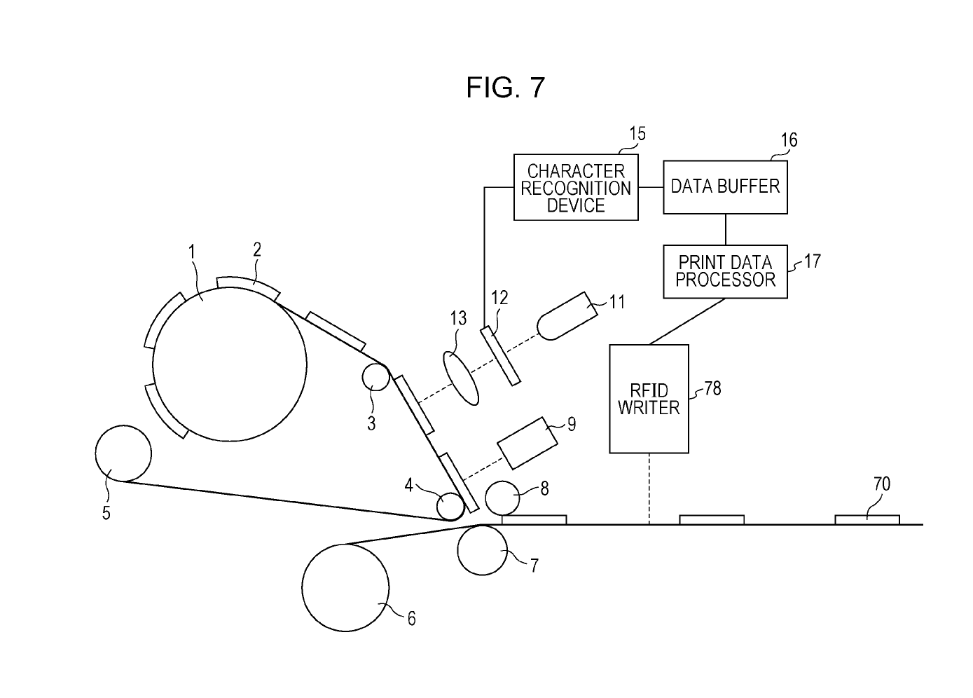

FIG. 7 is a schematic diagram illustrating an exemplary configuration of a hologram-mounted medium producing apparatus according to the second embodiment of the present technology. As shown in FIG. 7, the hologram-mounted medium producing apparatus according to the second embodiment of the present technology is the same as that of the first embodiment in that it includes the illumination-only LED light source 11, the imaging device 12, the character recognition device 15, the data buffer 16, and the print data processor 17. The hologram-mounted medium producing apparatus is different from that of the first embodiment in that it includes an RFID writer 78 instead of the printer 18. In addition to a configuration in which the printer 18 is replaced with the RFID writer 78, a configuration in which the RFID writer 78 is added to the printer 18 may be used. Moreover, from the reel-shaped carrier supply roll 6, instead of the label, an RF tag such as a non-contact IC card (Integrated Circuit card) which is supported on a lengthy separator sheet is continuously supplied. In this case, the non-contact IC card serving as the carrier is not limited to a roll form but may be supplied in a state of being supported on a sheet.

A hologram-mounted medium producing method according to the second embodiment of the present technology includes a step of reading identification information recorded in a hologram, a step of bonding and integrating an RF tag onto the hologram so as to thereby produce a hologram-mounted medium, a step of generating information associated with the identification information read from the hologram, and a step of writing information associated with the read identification information into the RF tag. Similarly to the first embodiment, in the step of reading the identification information recorded on the hologram, it is important to define a light source used for reading information from the hologram and an imaging angle from a prescribed position.

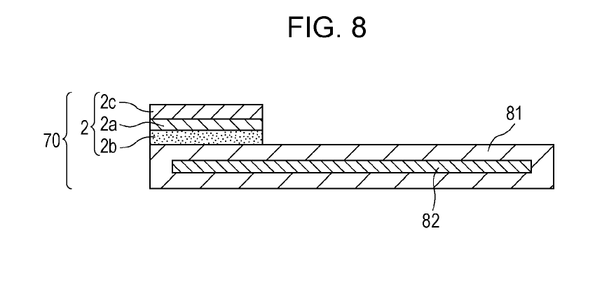

FIG. 8 is a schematic sectional view illustrating an exemplary configuration of a hologram-mounted medium 70 according to the second embodiment of the present technology. As shown in FIG. 8, in the hologram-mounted medium according to the second embodiment of the present technology, the hologram 2 having identification information recorded as additional information is integrated with an RF tag 82 in which information associated with the identification information read from the hologram 2 is written. In this example, the RF tag 82 is embedded in a covering material 81 (for example, resin), and the hologram 2 is bonded onto the covering material 81. By forming a concave portion through milling or the like at a position of the covering material 81 where the hologram 2 is to be bonded, the hologram-mounted medium may be formed to have a flat surface when the hologram 2 is bonded.

Similarly to the first embodiment, the information that is to be stored in the data buffer 16 and the information that is to be written into the RF tag 82 may only be necessary to be associated with each other, and they may not correspond one-to-one with each other. Similarly, new encryption codes may be generated from the information written into the RF tag 82 and the additional information reproduced from the hologram 2. For example, by allowing a user to read information recorded on the RF tag 82 of the hologram-mounted medium 70 using a personal computer having an RFID reader and to perform a query on a database through a network such as the Internet or the like, the user is able to determine whether or not the hologram-mounted medium 70 is authentic using information that does not appear on the hologram-mounted medium.

### Modified Example of Second Embodiment

The second embodiment of the present technology is not limited to the above-mentioned example, and can be modified into various forms. Similarly to the modified example of the first embodiment, a hologram-mounted medium may be produced by reading identification information recorded on an RF tag, generating information associated with the read identification information, recording the generated information on a hologram, and bonding and integrating the RF tag onto the hologram. According to this configuration, it is also possible to authenticate the hologram-mounted medium the first time that it is read by an RFID reader and provide a sophisticatedly encrypted authentication system.

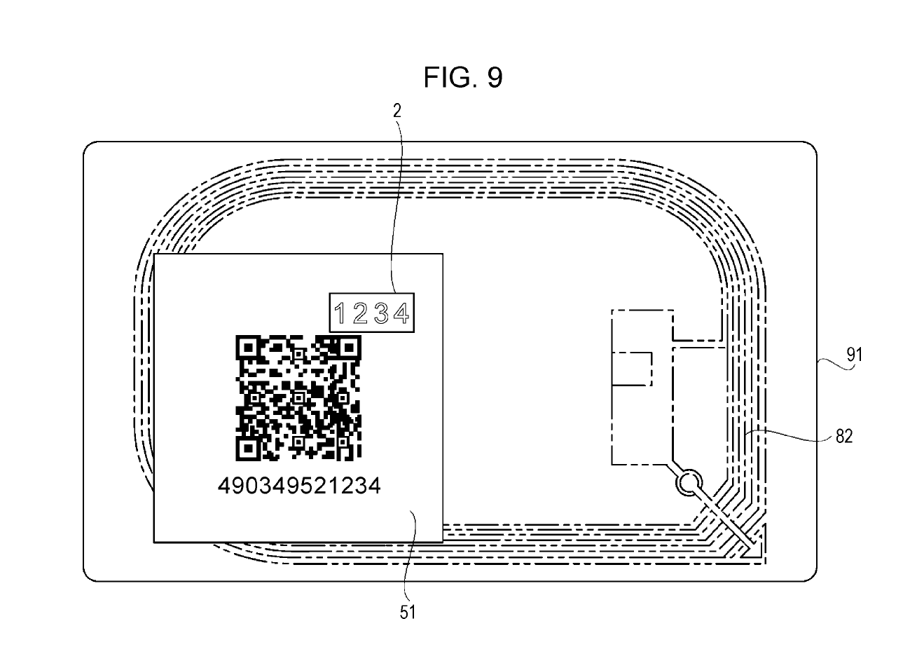

Further, a form which is combined with the first embodiment may be used. FIG. 9 shows an example of a hologram-mounted medium in which redundant data including hologram identification information in the last four digits and the two-dimensional barcode corresponding thereto are printed on a label 51, and to which the label 51 is bonded and integrated onto a non-contact IC card 91. In this example, the hologram-mounted medium can be used as a medium in which the identification information recorded on the hologram 2, the information printed on the two-dimensional barcode, and the information written into the RF tag 82 are combined with each other.

For example, when the hologram-mounted medium according to the second embodiment is used as an identification card or the like, the following usage is possible. A serial number of an issued hologram-mounted medium is recorded on the hologram 2, information such as an issuance number that is to be managed on the provider side of the hologram-mounted medium is recorded on the two-dimensional barcode, and personal information is recorded on the RF tag. When the hologram-mounted medium is configured in the above manner, since the RF tag 82 is embedded in the hologram-mounted medium, a plurality of hologram-mounted media can be read in a batch using an RFID reader. When the hologram-mounted medium having such a configuration is used as an admission ticket to an exhibition or the like, for example, the following usage is possible. Upon receiving the admission ticket, the additional information of the hologram and the redundant data including the hologram identification information printed on the label in the last four digits are cross-checked with the naked eye. Each participant acquires information on the barcode using a barcode reader. The host reads the collected hologram-mounted media in a batch using an RFID reader, thus easily obtaining statistics about the visitors.

Besides, a paper having an RF tag embedded therein may be used as the carrier of the holograms 2. In this case, holograms and documents which were created at different places may be associated with each other in the future. The material in which the RF tag is embedded is not limited to a document but may be a label board sheet. Moreover, when the RF tag is embedded in a part of a product or a package, it is possible to guarantee the authenticity of the product and manage the circulation of the product.

As mentioned above, by making the additional information recorded on the hologram coincide with a part or a whole of the printed data, it is possible to provide a superior authentication function without using other tools. Furthermore it is possible to authenticate the information that is not printed the first time that it is read by an RFID reader and provide a sophisticated encrypted authentication system.

### 3. Third Embodiment

Next, a third embodiment of the hologram-mounted medium and the hologram-mounted medium producing apparatus according to the present technology will be described. In the third embodiment, a hologram is integrated onto a label to produce a hologram-mounted medium, and identification information of the hologram read by the prescribed reproduction illumination light is registered on a database so as to be associated with information read from the label. A viewer of the hologram-mounted medium is able to authenticate the hologram-mounted medium by checking, for example, with the naked eye, the identification information recorded on the hologram and querying the identification information on the database together with the information read from the label using a barcode reader or the like. Therefore, according to the third embodiment of the present technology, it is possible to authenticate the hologram-mounted medium the first time by querying a plurality of kinds of information, which is recorded on the hologram-mounted medium, on the database, and it is possible to provide an authentication function superior to that of a single hologram to the hologram-mounted medium.

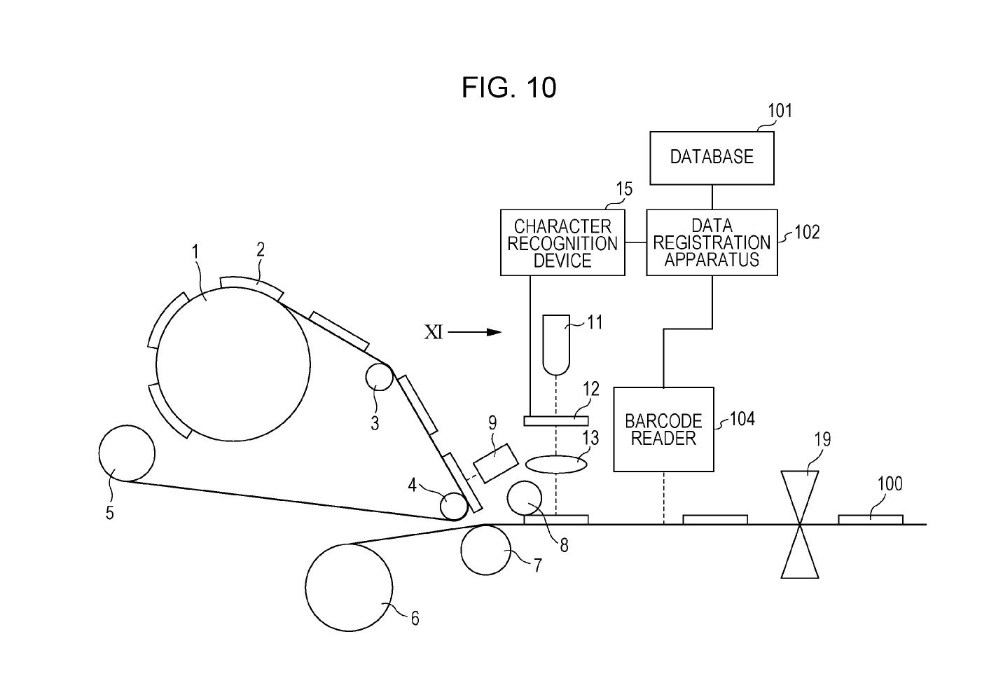

FIG. 10 is a schematic diagram illustrating an exemplary configuration of a hologram-mounted medium producing apparatus according to the third embodiment of the present technology. As shown in FIG. 10, the hologram-mounted medium producing apparatus according to the third embodiment of the present technology is different from that of the first embodiment, in that it includes a data registration device 102 instead of the data buffer 16 and a barcode reader 104 instead of the printer 18 and additionally includes a database 101. Similarly to the first embodiment, from the carrier supply roll 6, a label board sheet serving as the carrier of the holograms 2 is supplied. On the label board sheet, identification information, for example, for identifying individual labels is recorded on a form of a two-dimensional barcode or the like. In this exemplary configuration, after the holograms are integrated with the carrier, the identification information recorded on the hologram is read.

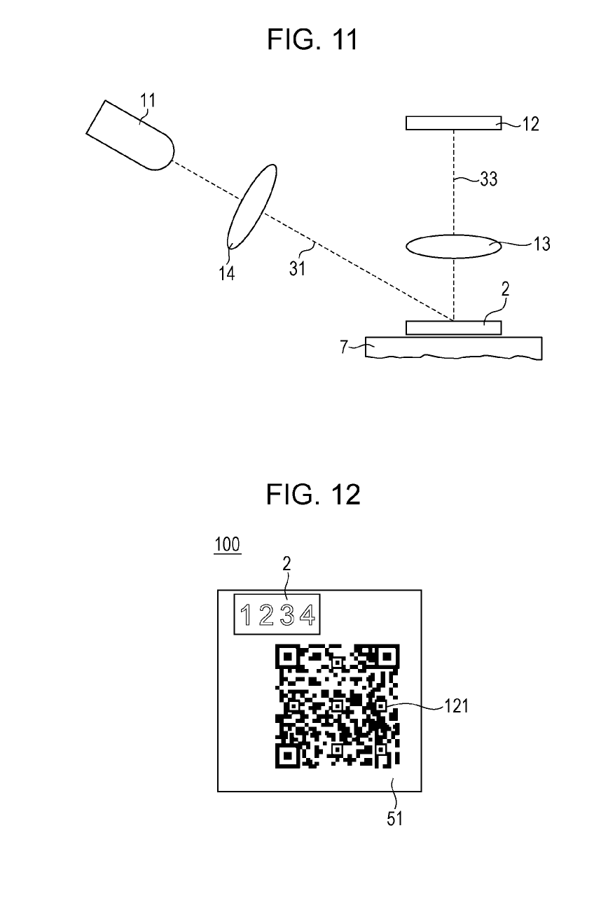

FIG. 11 is a view viewed from the direction of an arrow X in FIG. 10. As shown in FIG. 11, similarly to the first and second embodiments, the reproduction illumination light 31 illuminated through the collimator lens 14 from the illumination-only LED light source 11 is illuminated towards the hologram 2 from a direction in which the identification information recorded on the hologram 2 is appropriately reproduced. That is, the illumination-only LED light source 11, the collimator lens 14, the hologram 2, the imaging lens 13, and the imaging device 12 are arranged such that the reproduction illumination light 31 is illuminated from a direction in which the definition of the identification information which is a reproduced image becomes highest, and the identification information is imaged from a direction suitable for viewing.

A hologram-mounted medium producing method according to the third embodiment of the present technology includes a step of bonding and integrating a label onto a hologram so as to produce a hologram-mounted medium, a step of reading identification information recorded on the hologram, a step of reading identification information recorded on the label, and a step of registering the pieces of identification information read from the hologram and the label on a database in an associated manner. Similarly to the first and second embodiments, in the step of reading the identification information recorded on the hologram, it is important to define a light source used for reading information from the hologram and an imaging angle from a prescribed position.

According to the third embodiment of the present technology, since the identification information recorded on the hologram 2 and the identification information recorded on the label are registered on the database 101 in an associated manner, the hologram and the carrier may be produced individually and may not be associated with each other. That is, the pieces of identification information, which were originally recorded, may not be associated with each other. This means that the hologram-mounted medium is very suitably used for production management and particularly for guaranteeing traceability.

FIG. 12 shows an example of a hologram-mounted medium 100 in which a hologram 2 with identification information and a label 51 with a two-dimensional barcode 121 are integrated with each other. The hologram-mounted medium 100, in which the hologram 2 and the carrier are integrated with each other, can be authenticated by performing a query on the database 101. That is, the identification information recorded on the hologram 2 is checked, for example, with the naked eye, and queried on the database 101 together with the information read by the barcode reader.

### Modified Example of Third Embodiment

The third embodiment of the present technology is not limited to the above-mentioned example, and can be modified into various forms. For example, similarly to the first and second embodiments, encrypted information can be used for one or both of the pieces of identification information read from the hologram and the label, and thus it is possible to further improve the anti-counterfeit ability. Besides, the data registration device may have the function as an encrypter that generates encryption codes from the pieces of identification information read from the hologram and the label. That is, a mapping may be generated from the pieces of identification information read from the hologram and the label and registered on a database. Alternatively, the pieces of identification information read from the hologram and the label may be subjected to an arithmetic operation, and the result of the operation may be registered on the database. The newly generated encryption codes are difficult for a third party to guess from the hologram-mounted medium even when the third party has illegally obtained the hologram-mounted medium.

Further, for example, the number of pieces of identification information recorded on the label is not limited to one. A plurality of two-dimensional barcodes having other information recorded thereon may be printed, and may be combined with a sequence of numbers, characters, or the like, a symbol, a barcode, or the like. In the step of registering the pieces of identification information read from the hologram and the label on the database in an associated manner, they are not necessarily in a one-to-one correspondence but may be in a multiple-to-multiple correspondence. When a plurality of pieces of identification information are recorded on the label, the barcode reader 104 may be substituted with an appropriate reading means corresponding to the form of the printed information or may be combined with other reading means.

It is apparent that the carrier is not limited to the label. The carrier may be a document, and the material of the carrier is not limited to a paper. As for the form of printing, in addition to the form of dots, pores or notches may be formed, and embossing or grooving may be used.

Further, for example, individual IDs of discs may be used as the identification information associated to the identification information of the hologram. That is, when unique identification information is recorded in advance on a Blu-ray Disc (registered trademark), a DVD (Digital Video Disc), a CD (Compact Disc), or the like, information read by a disc player may be associated with the identification information of the hologram. In such a manner, for example, whether or not a recording medium that is to be reproduced is authentic, that is whether or not it is a pirated version, can be queried on the database from a disc player connected to a network. Moreover, for example, an instruction may be sent to the disc player so as not to play back the disc determined to be a pirated version, or billing information may be exchanged between a database and a disc player that plays back a recording medium having a program or music recorded thereon.

### 4. Fourth Embodiment

Next, a fourth embodiment of the hologram-mounted medium and the hologram-mounted medium producing apparatus according to the present technology will be described. In the fourth embodiment, a hologram is integrated with an RF tag to produce a hologram-mounted medium, and identification information of the hologram read by the prescribed reproduction illumination light is registered on a database so as to be associated with information read from the RF tag. A viewer of the hologram-mounted medium is able to authenticate the hologram-mounted medium by checking, for example, with the naked eye, the identification information recorded on the hologram and querying the identification information on the database together with the identification information read by an RFID reader. Therefore, according to the fourth embodiment of the present technology, it is possible to authenticate the hologram-mounted medium the first time by querying a plurality of kinds of information, which is recorded on the hologram-mounted medium, on the database and, it is possible to provide an authentication function superior to that of a single hologram to the hologram-mounted medium.

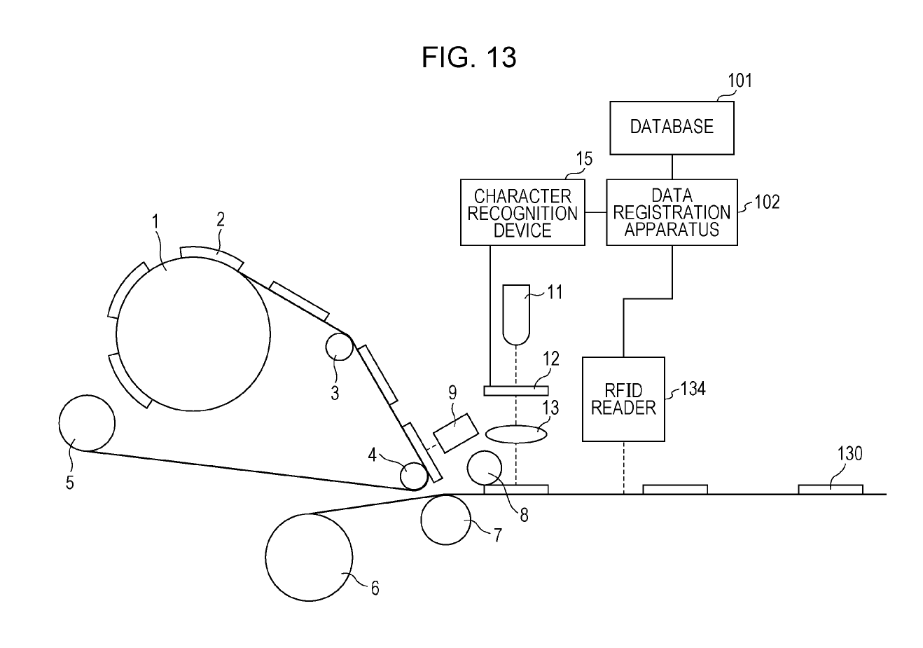

FIG. 13 is a schematic diagram illustrating an exemplary configuration of a hologram-mounted medium producing apparatus according to the fourth embodiment of the present technology. As shown in FIG. 13, the hologram-mounted medium producing apparatus according to the fourth embodiment of the present technology is different from that of the third embodiment, in that it includes an RFID reader 134 instead of the barcode reader 104. In this exemplary configuration, after the holograms are integrated with the carrier, the identification information recorded on the hologram is read.

A hologram-mounted medium producing method according to the fourth embodiment of the present technology includes a step of bonding and integrating an RF tag onto a hologram so as to produce a hologram-mounted medium, a step of reading identification information recorded on the hologram, a step of reading identification information recorded on the RF tag, and a step of registering the pieces of identification information read from the hologram and the RF tag on a database in an associated manner. Similarly to the first to third embodiments, in the step of reading the identification information recorded on the hologram, it is important to define a light source used for reading information from the hologram and an imaging angle from a prescribed position.

According to the fourth embodiment of the present technology, since the identification information recorded on the hologram 2 and the identification information recorded on the RF tag are registered on the database 101 in an associated manner, the hologram and the carrier may be produced individually and may not be associated with each other. That is, the pieces of identification information which were originally recorded on the hologram and the carrier may not be associated with each other. Similarly to the third embodiment, this means that the hologram-mounted medium is very suitably used for production management and particularly for guaranteeing traceability.

A hologram-mounted medium 130 in which the hologram 2 and the carrier are integrated with each other can be authenticated by performing a query on the database 101. That is, the identification information recorded on the hologram 2 is checked, for example, with the naked eye, and queried on the database 101 together with the information read by the RFID reader.

### Modified Example of Fourth Embodiment

The fourth embodiment of the present technology is not limited to the above-mentioned example, and can be modified into various forms. For example, similarly to the first to third embodiments, encrypted information can be used for one or both of the pieces of identification information read from the hologram and the RF tag, and thus it is possible to further improve the anti-counterfeit ability. Besides, the data registration device may have the function as an encrypter that generates encryption codes from the pieces of identification information read from the hologram and the RF tag. That is, a mapping may be generated from the pieces of identification information read from the hologram and the RF tag and registered on a database. Alternatively, the pieces of identification information read from the hologram and the RF tag may be subjected to an arithmetic operation, and the result of the operation may be registered on the database. The newly generated encryption codes are difficult for a third party to guess from the hologram-mounted medium even when the third party has illegally obtained the hologram-mounted medium.

Similarly to the third embodiment, in the step of registering the pieces of identification information read from the hologram and the RF tag on the database in an associated manner, they are not necessarily in a one-to-one correspondence but may be in a multiple-to-multiple correspondence.

### 5. Fifth Embodiment

Next, a fifth embodiment of the hologram-mounted medium and the hologram-mounted medium producing apparatus according to the present technology will be described. In the fifth embodiment, a hologram is integrated with an RF tag to produce a hologram-mounted medium, new information is generated from identification information of the hologram read by the prescribed reproduction illumination light and the information read from the RF tag, and these pieces of identification information are registered on a database in an associated manner. In addition, the newly generated identification information is recorded on the RF tag. A viewer of the hologram-mounted medium is able to authenticate the hologram-mounted medium by checking, for example, with the naked eye, the identification information recorded on the hologram, reading the newly generated identification information using an RFID reader, and querying these pieces of identification information on the database. According to the fifth embodiment of the present technology, the information recorded on the RF tag is different from the information which was originally recorded on the RF tag. Therefore, it is possible to authenticate the hologram-mounted medium the first time by querying a plurality of kinds of information, which is recorded on the hologram-mounted medium, on the database and, it is possible to provide an authentication function superior to that of a single hologram to the hologram-mounted medium.

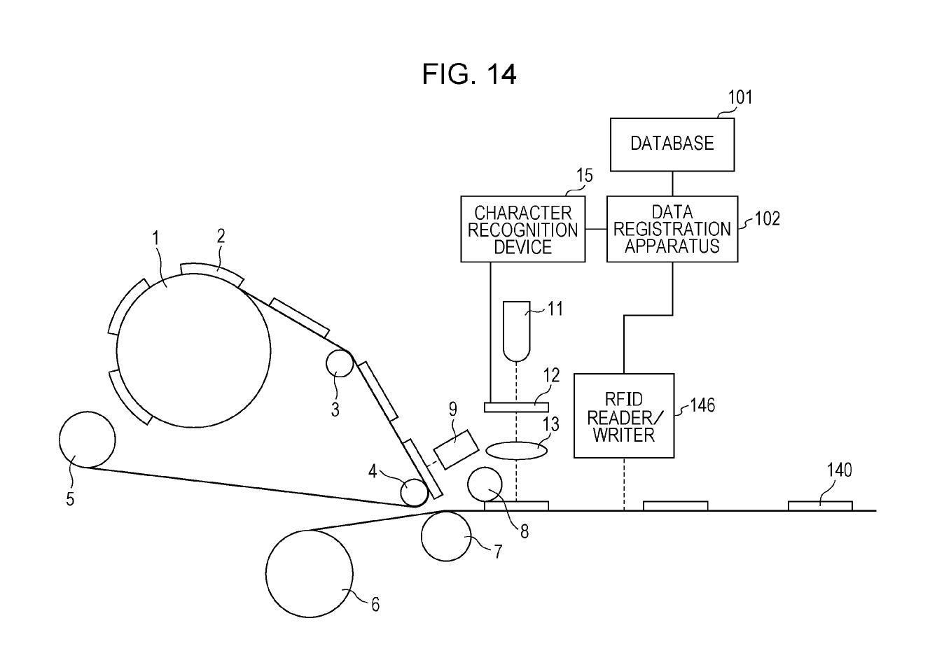

FIG. 14 is a schematic diagram illustrating an exemplary configuration of a hologram-mounted medium producing apparatus according to the fifth embodiment of the present technology. As shown in FIG. 14, the hologram-mounted medium producing apparatus according to the fifth embodiment of the present technology is different from that of the fourth embodiment, in that it includes an RFID reader/writer 146 instead of the RFID reader 134.

A hologram-mounted medium producing method according to the fifth embodiment of the present technology includes a step of bonding and integrating an RF tag onto a hologram so as to produce a hologram-mounted medium, a step of reading identification information recorded on the hologram, a step of reading information recorded on the RF tag, a step of generating information associated with the pieces of information read from the hologram and the RF tag, a step of registering these pieces of information on a database in an associated manner, and a step of writing the associated information into the RF tag. Similarly to the first to fourth embodiments, in the step of reading the identification information recorded on the hologram, it is important to define a light source used for reading information from the hologram and an imaging angle from a prescribed position.

According to the fifth embodiment of the present technology, since the identification information recorded on the hologram 2, the information recorded on the RF tag, and the information newly generated from these pieces of information are registered on the database 101 in an associated manner, the hologram and the carrier may be produced individually and may not be associated with each other. That is, the pieces of identification information which were originally recorded on the hologram and the carrier may not be associated with each other. Similarly to the third and fourth embodiments, this means that the hologram-mounted medium is very suitably used for production management and particularly for guaranteeing traceability.

In a hologram-mounted medium 140 in which the hologram and the carrier are integrated with each other, the information that is newly generated from the identification information recorded on the hologram 2 and the information recorded on the RF tag is rewritten or overwritten. Since these pieces of information are registered on the database 101 in an associated manner, they can be authenticated by performing a query on the database 101. That is, the fifth embodiment provides the same advantages as the fourth embodiment, in that the identification information recorded on the hologram 2 is checked, for example, with the naked eye, and queried on the database 101 together with the information read by the RFID reader.

### Modified Example of Fifth Embodiment

Here, the information written into the RF tag is different from the information which was originally recorded on the RF tag. Accordingly, similarly to the modified example of the third embodiment and the modified example of the fourth embodiment, the data registration device may have the function as an encrypter that generates encryption codes from the pieces of information read from the hologram 2 and the RF tag. In such a manner, it is possible to obtain new advantages. That is, when the encryption codes generated by the encrypter are overwritten and held in the RF tag, it becomes very difficult to guess the information registered on the database 101 from the hologram-mounted medium 140. A plurality of different encryption codes other than the encryption code that is to be written into the RF tag may be generated, associated with each other, and registered on the database 101.

Further, the information newly generated from the identification information recorded on the hologram 2 and the information recorded on the RF tag may be recorded as additional information on a second hologram different from the hologram (hereinafter appropriately referred to as a first hologram) as well as being rewritten or overwritten into the RF tag. The second hologram may be produced in a step or place different from the step or place where the hologram and the RF tag are integrated with each other so as to produce the hologram-mounted medium. Thus, it becomes very difficult to guess the information added to the second hologram which is produced in a different place from the identification information of the first hologram.

Accordingly, a hologram-mounted medium in which the second hologram is additionally combined with the hologram-mounted medium in which the first hologram and the RF tag are integrated with other will have very strong anti-counterfeit ability and an authentication function. The reason is that the information read from the hologram-mounted medium and the information that is to be recorded on the hologram-mounted medium can be associated in a multiple-to-multiple correspondence and registered on the database. It is apparent that the number of holograms is not limited to two but may be any number.

As mentioned above, the fifth embodiment of the present technology is not limited to the above-mentioned example, and can be modified into various forms. Since the information recorded on the RF tag can be rewritten in various stages, the hologram-mounted medium using the RF tag can be suitably used for a product which falls into the hands of many and unspecified persons, or which is produced through a number of steps.

The hologram-mounted medium 140 according to the fifth embodiment of the present technology can be applied to a craft product as well as a product made by mass production. For example, when the hologram-mounted medium is applied to a painting, an RF tag may be embedded in an expendable item such as a canvas sheet, and a hologram 2 having identification information recorded thereon may be bonded to the rear surface of the canvas sheet in a form such that the hologram 2 is not easily separated. If the RF tag has a dimension of about 1 mm or less, the RF tag may be embedded in a part of the painting together with the paint. The artist generates an encryption code from information determined by him or her in regard to the completed painting and the identification information recorded on the hologram 2 and records the encryption code in the RF tag using an RFID writer. These pieces of information are associated with each other and registered on the database 101. In such a manner, it is possible to determine whether or not the painting is authentic at the first time on the basis of the specific information belonging to the artist. That is, since the information recorded on the RF tag is rewritable, by writing new encryption codes whenever the owner of the painting is changed, it is possible to facilitate reliable appraisal and a history of verification.

### 6. Sixth Embodiment

Next, a sixth embodiment of the hologram-mounted medium according to the present technology will be described. As described in the first to fifth embodiments, the present technology relates to a medium on which at least two pieces of identification information are recorded, and at least one of the two pieces of the identification information is holographic identification information. In the sixth embodiment, two or more pieces of identification information, which are recorded on the medium, include at least two pieces of holographic identification information. One of the holographic identification information pieces is identification information having a visually verifiable form, and the other is recorded in a form different from the visually verifiable form. Here, the visually verifiable form is, for example, a form through which a viewer is able to recognize contents of the information with naked eye exemplified in the serial number. Further, if the form of the identification information is different from the visually verifiable form, this means that a machine is necessary to verify the information. The identification information, which is recorded in the visually verifiable form, and the identification information, for which a machine is necessary to verify, are associated with each other. In the following description, the identification information, which can be checked with naked eye, is appropriately referred to as visually readable identification information. Further, the identification information (except the visually readable identification information), which a machine is necessary to verify, is appropriately referred to as mechanically readable identification information.

According to the first to fifth embodiments, producers and consumers are able to track the processes of producing products and the distribution processes thereof and check whether or not products are authentic. In order to use the hologram-mounted media as a tracking system (track & trace system) by setting the information recorded in the hologram as unique identification information, it is the premise that the visually readable identification information such as the serial number recorded on the hologram is correct and mechanically readable. In other words, it is the premise that there is no discrepancy between the visually readable identification information, which is read by a machine, and the visually readable identification information which is checked with naked eye by a viewer of the hologram-mounted medium.

As one of the reason why the discrepancy arises between the visually readable identification information which is read by a machine and the visually readable identification information which is checked with naked eye by a viewer of the hologram-mounted medium, there is erroneous conversion at the time of performing image recognition of the identification information which is reproduced from the hologram. For example, in the process of optical character recognition (OCR), through pattern matching or structure analysis, the similarity with the registered fonts is determined, but erroneous conversion may occur in accordance with the similarity with the registered fonts.

Accordingly, before shipment of the hologram-mounted medium, it is preferable to check whether or not the visually readable identification information recorded in the hologram is correct and is mechanically readable, and whether or not the visually readable identification information read by a machine is incorrect. Further, if there is a hologram in which the recorded visually readable identification information is correct but is unreadable by a machine, it is preferable to study a countermeasure for preventing defective products from being shipped in the process of producing the hologram-mounted medium so as not to use the hologram.

Here, the identification information recorded in the hologram is mechanically readable identification information, for example, a form of a two-dimensional barcode, and check digits are set in the two-dimensional barcode. Hence, there is a low probability that the read data is incorrect data. Accordingly, it is considered that, similarly to the two-dimensional barcode, check digits are set in the visually readable identification information which is recorded in the hologram. However, if the visually readable identification information recorded in the hologram has a form of characters or numbers like for example a serial number, although convenience is improved, an amount of recordable information is greatly restricted, and thus it may be difficult to set the check digits in the visually readable identification information.

Therefore, in the sixth embodiment, the hologram-mounted medium includes at least two pieces of holographic identification information. One of the holographic identification information pieces is visually readable identification information, and the other one is mechanically readable identification information. The visually readable identification information and the mechanically readable identification information are made to be visible within a predetermined angular range when illuminated at a predetermined angle. The visually readable identification information and the mechanically readable identification information are associated with each other. As for the association, for example, at least a part of the mechanically readable identification information is made to coincide with at least a part of the visually readable identification information. The visually readable identification information and the mechanically readable identification information included in the hologram are reproduced by a prescribed reproduction illumination light beam. The reproduced holographic identification information is image-captured by an imaging device or the like. By performing character recognition and/or image recognition on the holographic identification information which is image-captured by the imaging device or the like, the visually readable identification information and the mechanically readable identification information is read. By cross-checking the read visually readable identification information and mechanically readable identification information, from the read mechanically readable identification information, it is determined whether or not the read visually readable identification information is recoverable. On the basis of the determination, the read mechanically readable identification information is sorted into information from which the read visually readable identification information is recoverable and information from which the read visually readable identification information is unrecoverable. That is, by making the mechanically readable identification information have the function of the check digits of the visually readable identification information, it is determined whether or not the visually readable identification information which is read from the hologram-mounted medium is correct data. Therefore, according to the sixth embodiment of the present technology, it is possible to guarantee that there is no discrepancy between the visually readable identification information, which is read by a machine, and the visually readable identification information, which is checked with naked eye by a viewer of the hologram-mounted medium. Further, it is possible to prevent the hologram-mounted media, in which the identification information is correct but mechanically unreadable, from being shipped, and thus it is possible to reliably use hologram-mounted media as a tracking system.

Hologram-Mounted Medium

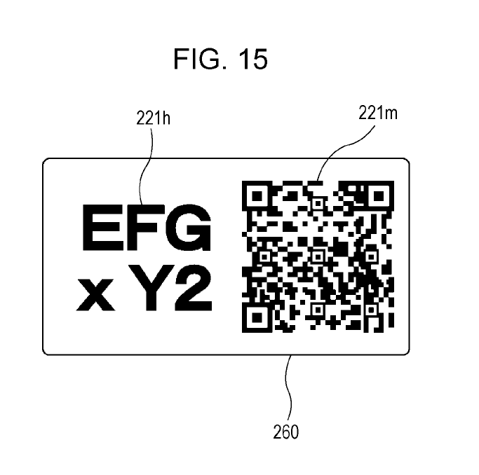

FIG. 15 is a top plan view illustrating an exemplary configuration of a hologram-mounted medium according to a sixth embodiment of the present technology. The exemplary configuration of a hologram-mounted medium 260 shown in FIG. 15 is a medium in which at least two or more pieces of identification information are recorded. In the example, visually readable identification information 221h and mechanically readable identification information 221m are recorded in the same hologram. In addition, FIG. 15 shows an example in which the visually readable identification information 221h and mechanically readable identification information 221m are horizontally arranged. However, the arrangement of the visually readable identification information 221h and mechanically readable identification information 221m is not limited to this example.

Examples of the visually readable identification information 221h recorded in the hologram-mounted medium 260 include numerals, characters, and the like arranged in sequence, and thus may include signs and figures. In addition, similarly to the first to fifth embodiments, the visually readable identification information 221h is unique identification information. In the exemplary configuration shown in FIG. 15, a character string “EFGxY2” as the visually readable identification information 221h is recorded on the hologram-mounted medium 260.

Examples of the mechanically readable identification information 221m recorded on the hologram-mounted medium 260 includes an one-dimensional barcode, a two-dimensional barcode, and the like. In the exemplary configuration shown in FIG. 15, a two-dimensional barcode as the mechanically readable identification information 221m is recorded on the hologram-mounted medium 260.

The visually readable identification information 221h and the mechanically readable identification information 221m, which are recorded on the hologram-mounted medium 260, are associated with each other. For example, at least a part of the mechanically readable identification information 221m is made to coincide with at least a part of the visually readable identification information 221h. Specifically, for example, the two-dimensional barcode as the mechanically readable identification information 221m is recorded to represent numbers, and is recorded such that the number at the end thereof coincides with the last number of the character string “EFGxY2” recorded as the visually readable identification information 221h. Besides, the information obtained by decoding the two-dimensional barcode may include the character string “EFGxY2”. Alternatively, making association using a computational expression is considered as a method for recovering at least a part of the visually readable identification information 221h from the information which is obtained by decoding the two-dimensional barcode. It is apparent that the visually readable identification information 221h may be associated with the mechanically readable identification information 221m through an encryption process.

The visually readable identification information 221h and the mechanically readable identification information 221m, which are recorded in the hologram-mounted medium 260, are associated with each other. Hence, it is possible to cross-check the visually readable identification information 221h and the mechanically readable identification information 221m which are reproduced by the prescribed reproduction illumination light from the hologram-mounted medium 260. By cross-checking the visually readable identification information 221h and the mechanically readable identification information 221m which are acquired by the imaging device or the like, from the mechanically readable identification information 221m which is read, it is possible to determine whether or not the read visually readable identification information 221h is recoverable. That is, by making the mechanically readable identification information 221m function as the check digits of the visually readable identification information 221h, it is possible to determine whether or not the visually readable identification information 221h which is read from the hologram-mounted medium 260 is correct data.

Therefore, according to the sixth embodiment, the mechanically readable identification information 221m can be made to function as the check digits of the visually readable identification information 221h. Hence, it is possible to determine whether or not the visually readable identification information 221h which is read from the hologram-mounted medium 260 is correct data. Further, it is possible to perform off-line the determination as to whether or not the visually readable identification information 221h which is read from the hologram-mounted medium 260 is correct data, even when a list of the data recorded in the hologram does not reside.

In addition, as described in the first to fifth embodiment, the holographic identification information is constructed such that additional information is visible within a predetermined angular range when illuminated at a predetermined angle. The hologram-mounted medium 260 according to the sixth embodiment includes two holographic identification information pieces of the visually readable identification information 221h and the mechanically readable identification information 221m. Here, it is preferable that the visually readable identification information 221h and mechanically readable identification information 221m should be recorded to be reproduced in the predetermined angular ranges including the same angular direction when illuminated by the same reproduction illumination light beams. In addition, the term “the reproduction illumination light beams are same” means that the illumination directions of the reproduction illumination light beams are the same. Here, the wavelengths of the reproduction illumination light beams may be not necessarily the same. As the reproduction illumination light beam, the light of a light source, such as an LED, a fluorescent lamp, a halogen lamp, a xenon lamp, or a krypton lamp, including various wavelength components of visible light may be used. In this case, even when the wavelengths of the reproduction illumination light beams are not necessarily the same, it is possible to capture an image thereof by viewing the hologram in the same direction.

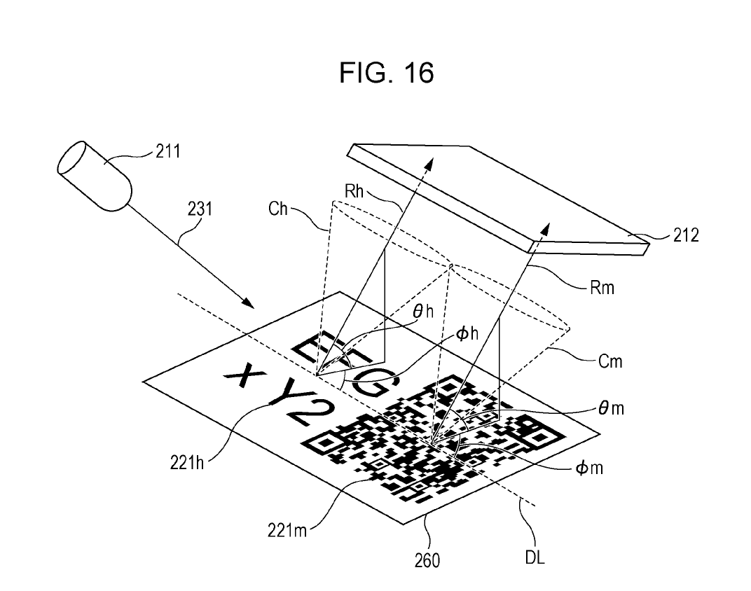

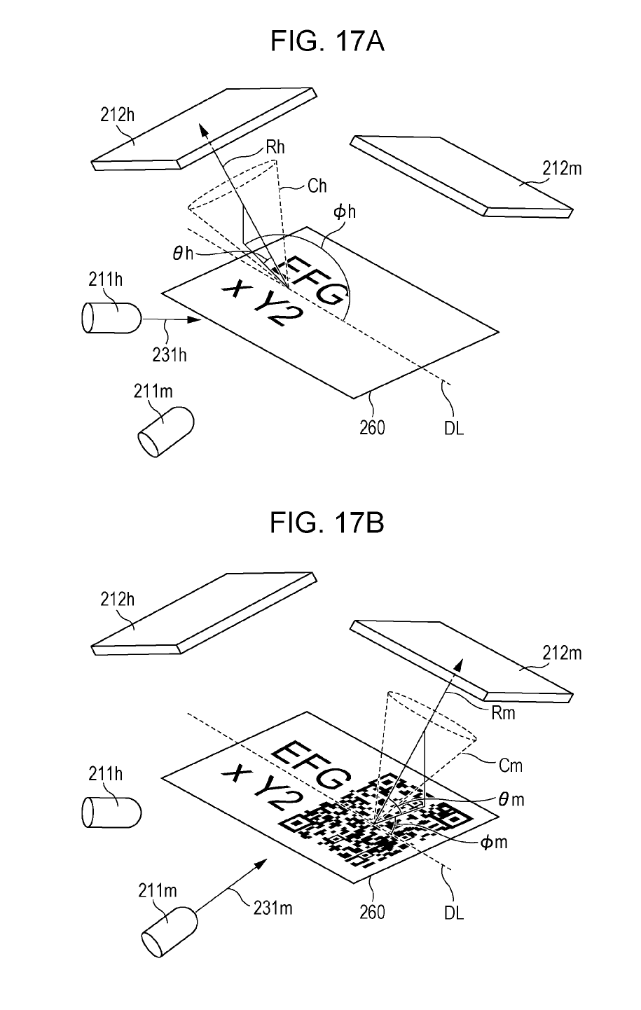

FIGS. 16 and 17 are schematic diagrams for description of arrangement of the light source of reproduction illumination light, the hologram-mounted medium, and the imaging device. As shown in FIG. 16, similarly to the first to fifth embodiments, for example, the reproduction illumination light beam 231 is laminated onto the hologram-mounted medium 260 from an illumination-only LED light source 211.

In FIG. 16, the range, in which the visually readable identification information 221h is visible when the reproduction illumination light beam 231 is illuminated, is assumed as the circular cone Ch, and the arrow along the same direction as the axis of the circular cone Ch schematically represents reproduction light Rh. It is the same for the light Rm which is reproduced from the mechanically readable identification information 221m. At the time, for example, the direction of the arrow Rh (hereinafter referred to as the reproduction light Rh) is defined as an angular direction in which the luminance of the light reproduced from the visually readable identification information 221h is set to the maximum. As shown in FIG. 16, the direction of the reproduction light Rh is represented by a group (φh, θh) of the angle θh on the plane of the hologram-mounted medium 260 and the angle θh measured from the plane of the hologram-mounted medium 260. The angle θh is, when the straight line DL along a certain direction on the plane of the hologram-mounted medium 260 is assumed, an angle formed between the straight line DL and the projection of the reproduction light Rh on the plane of the hologram-mounted medium 260. The angle θh is an angle formed between the reproduction light Rh and the projection of the reproduction light Rh on the plane of the hologram-mounted medium 260.

When the reproduction illumination light beam 231 is illuminated onto the hologram-mounted medium 260 from the direction appropriate to reproduce the identification information recorded in the hologram, in the predetermined angular ranges including the same angular direction, the visually readable identification information 221h and the mechanically readable identification information 221m are reproduced. For example, φh=φm and θh=θm. In this case, by illuminating the same reproduction illumination light beam 231, the visually readable identification information 221h and mechanically readable identification information 221m are image-captured at the same time by a single imaging device 212.

Alternatively, when illuminated by a different reproduction illumination light beam, the visually readable identification information 221h and the mechanically readable identification information 221m may be recorded to be reproduced within the predetermined angular ranges centered on different angular directions. As shown in FIG. 17A, from the direction appropriate to reproduce the visually readable identification information 221h, the reproduction illumination light beam 231h, which is originated from the illumination-only LED light source 211h, is illuminated onto the hologram-mounted medium 260. The visually readable identification information 221h is reproduced in the predetermined range centered on a certain angular direction (φh, θh). Further, as shown in FIG. 17B, from the direction appropriate to reproduce the mechanically readable identification information 221m, the reproduction illumination light beam 231m, which is originated from the illumination-only LED light source 211m, is illuminated onto the hologram-mounted medium 260. The mechanically readable identification information 221m is reproduced in the predetermined angular range centered on a certain angular direction (φm, θm). In this case, the imaging devices 212h and 212m are disposed to correspond to the respective angular directions in which the visually readable identification information 221h and the mechanically readable identification information 221m are reproduced, and thus the reproduction illumination light beam 231h and the reproduction illumination light beam 231m are illuminated at different timings. Accordingly, it is possible to reliably image-capture the respective visually readable identification information 221h and mechanically readable identification information 221m.

Besides, when the visually readable identification information 221h and mechanically readable identification information 221m are illuminated by the same reproduction illumination light beams, the recording is performed such that the information pieces are reproduced in the predetermined angular ranges centered on different angular directions. For example, similarly to the case shown in FIG. 16, when the reproduction illumination light beam 231 originated from the illumination-only LED light source 211 is illuminated onto the hologram-mounted medium 260, the visually readable identification information 221h and mechanically readable identification information 221m are reproduced at the same time. The visually readable identification information 221h is reproduced in the predetermined range centered on the certain angular direction (φh, θh), and the mechanically readable identification information 221m is reproduced in the predetermined angular range centered on a certain angular direction (φm, θm). At this time, it is assumed that (φh, θh)≠(φm, θm), and thus the imaging devices 212h and 212m are disposed to correspond to the respective angular directions in which the visually readable identification information 221h and mechanically readable identification information 221m are reproduced. In this case, it is necessary to arrange a plurality of the imaging devices corresponding to the respective angular directions in which the visually readable identification information 221h and mechanically readable identification information 221m are reproduced. However, it is possible to image-capture the visually readable identification information 221h and mechanically readable identification information 221m through one illumination.

Alternatively, when illuminated by a different reproduction illumination light beam, the visually readable identification information 221h and the mechanically readable identification information 221m may be recorded to be reproduced within the predetermined angular ranges including the same angular direction. For example, as shown in FIG. 17A, from the direction appropriate to reproduce the visually readable identification information 221h, the reproduction illumination light beam 231h, which is originated from the illumination-only LED light source 211h, is illuminated onto the hologram-mounted medium 260. Further, as shown in FIG. 17B, from the direction appropriate to reproduce the mechanically readable identification information 221m, the reproduction illumination light beam 231m, which is originated from the illumination-only LED light source 211m, is illuminated onto the hologram-mounted medium 260. The visually readable identification information 221h is reproduced in the predetermined range centered on a certain angular direction (φh, θh). The mechanically readable identification information 221m is reproduced in the predetermined angular range centered on a certain angular direction (φm, θm). At this time, similarly to the case shown in FIG. 16, for example, it is assumed that φh=φm and θh=θm. In this case, the reproduction illumination light beam for reproducing the visually readable identification information 221h and the reproduction illumination light beam for reproducing the mechanically readable identification information 221m are illuminated at different timings. However, it is possible to image-capture the visually readable identification information 221h and mechanically readable identification information 221m through a single imaging device.

The relationship between the illumination direction of the reproduction illumination light beam and a reproduced image of the visually readable identification information or the mechanically readable identification information can be adjusted by a condition for recording the hologram with the visually readable identification information or the mechanically readable identification information. For example, if the signal light beams for the visually readable identification information and the mechanically readable identification information have the same direction with respect to the reference light at the time of recording the hologram, the visually readable identification information and the mechanically readable identification information are made to have the same angular directions with respect to the same reproduction illumination light beams.

Roll-Shaped Medium

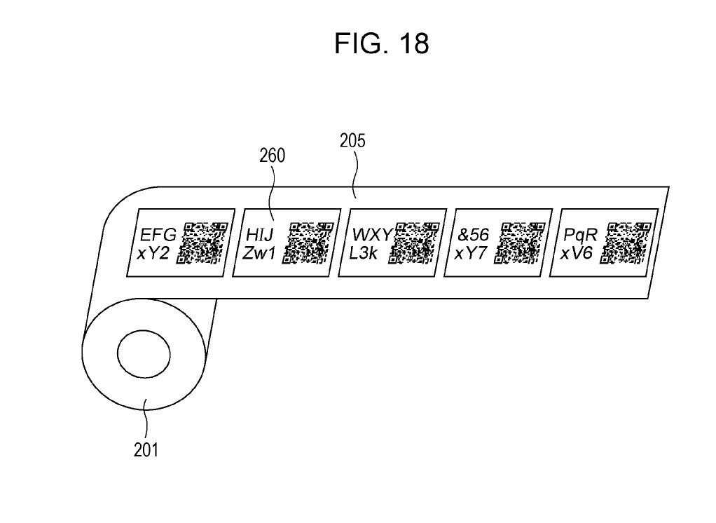

FIG. 18 is a perspective view illustrating an exemplary configuration of a roll-shaped medium in which a plurality of hologram-mounted media each including the visually readable identification information and the mechanically readable identification information holographically formed are disposed on the same separator. In the example shown in FIG. 18, a plurality of hologram-mounted media 260 is arranged on the lengthy separator sheet 205 with an adhesive interposed therebetween, thereby forming a roll-shaped medium 201. As shown in FIG. 18, the hologram-mounted medium 260 may be formed as a hologram sticker in which the visually readable identification information and the mechanically readable identification information are recorded on the same hologram. At this time, for example, similarly to the example of the layer structure of the hologram shown in FIG. 4, the hologram-mounted medium has a structure in which an adhesive, a hologram recording layer, and a protective layer are laminated in this order.

Determination Device

As mentioned above, according to the hologram-mounted medium of the sixth embodiment, it is possible to determine whether or not the visually readable identification information 221h which is read from the hologram-mounted medium 260 is correct data. Here, on the basis of the determination result, it is preferable to prevent shipment of hologram-mounted media in which the visually readable identification information is correct but mechanically unreadable, that is, hologram-mounted media through which the visually readable identification information is unrecoverable from the mechanically readable identification information which is mechanically read.

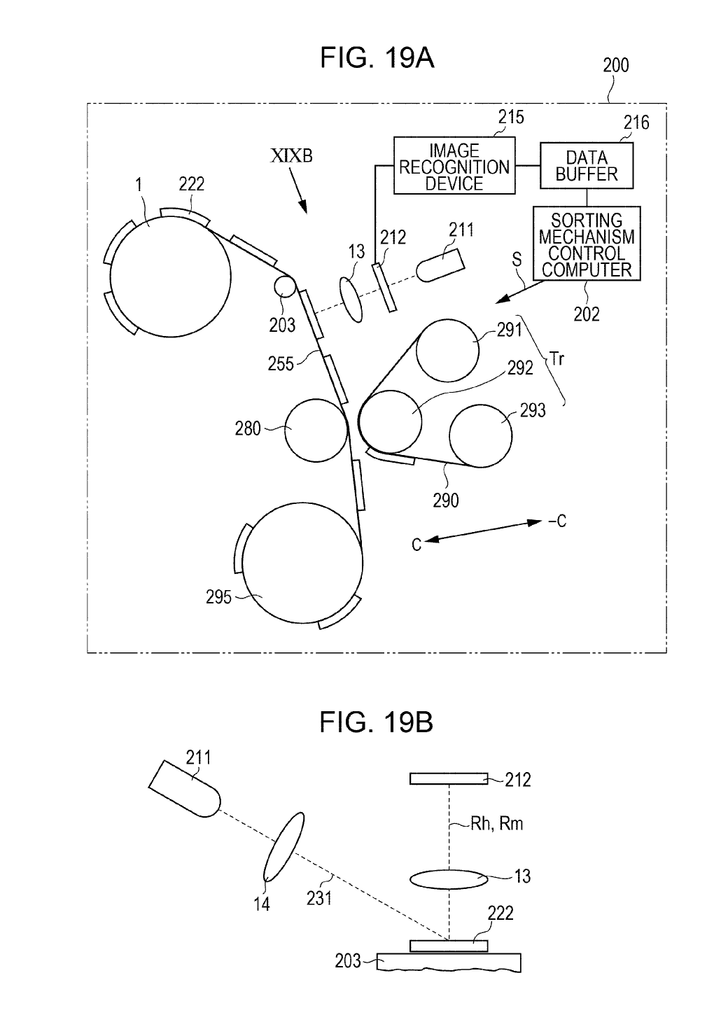

FIG. 19A is a schematic diagram illustrating an exemplary configuration of the determination device separating a hologram, through which the determination section determines that the visually readable identification information is unrecoverable from the mechanically readable identification information which is mechanically read, from a group of holograms through which the determination section determines that the visually readable identification information is recoverable from the mechanically readable identification information which is mechanically read. FIG. 19B is a view viewed from the direction of the arrow XIXB in FIG. 19A.

As shown in FIG. 19, the determination device 200 (indicated by the chain double-dashed line) includes the illumination-only LED light source 211, the imaging device 212, an image recognition device 215, a data buffer 216, and a sorting mechanism control computer 202. Further, the determination device 200 includes, as a sorting mechanism, a group Tr of a stripping tape feeding roll 291, a defect stripping roller 292, and a stripping tape wind-up roll 293. Although not shown in the drawings, the roll group Tr is configured to be supported by a supporting member such as a guiding rail, and to be reciprocated along the supporting member by a mechanical method using a stepping motor or the like. The movement direction of the roll group Tr is, for example, a direction (in FIG. 19A, the C direction of the arrow, or -C direction) in which a defect stripping roller 292 shown in FIG. 19A approaches to a defect stripping platen roller 280 or a direction in which the defect stripping roller 292 is separated therefrom.

From the stripping tape feeding roll 291, a ripping tape 290 is fed out, and thus the stripping tape 290 is stretched around the defect stripping roller 292, and is subsequently wound around the stripping tape wind-up roll 293. An adhesive, of which the peeling strength is larger than that of the adhesive for providing holograms 222 on the separator 255, is formed on the surface of the sheet on a side of the stripping tape 290 opposite to a side with which the circumferential surface of the defect stripping roller 292 is in contact.

Next, an operation of the determination device will be described with reference to FIG. 19A. The holograms 222 are fed out from the hologram supply roll 1, and the separator 255 is wound around a selected-product wind-up roll 295 through the positioning roll 203 and the defect stripping platen roller 280. As the hologram supply roll 1, for example, it is possible to use the roll-shaped medium 201 shown in FIG. 18. However, if the holograms can be continuously supplied, other shapes such as a sheet shape and other methods may be used.

During the time until each hologram 222 fed out from the hologram supply roll 1 together with the separator 255 reaches the defect stripping platen roller 280, the visually readable identification information and the mechanically readable identification information, which are recorded on the hologram 222, are acquired. Similarly to the first to fifth embodiments mentioned above, from the illumination-only LED light source 211, the reproduction illumination light beam 231, which has a predetermined wavelength, an incident angle, and a light beam divergence angle, is illuminated onto the hologram 222 through the collimator lens 14 which is not shown in the drawing.

Here, for example, the visually readable identification information and mechanically readable identification information, which are recorded on the hologram 222, are recorded to be reproduced in the predetermined angular ranges including the same angular direction when illuminated by the same reproduction illumination light beams. At this time, by illuminating the reproduction illumination light beam 231, the visually readable identification information and the mechanically readable identification information are reproduced from the hologram 222 at the same time, and the reproduction light Rh of the visually readable identification information and the reproduction light Rm of the mechanically readable identification information are incident on the imaging device 212 through the imaging lens 13. The reproduction light beams Rh and Rm incident on the imaging device 212 are photoelectrically converted into, for example, text data by the image recognition device 215, and the data can be stored in the data buffer 216. In addition, the image recognition device 215 also has a function of the character recognition. Thus, by illuminating the same reproduction illumination light beam 231 once, it is possible to acquire the visually readable identification information and the mechanically readable identification information, which are recorded on the hologram 222, at the same time.

The data, which is stored in the data buffer 216, is sent to, for example, sorting mechanism control computer 202, and is cross-checked with the visually readable identification information and mechanically readable identification information by the sorting mechanism control computer 202. Specifically, on the basis of the association between the visually readable identification information and the mechanically readable identification information, it is determined whether or not the visually readable identification information, which is read, is recoverable from the mechanically readable identification information which is read. Due to defects at the time of recording the visually readable identification information and the mechanically readable identification information on the hologram 222 and the reason that dust and dirt may be placed on the hologram 222 and so on, sometimes, it may be difficult to recover the visually readable identification information from the mechanically readable identification information. In this case, it is determined that the hologram is a defective product.

If it is determined that the hologram is defective, a signal S is sent from the sorting mechanism control computer 202 to a stepping motor or the like for moving the roll group Tr. When the stepping motor or the like receives the signal S, the roll group Tr is moved along the direction of the arrow C shown in FIG. 19A, whereby the defect stripping roller 292 is able to approach to the defect stripping platen roller 280.

Since the hologram 222 is easily stripped from the separator 255, when the defect stripping roller 292 approaches to the defect stripping platen roller 280, the hologram, which is determined as a defective product, is stripped from the separator 255 by the stripping tape 290, and is moved onto the stripping tape 290. That is, the hologram, which is determined as a defective product, is separated from a group of non-defective holograms. When the hologram determined as a defective product is stripped from the separator 255, by rotating the stripping tape wind-up roll 293, the hologram attached onto the stripping tape 290 is wound around the stripping tape wind-up roll 293.

On the other hand, the hologram, which is not determined as a defective product, is wound around the selected-product wind-up roll 295 together with the separator 255.

Therefore, according to the sixth embodiment, it is possible to separate the hologram, through which the determination section determines that the visually readable identification information is unrecoverable from the mechanically readable identification information, from a group of the holograms through which the determination section determines that the visually readable identification information is recoverable from the mechanically readable identification information. That is, it is possible to prevent shipment of hologram-mounted media through which the visually readable identification information is unrecoverable from the mechanically readable identification information which is mechanically read.

### Modified Example of Determination Device

In the exemplary configuration of the determination device mentioned above, the roll group Tr is provided as a sorting mechanism, and the hologram, which is determined as a defective product, is stripped from the separator 255 by the stripping tape 290, and is separated from the group of the non-defective holograms, but the sorting mechanism may have a different configuration. For example, printing or punching may be performed on the hologram, which is determined as a defective product, such that the hologram can be distinguished as a defective product. In this case, the determination device may have a printer or a puncher as a sorting mechanism instead of the roller group Tr.

Further, in the above-mentioned determination device, by using a function of the check digits of the visually readable identification information based on the mechanically readable identification information, whether or not the visually readable identification information read from the hologram 222 is correct data is determined off-line, but may be determined on-line.

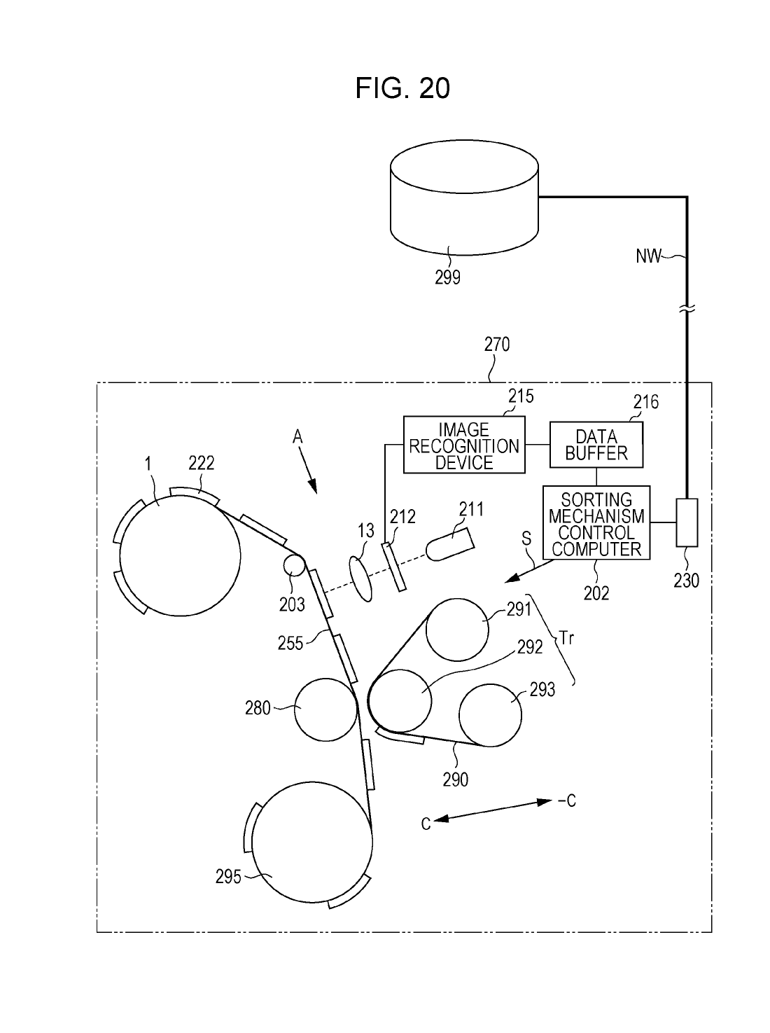

FIG. 20 is a schematic diagram illustrating another exemplary configuration of the determination device. In addition, since a configuration of the determination device viewed from the A direction in FIG. 20 is the same as the configuration shown in FIG. 19B, here the view viewed from the A direction in FIG. 20 is omitted. In another exemplary configuration of the determination device shown in FIG. 20, a determination device 270 (indicated by the chain double-dashed line) further includes a data transceiving section 230 that communicates with database 299 in which the list of the data recorded on the hologram 222 is registered. The database 299 shown in FIG. 20 is a database in which the data of at least one of the visually readable identification information and the mechanically readable identification information recorded on, for example, the hologram 222 is registered. The database 299 is administered by a person (hereinafter appropriately referred to as a maker of the hologram) who performs the recording of the visually readable identification information and the mechanically readable identification information on, for example, the hologram 222.

The determination device 270 shown in FIG. 20 first acquires the visually readable identification information and the mechanically readable identification information from the hologram 222, and determines off-line whether or not the visually readable identification information is recoverable from the mechanically readable identification information. On the basis of the determination, if it is determined that the visually readable identification information is unrecoverable from the mechanically readable identification information, the roller group Tr strips the hologram, through which it is determined that the visually readable identification information is unrecoverable from the mechanically readable identification information, from the separator 255.

In contrast, if it is determined that the visually readable identification information is recoverable from the mechanically readable identification information, the determination device 270 queries the data, which includes the visually readable identification information stored in for example the data buffer 216, on the database 299 through the data transceiving section 230 and a network NW.

The query is, for example, to check whether or not the visually readable identification information acquired from the hologram 222 is recoverable from the mechanically readable identification information registered in the database 299. It may be determined whether or not the visually readable identification information acquired from the hologram 222 coincides with the visually readable identification information registered in the database 299. If it is determined that the visually readable identification information acquired from the hologram 222 is unrecoverable from the mechanically readable identification information registered in the database 299, it means that a hologram, in which visually readable identification information recorded is actually nonexistent, is mixed therein. Accordingly, if it is determined by the query that the visually readable identification information acquired from the hologram 222 is unrecoverable, the signal S is sent from the sorting mechanism control computer 202 to the stepping motor or the like in order to move the roll group Tr. That is, the hologram, through which it is determined that the visually readable identification information acquired from the hologram 222 is unrecoverable from the mechanically readable identification information registered in the database 299, is removed. At this time, the data on the visually readable identification information and the mechanically readable identification information of the removed hologram may be erased from the database 299. Alternatively, the removal of the hologram corresponding to the data may be additionally registered in the database 299.

As mentioned above, the determination device 270 shown in FIG. 20 performs two-step determination as to whether or not the visually readable identification information read from the hologram 222 is correct data. Furthermore, the two-step determination can be performed on each point of the hologram. Accordingly, it is possible to guarantee that the visually readable identification information apparently issued is reliably recorded on the hologram and a counterfeit hologram is not included therein.

### 7. Seventh Embodiment

In the above-mentioned sixth embodiment, by making the mechanically readable identification information function as the check digits of the visually readable identification information, it is possible to determine whether or not the visually readable identification information which is read from the hologram is correct data. Accordingly, by cross-checking each hologram, it is possible to remove the hologram which is determined as a defective product.

Here, in the case where a separate functional material is bonded to the hologram, or in the case where slit formation or half cutting is performed, it can be considered that a defect may occur in a subsequent step thereof. In order to remove the hologram in which the defect occurs in the subsequent step, it is necessary to cross-check each hologram. Thus, in order to remove the hologram which is determined as a defective product, unless cross-checking is performed in-line on the basis of the records of the identification information, a complicated system therefore has to be constructed. In particular, in order to erase the data on the hologram, which is determined as a defective product, from the database in which the data of the visually readable identification information and the mechanically readable identification information recorded on the hologram is registered, a further complicated system has to be constructed.

For this reason, in the seventh embodiment, two or more pieces of identification information, which are recorded on the medium, include at least two pieces of holographic identification information. One of the holographic identification information pieces is visually readable identification information, and the other one is mechanically readable identification information. The visually readable identification information and the mechanically readable identification information are associated with each other. The visually readable identification information and the mechanically readable identification information included in the hologram are reproduced by a prescribed reproduction illumination light beam, the visually readable identification information and the mechanically readable identification information are acquired by the imaging device or the like, and the visually readable identification information and the mechanically readable identification information are cross-checked. It is determined through the cross-check whether or not the read visually readable identification information is recoverable from the read mechanically readable identification information, thereby performing the sorting into recoverable information and unrecoverable information. Through the sorting, a carrier is bonded to the hologram through which the read visually readable identification information is recoverable from the read mechanically readable identification information. Identification information associated with the mechanically readable identification information or the visually readable identification information is recorded in the carrier. Therefore, according to the seventh embodiment, before the bonding between the hologram and the carrier, the visually readable identification information and the mechanically readable identification information are cross-checked in-line, and thus it is possible to integrate the carrier with only the hologram which is not determined as a defective product.

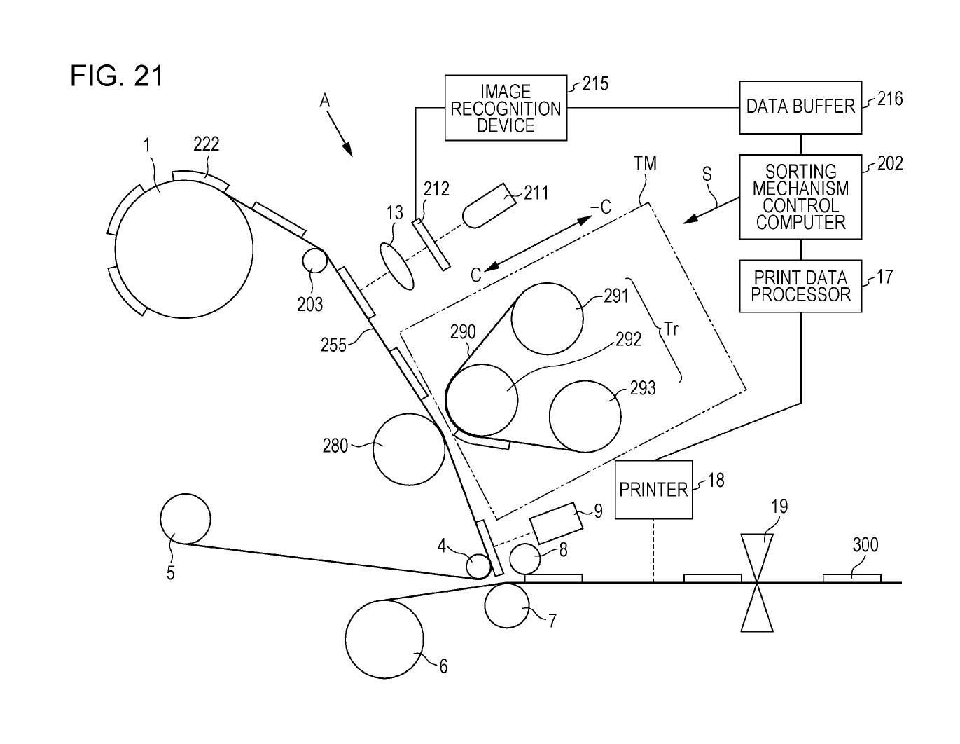

FIG. 21 is a schematic diagram illustrating an exemplary configuration of a hologram-mounted medium producing apparatus according to the seventh embodiment of the present technology. In addition, since a configuration of the hologram-mounted medium producing apparatus viewed from the A direction in FIG. 21 is the same as the configuration shown in FIG. 19B, here the view viewed from the A direction in FIG. 21 is omitted. The hologram-mounted medium producing apparatus according to the seventh embodiment schematically has a configuration in which any one of the hologram-mounted medium producing apparatuses according to the first to fifth embodiments is integrated with the determination device according to the sixth embodiment. Here, as shown in FIG. 21, a description will be given of an example in which the hologram-mounted medium producing apparatus according to the first embodiment is integrated with the determination device according to the sixth embodiment.

That is, in addition to the components of the hologram-mounted medium producing apparatus according to the first embodiment, the hologram-mounted medium producing apparatus according to the seventh embodiment includes: the sorting mechanism control computer 202; a sorting mechanism TM indicated by the dashed line in FIG. 21; and the defect stripping platen roller 280, and includes the image recognition device 215 instead of the character recognition device 15. The sorting mechanism TM includes the group Tr of the stripping tape feeding roll 291, the defect stripping roller 292, and the stripping tape wind-up roll 293. Similarly to the sixth embodiment, the roll group Tr is supported in a shape capable of causing the defect stripping roller 292 to approach to the defect stripping platen roller 280, or moving it in a separation direction (in FIG. 21, the C direction of the arrow, or −C direction).

Next, an operation of the hologram-mounted medium producing apparatus according to the seventh embodiment will be described below with reference to FIG. 21. The holograms 222 are fed out from the hologram supply roll 1, and the separator 255 is wound around the wind-up roll 5 through the positioning roll 203, the defect stripping platen roller 280, and the stripping platen roller 4.

Each hologram 222 fed out from the hologram supply roll 1 includes the visually readable identification information and the mechanically readable identification information associated with each other, and as necessary, a separate functional material is bonded to the hologram, or slit is formed or half cut is performed thereon. As the hologram supply roll 1, for example, it is possible to use the roll-shaped medium 201 shown in FIG. 18. However, other shapes such as a sheet shape and other methods may be used so far as the holograms can be continuously supplied.

Similarly to the first embodiment, the above-mentioned stripping platen roller 4 has a curvature which is sufficiently small to strip the holograms 222 from the separator 255, whereby the holograms 222 are separated from the separator 255, and then come close to the label board sheet fed out from the carrier supply roll 6. The hologram 222, which is stripped from the separator 255, is reliably pressure-bonded to a label by the labeling platen 7 and the press pinch roller 8.

In the seventh embodiment, before the step of integrally bonding the label to the hologram 222, during the time until each hologram 222 reaches the defect stripping platen roller 280, the visually readable identification information and the mechanically readable identification information, which are recorded on the hologram 222, are acquired.

Similarly to the first to sixth embodiments mentioned above, from the illumination-only LED light source 211, the reproduction illumination light beam 231, which has a predetermined wavelength, an incident angle, and a light beam divergence angle, is illuminated onto the hologram 222 through the collimator lens 14 which is not shown in the drawing. The reproduction light Rh of the visually readable identification information and the reproduction light Rm of the mechanically readable identification information from the hologram 222 are incident on the imaging device 212 through the imaging lens 13. The reproduction light beams Rh and Rm incident on the imaging device 212 are photoelectrically converted into, for example, text data by the image recognition device 215, and the data can be stored in the data buffer 216.

The data, which is stored in the data buffer 216, is sent to, for example, sorting mechanism control computer 202, and is cross-checked with the visually readable identification information and mechanically readable identification information by the sorting mechanism control computer 202. Specifically, it is determined whether or not the visually readable identification information is recoverable from the mechanically readable identification information. If the visually readable identification information is unrecoverable from the mechanically readable identification information, it is determined that the hologram is a defective product, and thus the hologram, which is determined as a defective product, is separated from the group of the non-defective holograms through the sorting mechanism TM. When the hologram determined as a defective product is stripped from the separator 255, by rotating the stripping tape wind-up roll 293, the hologram attached onto the stripping tape 290 is wound around the stripping tape wind-up roll 293.

The hologram, which is not determined as a defective product, is stripped from the separator 255 by the stripping platen roller 4, and is bonded to a label. At this time, a feeding amount sensor 9 detects the end portion of the hologram which is not determined as a defective product, whereby it is possible to bond the hologram which is not determined as a defective product to a prescribed position of the label supplied from the carrier supply roll 6. Hence, there is no problem even when there are differences of the spaces between the holograms which are not determined as a defective product since the hologram determined as a defective product is stripped from the separator 255.

After the hologram is bonded to the label, the printer 18 prints information, which is associated with the mechanically readable identification information or visually readable identification information acquired from the hologram 222, on the label. The hologram-mounted medium 300, in which the information associated with the visually readable identification information or mechanically readable identification information is printed on the label, is cut out by a cutter 19 so as to have a predetermined size as necessary.

According to the seventh embodiment, it is possible to integrate only the hologram, which is not determined as a defective product, with the carrier, and it is possible to obtain the same effect as the hologram-mounted medium according to the first embodiment.

### Modified Example of Seventh Embodiment

In order to reliably use as a tracking system the hologram-mounted media in which the hologram is bonded to the carrier, it is preferable to construct a database as to which identification information is included in the hologram bonded to the carrier.

Therefore, it is considered that the database is constructed from the data stored in the data buffer 216. However, when erroneous conversion occurs in the course of the optical character recognition, there is a concern that incorrect identification information is registered in the database. It is assumed that, in the course of mechanically reading the optical character recognition or the like, incorrect identification information is registered in the database. Then, even when a viewer of the hologram-mounted medium checks the identification information recorded on the hologram with naked eye and performs a query on the database, it is erroneously determined that the hologram-mounted medium is a fake. For example, even when the identification information checked from the hologram by a viewer of the hologram-mounted medium does not reside in the database, it is difficult for a viewer of the hologram-mounted medium to determine whether the query target is absent in the database, on the basis of only the identification information.

In the seventh embodiment, the hologram includes the visually readable identification information and the mechanically readable identification information. Hence, the mechanically readable identification information can be made to function as the check digits of the visually readable identification information, and thus it is possible to prevent the incorrect identification information from being registered in the database. Accordingly, by checking whether or not the visually readable identification information read from the hologram is correct data, it is possible to construct a database as to which identification information is recorded on the hologram used in the hologram-mounted medium. Further, it is possible to guarantee that the identification information, which is checked with naked eye by a viewer of the hologram-mounted medium, is reliably registered in the database.

The identification information, which is read from the hologram, and the information, which will be printed on the label, may be registered in the database. In this case, in terms of producing and supplying the hologram-mounted medium, the identification information, which is read from the hologram, and the information, which will be printed on the label, may have only to be associated with each other, and may not correspond one-to-one with each other.

By constructing the database right before integrating the hologram and the carrier, the list of the data recorded on the hologram becomes not necessary. In other words, even when the database administered by the maker of the hologram does not exist, it is possible to determine off-line whether or not the visually readable identification information read from the hologram-mounted medium is correct data.

### 8. Eighth Embodiment

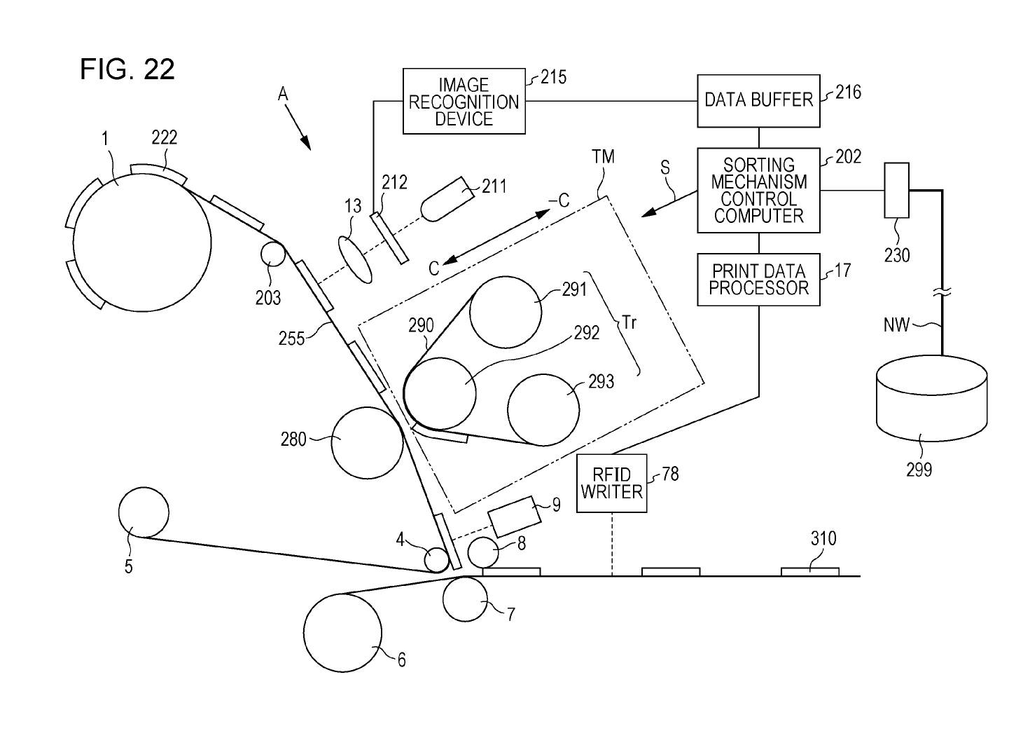

FIG. 22 is a schematic diagram illustrating an exemplary configuration of a hologram-mounted medium producing apparatus according to an eighth embodiment of the present technology. In addition, since a configuration of the hologram-mounted medium producing apparatus viewed from the A direction in FIG. 22 is the same as the configuration shown in FIG. 19B, here the view viewed from the A direction in FIG. 22 is omitted. The hologram-mounted medium producing apparatus according to the eighth embodiment schematically has a configuration in which any one of the hologram-mounted medium producing apparatuses according to the first to fifth embodiments is integrated with the determination device according to the sixth embodiment. Here, as shown in FIG. 22, a description will be given of an example in which the hologram-mounted medium producing apparatus according to the second embodiment is integrated with the determination device according to the sixth embodiment.

As shown in FIG. 22, comparing the hologram-mounted medium producing apparatus according to the eighth embodiment with the hologram-mounted medium producing apparatus according to the seventh embodiment shown in FIG. 21, there is a difference in that the apparatus includes the RFID writer 78 instead of the printer 18. Further, as shown in FIG. 22, the hologram-mounted medium producing apparatus according to the eighth embodiment further includes the data transceiving section 230 that communicates with the database 299 administered by the maker of the hologram. In the database 299, for example, the data on at least one of the visually readable identification information and the mechanically readable identification information, which are recorded in the hologram 222, is registered. In addition, from the reel-shaped carrier supply roll 6, instead of the label, an RF tag such as a non-contact IC card which is supported on a lengthy separator sheet is continuously supplied.

An operation of the hologram-mounted medium producing apparatus according to the eighth embodiment is schematically different only in that, instead of printing the information stored in the data buffer 216 on the label, the information is written into the RF tag. Therefore, detailed description thereof will be omitted. Here, in one exemplary configuration of the hologram-mounted medium producing apparatus according to the eighth embodiment, similarly to the modified example of the above-mentioned determination device, two-step determination is made as to whether or not the visually readable identification information read from the hologram 222 is correct data.

The hologram-mounted medium producing apparatus acquires the visually readable identification information and the mechanically readable identification information from the hologram 222, and first determines off-line whether or not the visually readable identification information is recoverable from the mechanically readable identification information. On the basis of the determination, if it is determined that the visually readable identification information is unrecoverable from the mechanically readable identification information, the roller group Tr strips the hologram from the separator 255. Next, determination is made on-line as to whether or not the visually readable identification information read from the hologram 222 is correct data. That is, if it is determined that the visually readable identification information is recoverable from the mechanically readable identification information, the hologram-mounted medium producing apparatus queries the data, which is stored in the data buffer 216, on the database 299 through the data transceiving section 230 and a network NW. For example, if it is determined by the query that the visually readable identification information acquired from the hologram 222 is unrecoverable from the mechanically readable identification information registered in the database 299, the hologram is stripped from the separator 255 by the roller group Tr.

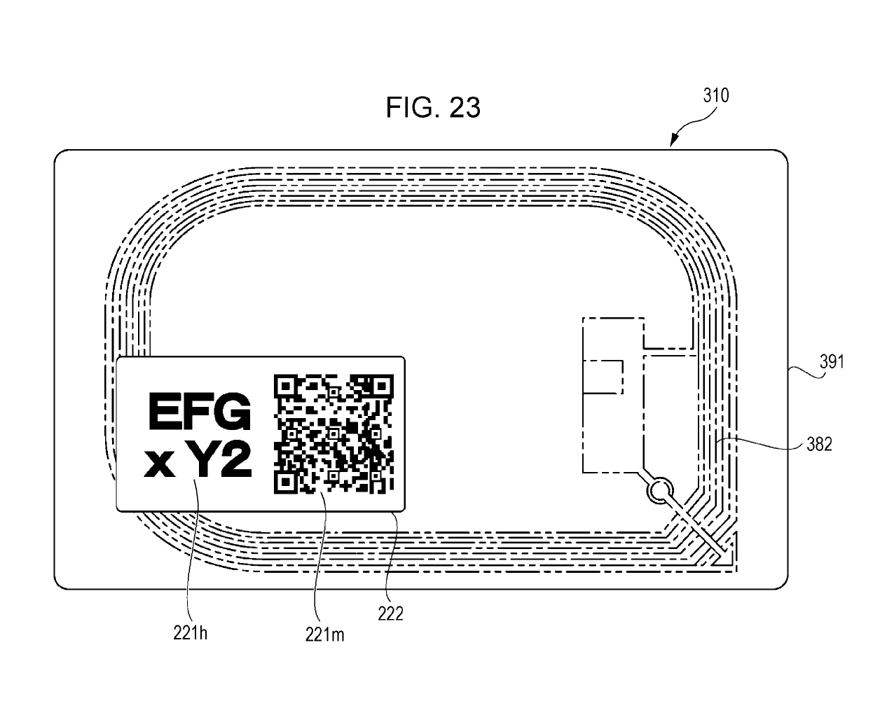

The hologram, which is not determined as a defective product, is stripped from the separator by the stripping platen roller 4, and is bonded to the RF tag, whereby the information associated with the mechanically readable identification information or visually readable identification information acquired from the hologram 222 is written into the RF tag. FIG. 23 shows the exemplary configuration of the hologram-mounted medium according to the eighth embodiment. In the exemplary configuration shown in FIG. 23, the hologram 222, on which the visually readable identification information 221h and mechanically readable identification information 221m are holographically recorded, is bonded to and integrated with the non-contact IC card 391. In the example shown in FIG. 23, the visually readable identification information 221h and the mechanically readable identification information 221m are associated with each other, and thus the mechanically readable identification information 221m functions as check digits of the visually readable identification information 221h. Further, in the RF tag 382, for example, the information, which is associated with the visually readable identification information 221h or mechanically readable identification information 221m recorded on the hologram 222, is recorded. Accordingly, it is possible to use the hologram-mounted medium 310 as a medium in which the visually readable identification information 221h or mechanically readable identification information 221m recorded on the hologram 222 and the information written into the RF tag 382 are combined.

According to the eighth embodiment, it is possible to integrate only the hologram, which is not determined as a defective product, with the carrier, and it is possible to obtain the same effect as the hologram-mounted medium according to the second embodiment. Furthermore, since the identification information read from the hologram-mounted medium is queried on the database 299 administered by the maker of the hologram, it is possible to guarantee that there is no discrepancy between the information to be recorded on the hologram and the information recorded on the hologram. Accordingly, it is possible to guarantee that the identification information, which is checked with naked eye by a viewer of the hologram-mounted medium, is reliably registered in the database 299 administered by the maker of the hologram. Thus, it is possible to reliably use the hologram-mounted media as a tracking system.

### Modified Example of Eighth Embodiment

Similarly to the modified example of the seventh embodiment, the database may be constructed from the data stored in the data buffer 216. In this case, it is also possible to administer which identification information is included in the hologram bonded to the carrier, through the database, in terms of producing and supplying the hologram-mounted medium.

### 9. Modified Example

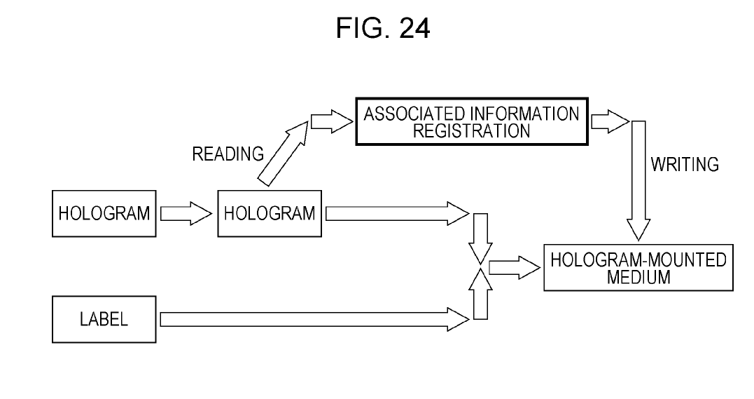

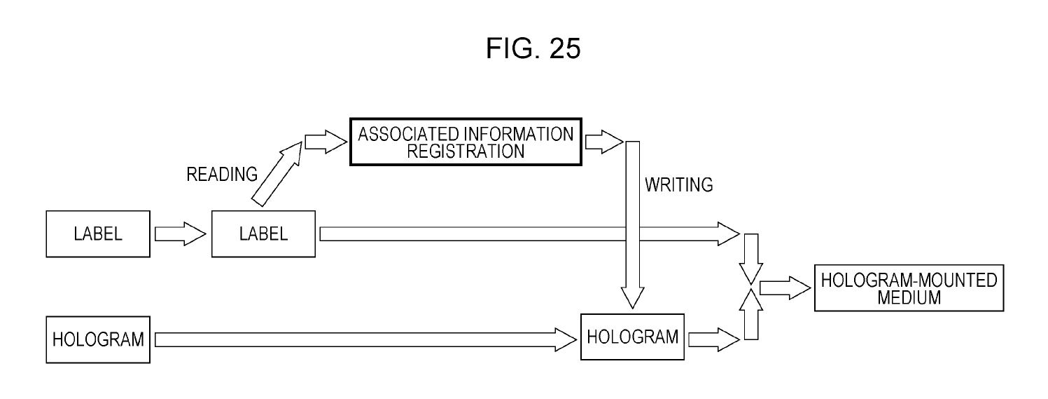

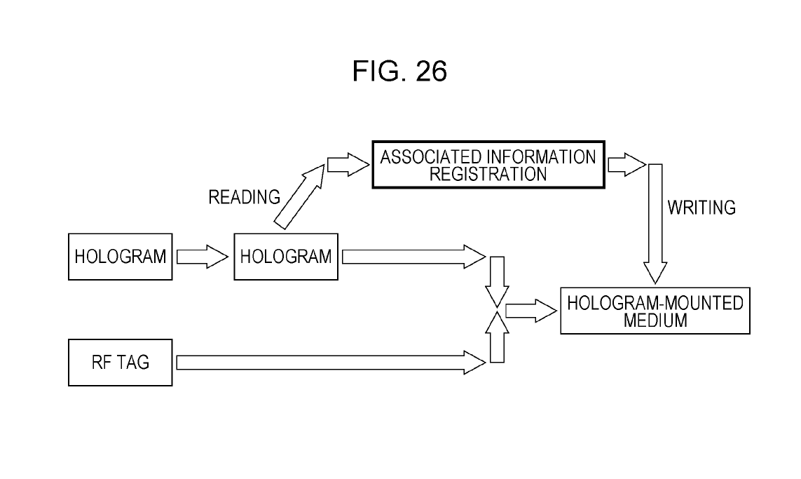

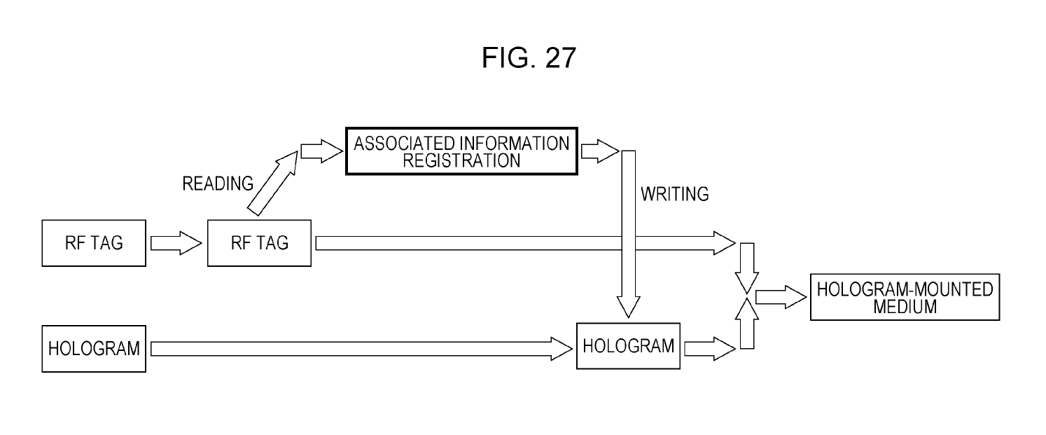

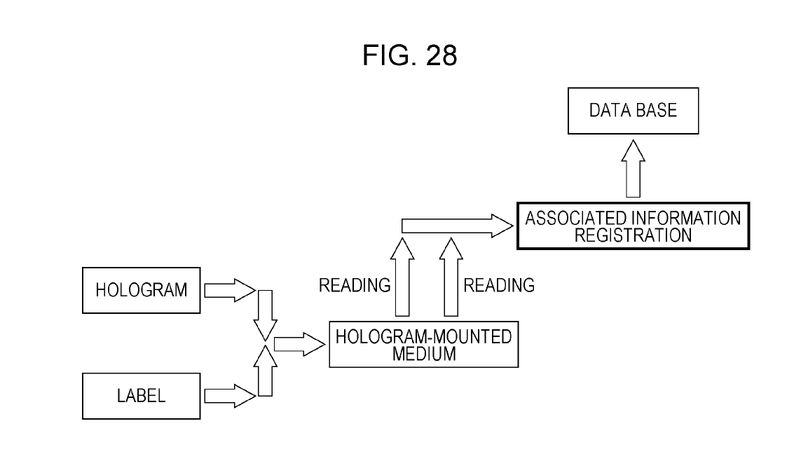

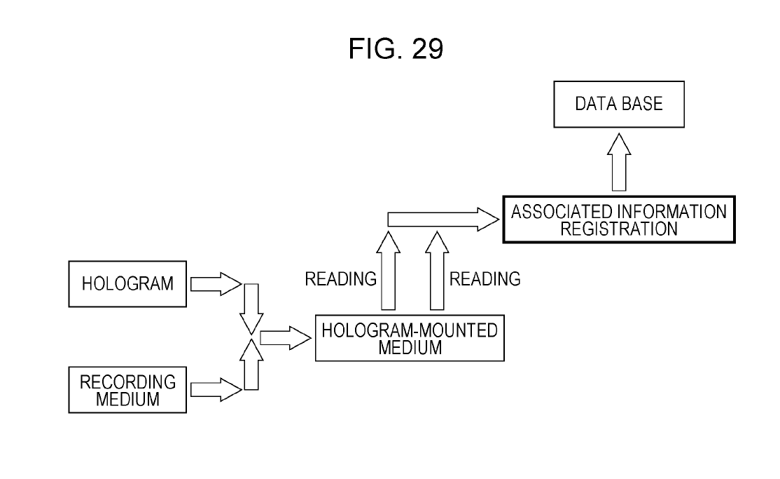

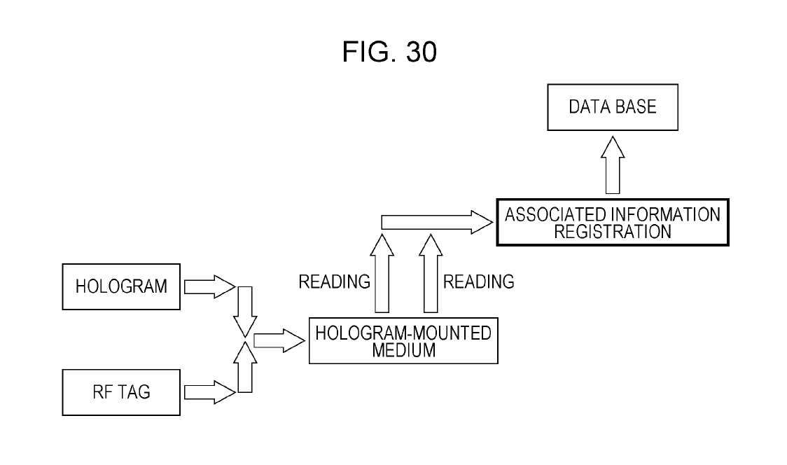

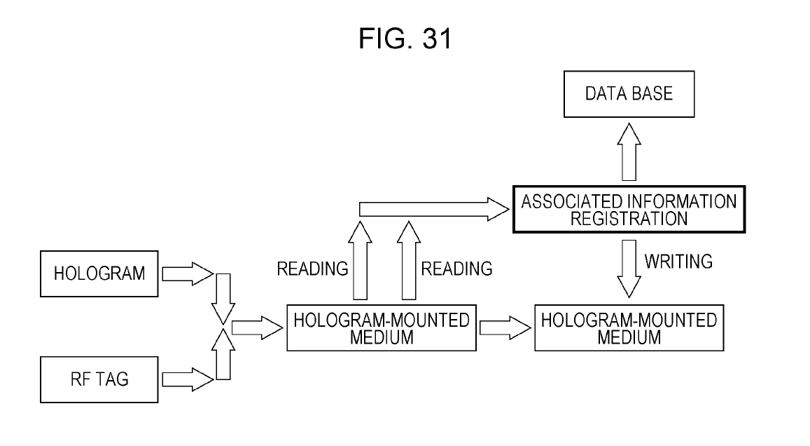

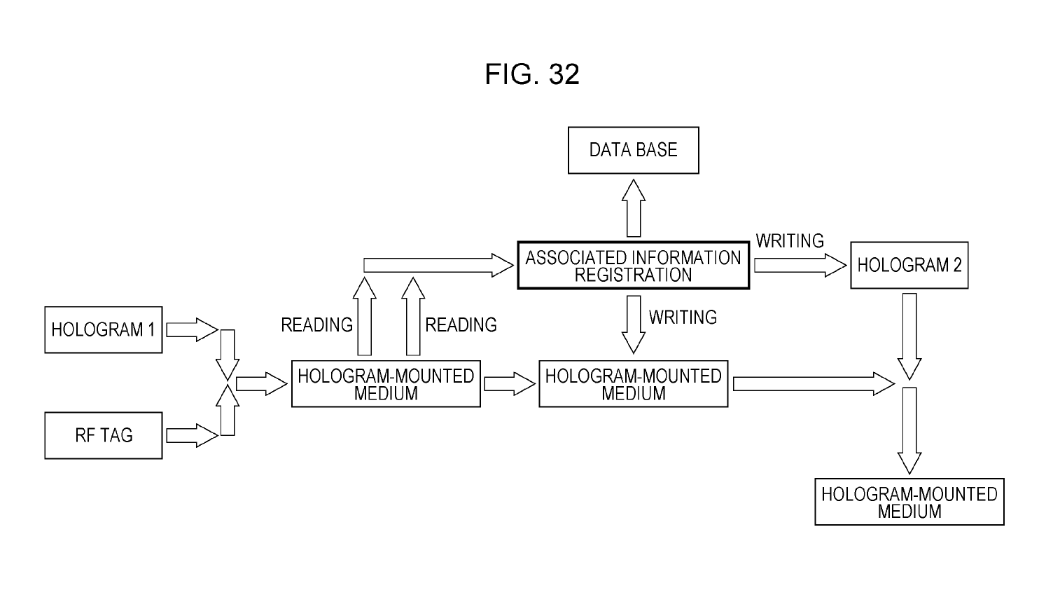

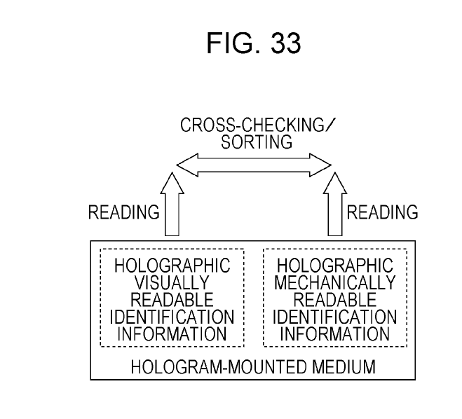

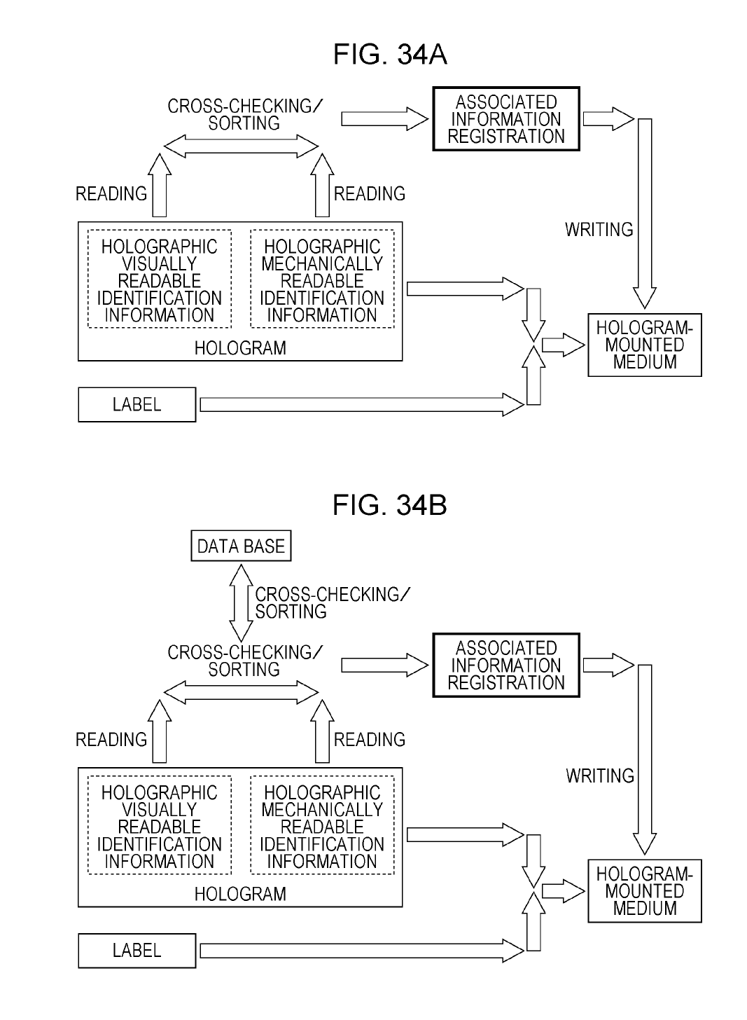

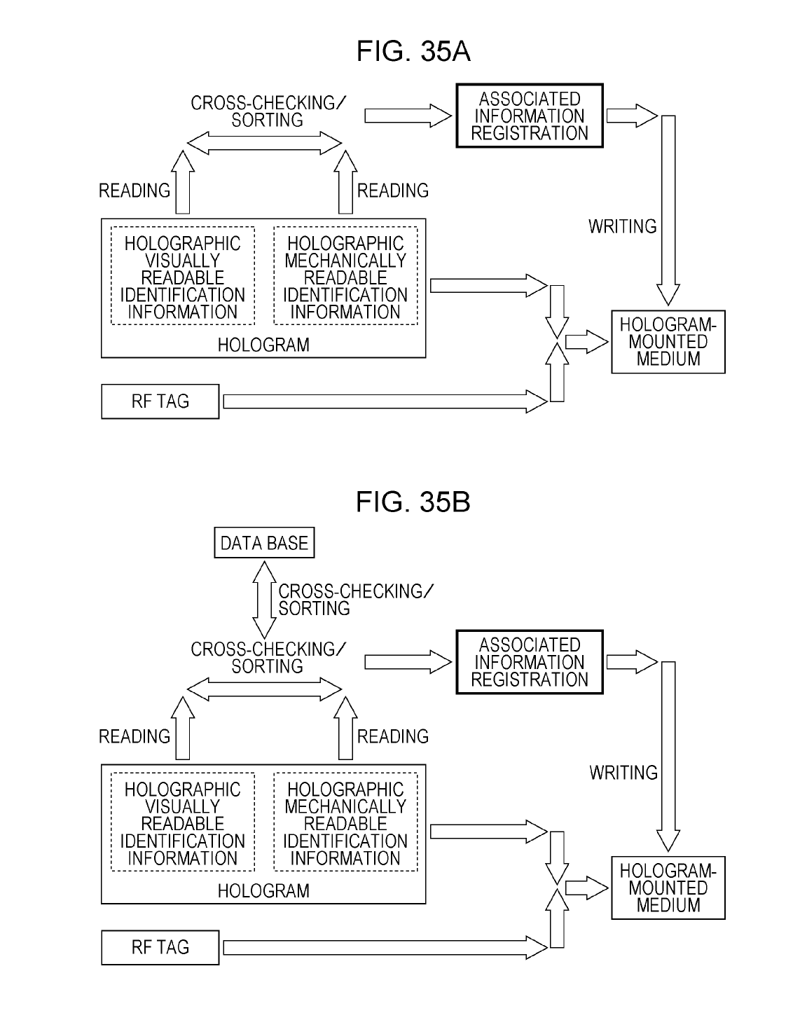

While specific embodiments of the present technology have hitherto been described, the present technology is not limited to this, but can be modified into various forms based on the technical spirit of the present technology. For example, it may be possible to adopt combinations of the above-mentioned embodiments. In addition, FIGS. 24 to 35 are schematic diagrams illustrating the embodiments of the present technology and the modified examples of the embodiments.

The layer structure of the hologram is not limited to the structure shown in FIG. 4. The protective layer may have a plurality of layers and may be omitted, and various adhesives may be used. The hologram is not limited to the volume hologram, and various kinds of holograms such as an embossed hologram may be used. The supply sources of the hologram and the carrier may be different from each other.

The identification information recorded on the hologram as the additional information is not limited to an array of numbers, and various kinds of information may be used as long as they are unique. For example, various kinds of information such as a serial number, a manufacturer name, a lot number, or biometric information may be recorded. The recorded form is not limited to characters, symbols, figures, and a combination thereof, and image information other than the identification information such as a one-dimensional barcode or a two-dimensional barcode may be recorded. When identification information other than characters is recorded on the hologram, the hologram-mounted medium producing apparatus may include an image recognition means instead of the character recognition device 15. In addition, two or more pieces of additional information may be recorded.

The light source for illuminating the hologram is not limited to an LED, and light sources such as a xenon lamp, a halogen lamp, a fluorescent lamp, or a light source guided through an opening or an optical fiber from an external light may be used. A representative example of the imaging device includes a CCD (Charge Coupled Device) and a CMOS (Complementary Metal-Oxide Semiconductor), but the present technology is not limited to this. The important thing is to define the light source for reading the hologram and the imaging angle from a prescribed position.

Integration of the hologram and the carrier is not limited to the bonding using an adhesive, but various methods such as heat sealing using a hot-melt material, an adhesive, a UV-curable resin, or a lamination film may be used.

Further, similarly to the modified example of the third embodiment, as for the carrier, the recording medium may be combined with the hologram in addition to the RFID. For example, other mechanically readable recording media such as a magnetic recording medium, an optical recording medium, an optomagnetic recording medium, a contact IC, or a noncontact IC may be used. A holographic memory may be combined since it can be read by a machine. Alternatively, a recording medium such as a flash memory which has unique ID information therein may be used or combined. A plurality of kinds of information may be recorded on these recording media. The medium which is integrated with the hologram is not limited to the recording media mentioned above. That is, the medium which is integrated with the hologram may only be necessary to have identification information, but the medium may not necessarily be combined with the recording medium.

The present technology can be applied to a non-contact IC card, an ID card, a bank card, a credit card, an employee ID card, a student ID card, a commuter ticket, a driver's license card, a passport, a visa, securities, a bank book, a documentary stamp, a stamp, a portable phone, a currency, and the like.

### 10. Hologram Storing Additional Information

Hereinafter, an image recording medium which was previously proposed by the present inventors will be described. The image recording medium is an image recording medium through which additional information is visible within a predetermined range of viewing angles when illuminated at a predetermined angle.

Holographic Stereogram Producing System

Prior to a description of a replication apparatus of the image recording medium and a replication method, production of a covering hologram master to be replicated will be described. In general, it is possible to synthesize a hologram which reproduces a three-dimensional image using two-dimensional original images of an object viewed from different viewpoints. A holographic stereogram is produced, for example, by sequentially recording a number of original images, which are obtained by sequentially photographing an object from different viewpoints, as strip-shaped elementary holograms in a single hologram recording medium.

When strip-shaped elementary holograms are sequentially recorded, an HPO (Horizontal Parallax Only) holographic stereogram which has parallax only in the horizontal direction is produced. The HPO holographic stereogram takes a short time to print and can realize high image quality recording. On the other hand, there was a strong demand for providing vertical parallax as well as horizontal parallax in order to record images with a more natural three-dimensional effect. Further, the embossed recording media which have been used for the purpose of preventing counterfeiting of credit cards are replaced with more sophisticated volume recording media since the embossed recording media are easy to counterfeit. The use of volume recording media enables recording of images with vertical parallax which is basically not expressed with the embossed recording media. Thus, it was desirable to include vertical parallax in the recording method so as to enhance the anti-counterfeit effect.

An FP (Full Parallax) holographic stereogram having parallax in both the horizontal and vertical directions has been produced by incorporating an optical system using a combination of spherical lenses. The inventors of the present application propose an image recording apparatus which can solve some problems of an existing production method of the FP hologram. With the image recording apparatus, it is possible to obtain a high-quality full-parallax holographic stereogram having independent numbers of parallax in the vertical and horizontal directions using an optical system, a mechanism section, and a control section used for recording elementary holograms having horizontal parallax. In such a manner, a high-quality holographic stereogram in which elementary holograms are not easily visible can be produced at a high speed compared to dot-shaped full parallax holographic stereogram.

First, an exemplary configuration of a holographic stereogram producing system that produces a holographic stereogram will be described. Hereinafter, description will be given of an apparatus for constructing a holographic stereogram with parallax information in the horizontal direction by recording a plurality of strip-shaped elementary holograms on a single recording medium.

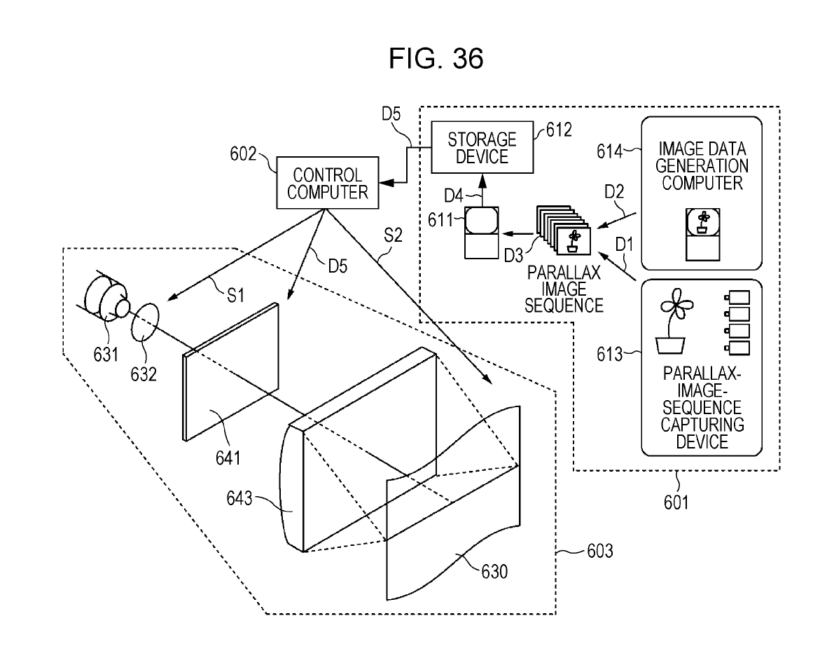

This holographic stereogram producing system is a so-called one-step holographic stereogram producing system in which a hologram recording medium having the interference fringes between an object light beam and a reference light beam recorded thereon is used as a holographic stereogram. As shown in FIG. 36, the holographic stereogram producing system includes a data processing section 601 that processes image data to be recorded, a control computer 602 that controls the system as a whole, and a holographic stereogram printing apparatus 603 that has an optical system for producing a holographic stereogram.

The data processing section 601 generates a parallax image sequence D3, on the basis of a plurality of pieces of image data D1 which includes parallax information supplied from a parallax-image-sequence capturing device 613 having, for example, a multi-lens camera or moving camera. The data processing section 601 generates the parallax image sequence D3, on the basis of other data such as a plurality of pieces of image data D2 which includes parallax information generated by an image data generation computer 614.

Here, the plurality of pieces of image data D1 which includes the parallax information supplied from the parallax-image-sequence capturing device 613 are image data for a plurality of images. Such image data are obtained by capturing images of an actual object from a plurality of different viewpoints in the horizontal direction through simultaneous image capturing with a multi-lens camera or continuous image capturing with a moving camera.

Further, the image data generation computer 614 generates the plurality of pieces of image data D2 including the parallax information. For example, the image data pieces D2 are image data such as a plurality of CAD (Computer Aided Design) images or CG (Computer Graphics) images created by sequentially providing parallax in the horizontal direction.

Then, the data processing section 601 performs prescribed image processing for holographic stereogram on the parallax image sequence D3 by using an image processing computer 611. Subsequently, the image data pieces D4, on which the prescribed image processing is performed, are stored in a storage device 612 such as a memory or a hard disk.

Further, when images are recorded on the hologram recording medium, the data processing section 601 sequentially reads data of each image from the image data pieces D4 recorded in the storage device 612 and transmits the image data pieces D5 to the control computer 602.

On the other hand, the control computer 602 drives the holographic stereogram printing apparatus 603. The images based on the image data pieces D5 supplied from the data processing section 601 are sequentially recorded on a hologram recording medium 630, which is set in the holographic stereogram printing apparatus 603, as strip-shaped elementary holograms.

At this time, as described later, the control computer 602 controls a shutter 632, a display device 641, a recording medium feeding mechanism, and the like provided in the holographic stereogram printing apparatus 603. That is, the control computer 602 transmits a control signal S1 to the shutter 632 so as to thereby control the opening and closing of the shutter 632. Further, the control computer 602 supplies the image data pieces D5 to the display device 641 so as to thereby cause the display device 641 to display the images based on the image data pieces D5. In addition, the control computer 602 transmits a control signal S2 to the recording medium feeding mechanism so as to thereby control the feeding operation of the hologram recording medium 630 by the recording medium feeding mechanism.

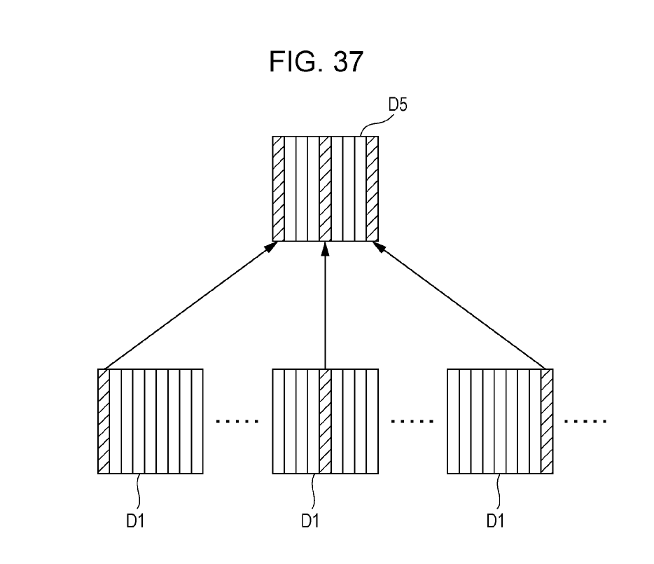

As shown in FIG. 37, image processing includes dividing each of the plurality of pieces of image data pieces D1 including parallax information in the direction of parallax, that is, in the horizontal (width) direction into slits and assembling the divided slices into the processed image D5. This image D5 is displayed on the display device 641.

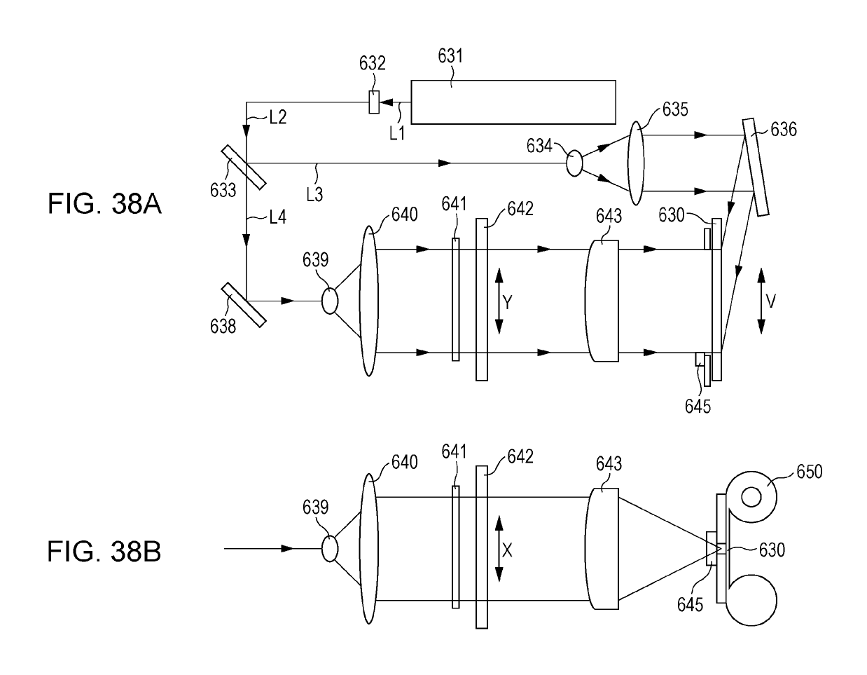

An optical system of the holographic stereogram printing apparatus 603 mentioned above will be described in detail with reference to FIGS. 38A and 38B. FIG. 38A is a top view of a whole optical system of the holographic stereogram printing apparatus 603, and FIG. 38B is a side view of the whole optical system of the holographic stereogram printing apparatus 603.

Holographic Stereogram Printing Apparatus

As shown in FIGS. 38A and 38B, the holographic stereogram printing apparatus 603 includes a laser light beam source 631 that emits a laser light beam having a predetermined wavelength, and the shutter 632, a mirror 638, and a half mirror 633 which are located on the optical axis of a laser light beam L1 emitted from the laser light beam source 631. Here, the laser light beam source 631 employs a light source that emits a laser light beam having a wavelength of about 532 nm, for example.

The shutter 632 is controlled by the control computer 602. The shutter 632 is closed when the hologram recording medium 630 is not to be exposed and opened when the hologram recording medium 630 is to be exposed. The half mirror 633 serves to separate the laser light beam L2 transmitted through the shutter 632 into the reference light beam and the object light beam. The light beam L3 reflected by the half mirror 633 is the reference light beam. The light beam L4 transmitted through the half mirror 633 is the object light beam.

In addition, in the optical system, the optical path of the reference light beam, which is reflected by the half mirror 633 and incident on the hologram recording medium 630, has substantially the same length as the optical path of the object light beam which is transmitted through the half mirror 633 and is incident on the hologram recording medium 630. In such a manner, coherency between the reference light beam and the object light beam is enhanced, and it is possible to produce a holographic stereogram offering a sharper reproduced image.

On the optical axis of the light beam L3 reflected by the half mirror 633, a cylindrical lens 634, a collimator lens 635 that collimates the reference light beam, and a reflection mirror 636 that reflects the parallel light beam from the collimator lens 635 are arranged in this order as an optical system for the reference light beam.

Subsequently, the light beam, which is reflected by the half mirror 633, is first converted into a divergent light beam by the cylindrical lens 634. Then, the divergent light beam is converted into the parallel light beam by the collimator lens 635. After that, the parallel light beam is reflected by the reflection mirror 636, and is then incident on the rear side of the hologram recording medium 630.

On the other hand, an optical system for the object light beam is provided on the optical axis of the light beam L4 transmitted through the half mirror 633. As the optical system for the object light beam, a reflection mirror 638 that reflects the light beam transmitted through the half mirror 633, a spatial filter 639 made up of a convex lens and a pin hole, and a collimator lens 640 that collimates the object light beam are used. Moreover, a display device 641, which displays an image to be recorded, and a one-dimensional diffuser panel 642, which diffuses the light transmitted through the display device 641 in the width direction of the elementary holograms, are used. In addition, a cylindrical lens 643, which concentrates the object light beam transmitted through the one-dimensional diffuser panel 642 onto the hologram recording medium 630, and an optical functional panel 645, which has a one-dimensional diffusion function, are used.

The cylindrical lens 643 concentrates the object light beam in a first parallax direction (the widthwise direction of the elementary holograms or the horizontal direction during viewing).

The optical functional panel 645 serves to diffuse the concentrated object light beam one-dimensionally in the longitudinal direction of the strip-shaped elementary holograms so as to cope with movement of viewpoint in the longitudinal direction. The optical functional panel 645 is a microstructure, and for example, a lenticular lens with a small pitch can be used as the optical functional panel 645.

The light beam L4, which is transmitted through the half mirror 633, is reflected by the reflection mirror 638, and is then converted into a divergent light beam which is emitted from a point light source by the spatial filter 639. Then, the divergent light beam is converted into a parallel light beam by the collimator lens 640, and is then incident on the display device 641. Here, the spatial filter 639 employs an objective lens with a magnification of 20 times and a pin hole with a diameter of 20 μm. In addition, the collimator lens 640 has a focal distance of 100 mm.

The display device 641 is a projection image display device formed of a liquid crystal display, for example. The display device 641 is controlled by the control computer 602 so as to display the image based on the image data pieces D5 sent from the control computer 602. In this example, a monochrome liquid crystal display panel whose pixels form a 480×1068 array and whose size is 16.8 mm×29.9 mm is used.

The light, which is transmitted through the display device 641, is converted into light which is modulated in accordance with the image displayed on the display device 641, and is diffused by the one-dimensional diffuser panel 642. The one-dimensional diffuser panel 642 is only necessary to be located near the display device 641 and may be located right before or after the display device 641. In this example, the one-dimensional diffuser panel 642 is located right after the display device 641.

Here, the one-dimensional diffuser panel 642 serves to slightly diffuse the light transmitted from the display device 641 in the width direction of the elementary holograms, thereby diffusing the light inside the elementary holograms. Thus, the image quality of the produced holographic stereogram is improved.

At this time, a diffuser panel moving section (not shown) is provided to the diffuser panel 642 so that the diffuser panel 642 is moved randomly each time the elementary holograms are formed, and the position thereof is changed for each elementary hologram. In such a manner, it is possible to reduce the noise at infinity when the hologram is viewed.

As the diffuser panel moving means for moving the diffuser panel 642, a moving mechanism such as a stepping motor that moves the diffuser panel 642 by a predetermined distance using a mechanical method may be used. The movement direction of the diffuser panel 642 by this mechanism may be the width direction (the direction of arrow X in FIG. 38B) of the elementary hologram and may be a direction (the direction of arrow Y in FIG. 38A) perpendicular to the width direction. The movement direction may be a combination of the two directions and may be random. Further, a reciprocating movement is also possible.

By disposing the diffuser panel 642 in the described manner, the width portion of the elementary hologram can be uniformly exposed. Thus, the image quality of the resulting hologram is improved. However, in order to realize uniform exposure, it is necessary to intensify the diffusing effect of the diffuser panel 642 to some extent. The object light beam diffused by the diffuser panel 642 is spread on the hologram recording medium 630. Thus, a wider range of the area than the width of the elementary hologram is exposed.

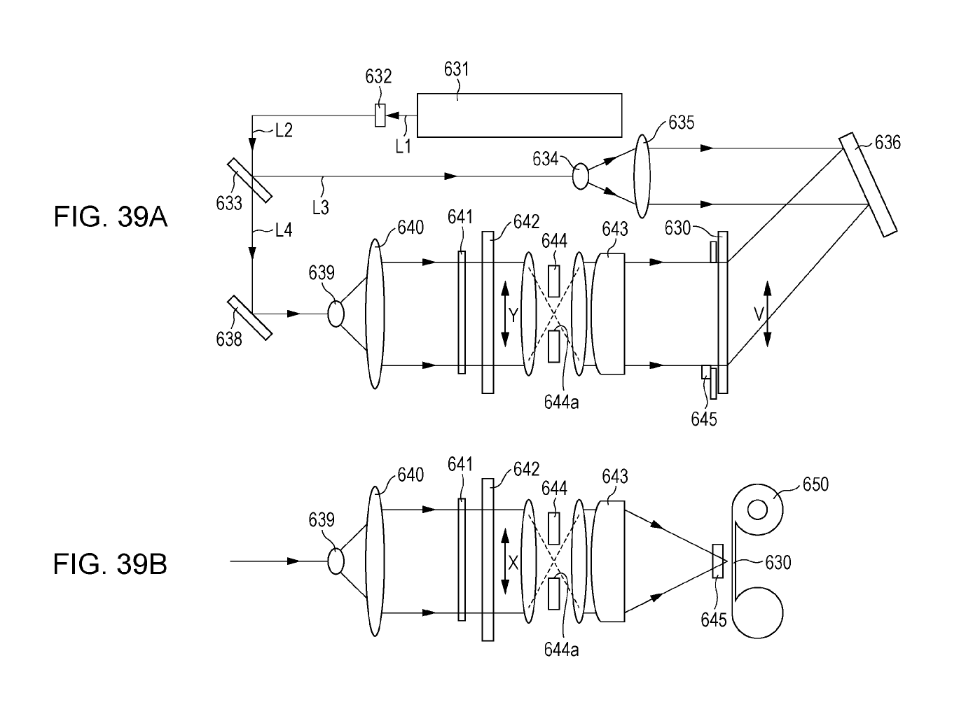

Accordingly, a mask 644 is disposed on the optical path as shown in FIGS. 39A and 39B so as to project the image thereof onto the recording material, whereby an appropriate width portion of each elementary hologram is exposed. That is, due to the diffusion effected by the diffuser panel 642 and the screening of unnecessary light by the mask 644, it is possible to obtain a uniformly appropriate exposure width. As shown in FIGS. 39A and 39B, the mask may be provided between the diffuser panel 642 and the cylindrical lens 643, and may be provided near the hologram recording medium 630.

Specifically, the light transmitted from the display device 641 is transmitted through the diffuser panel 642, where the light is diffused in the width direction of the elementary hologram. Thereafter, the diffused light is converged onto the hologram recording medium 630 by the cylindrical lens 643. At this time, due to the effect of the diffuser panel 642, the object light beam is spread over a certain area without being concentrated to one point.

As shown in FIGS. 39A and 39B, only a predetermined central area of the spread convergent light is transmitted through an opening 644a of the mask 644 and is incident on the hologram recording medium 630 as the object light beam. The object light beam is strip-shaped.

As mentioned above, the optical functional panel 645 is disposed as a second diffuser panel, and the object light beam is diffused one-dimensionally in the longitudinal direction of the strip-shaped elementary hologram and illuminated onto the hologram recording medium 630. Thereby, it is possible to widen the viewing angle in the vertical direction (perpendicular direction) of a reflective hologram.

In a general holographic stereogram having parallax only in the horizontal direction, the optical functional panel 645 provides an optical functional angle substantially equivalent to the viewing angle in the vertical direction of a final holographic stereogram. On the other hand, in the recording medium, the one-dimensional diffusion angle is strictly narrowed so as to prevent an overlap with other pieces of identification information described later.

The holographic stereogram printing apparatus 603 includes a recording medium feeding mechanism 650 capable of intermittently feeding the hologram recording medium 630 by an amount corresponding to one elementary hologram under the control of the control computer 602. As described below, the recording medium feeding mechanism 650 is arranged to intermittently feed a film-shaped hologram recording medium in response to a control signal from the control computer 602. In addition, when the printer 603 produces a holographic stereogram, the printer 603 sequentially records the image based on each of the image data of the parallax image sequences on the hologram recording medium 630 set to the recording medium feeding mechanism 650 as a strip-shaped elementary hologram.

Example of Hologram Recording Medium

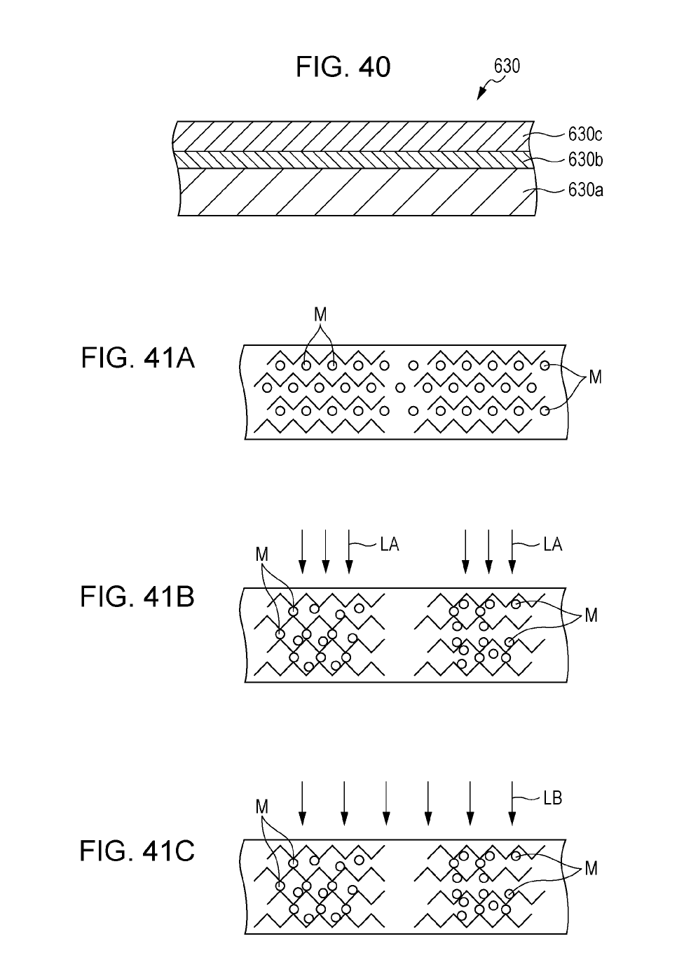

Here, the hologram recording medium 630, which is used in the holographic stereogram producing system mentioned above, will be described in detail. As shown in FIG. 40, the hologram recording medium 630 is formed to have the following structure. In the medium, a photopolymer layer 630b made from photo-polymerizable photopolymer is formed on a film base material 630a formed in a tape shape. In addition, a cover sheet 630c is coated on the photopolymer layer 630b. The hologram recording medium 630 is a so-called film-coated recording medium.

In the initial state of the photo-polymerizable photopolymer, monomers M are evenly distributed in a matrix polymer as shown in FIG. 41A. In contrast, as shown in FIG. 41B, when the photopolymer is illuminated with a light beam LA with a power of about 10 to 400 mJ/cm², the monomers M polymerize in the portions exposed with the light beam LA. As the polymerization progresses, the monomers M migrate from an area around the exposed portions, whereby the concentrations thereof are changed from one place to another and refractive index modulation occurs. Then, as shown in FIG. 41C, an ultraviolet or visible light beam LB with a power of about 1000 mJ/cm² is illuminated over the entire surface to complete the polymerization of the monomers M. As mentioned above, the refractive index of a photo-polymerizable photopolymer changes according to the incident light beam. Therefore, it is possible to record the interference fringes occurring due to the interference between the reference light beam and the object light beam as a change in refractive index.

In the hologram recording medium 630 using such a photo-polymerizable photopolymer, it is not necessary to perform any special development after the exposure. Accordingly, it is possible to simplify the configuration of the holographic stereogram printing apparatus 603 using the hologram recording medium 630 in which the photo-polymerizable photopolymer is used in a photosensitive section.

Recording Medium Feeding Mechanism

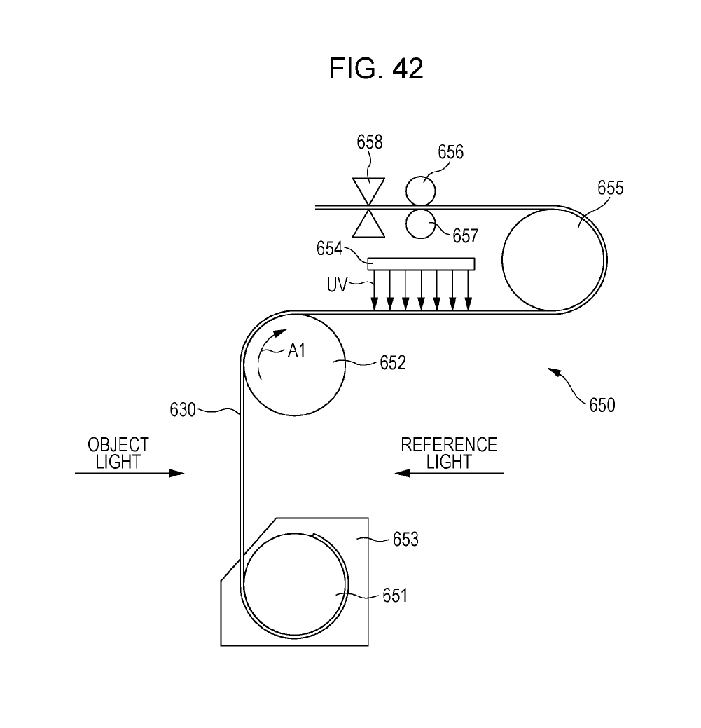

Next, the recording medium feeding mechanism 650 will be described in detail. FIG. 42 is an expanded view illustrating the recording medium feeding mechanism 650 of the holographic stereogram printing apparatus 603.

As shown in FIG. 42, the recording medium feeding mechanism 650 includes a roller 651 and an intermittent feeding roller 652. The hologram recording medium 630 is stored in a film cartridge 653 in a state of being wound around the roller 651. The recording medium feeding mechanism 650 axially support the roller 651 located in the film cartridge 653 mounted at a prescribed position so as to be rotatable with a predetermined amount of torque. The hologram recording medium 630 pulled out of the film cartridge 653 is held by the roller 651 and the intermittent feeding roller 652. At this time, the recording medium feeding mechanism 650 holds the hologram recording medium 630 so that the main face of the hologram recording medium 630 is substantially perpendicular to the object light beam between the roller 651 and the intermittent feeding roller 652. Thereby, the hologram recording medium 630 is held. Further, the roller 651 and the intermittent feeding roller 652 are pulled against each other by a torsion coil spring. Thereby, a predetermined amount of tension is applied to the hologram recording medium 630 loaded between the roller 651 and the intermittent feeding roller 652.

The intermittent feeding roller 652 of the recording medium feeding mechanism 650 is connected to a stepping motor which is not shown. The intermittent feeding roller 652 is rotatable in the direction indicated by the arrow A1 in FIG. 42 based on the rotation force transmitted from the stepping motor. This stepping motor serves to sequentially rotate the intermittent feeding roller 652 by a predetermined angle corresponding to one elementary hologram based on a control signal S2 supplied from the control computer 602 each time the exposure of one image is completed. In such a manner, the hologram recording medium 630 is fed by an amount corresponding to one elementary hologram for each image exposure.

Further, an ultraviolet lamp 654 is located along the travelling path of the hologram recording medium 630 at the posterior end of the intermittent feeding roller 652. The ultraviolet lamp 654 is used for completing the polymerization of the monomers M of the exposed hologram recording medium 630 and serves to apply an ultraviolet light beam UV with a predetermined power to the hologram recording medium 630 fed by the intermittent feeding roller 652.

Furthermore, a heat roller 655 that is axially supported to be rotatable, a pair of discharge rollers 656 and 657, and a cutter 658 are arranged in this order at the posterior end of the ultraviolet lamp 654 in the travelling path of the hologram recording medium 630.

Here, the discharge rollers 656 and 657 serve to feed the hologram recording medium 630 so that the side of the hologram recording medium 630 close to the cover sheet 630c is wound halfway around the peripheral surface of the heat roller 655 in a contacting state. The discharge rollers 656 and 657 are connected to a stepping motor (not shown) and are rotated based on the rotation force transmitted from the stepping motor. The stepping motor rotates based on the control signal S2 supplied from the control computer 602. That is, the discharge rollers 656 and 657 are sequentially rotated by a predetermined angle corresponding to one elementary hologram every exposure of one image is completed in synchronism with the rotation of the intermittent feeding roller 652. In such a manner, the hologram recording medium 630 is reliably fed in contact with the peripheral surface of the heat roller 655 without being loosened between the intermittent feeding roller 652 and the discharge rollers 656 and 657.

The heat roller 655 includes a heating means such as a heater therein. This heating means serves to maintain the peripheral surface to be at a temperature of about 120° C. In addition, the heat roller 655 heats the photopolymer layer 630b of the fed hologram recording medium 630 with the cover sheet 630c disposed therebetween. By this heating, the degree of modulation of the refractive index of the photopolymer layer 630b is increased, and the recording image is fixed onto the hologram recording medium 630. Hence, the outer diameter of the heat roller 655 is chosen so that the recording image is fixed during the period between the contact of the hologram recording medium 630 on the peripheral surface of the heat roller 655 and the release thereof.

Further, the cutter 658 includes a cutter driving mechanism which is not shown. By driving the cutter driving mechanism, the hologram recording medium 630 being fed to the cutter 658 can be cut. This cutter driving mechanism drives the cutter 658. That is, after all the images based on the image data of the parallax image sequences are recorded on the hologram recording medium 630, the cutter 658 is driven at a state where all the image-recorded portions of the hologram recording medium 630 are ejected. In such a manner, the portion where the image data pieces are recorded is cut out of the other portions and ejected to the outside as one holographic stereogram.

Operation of Holographic Stereogram Producing System

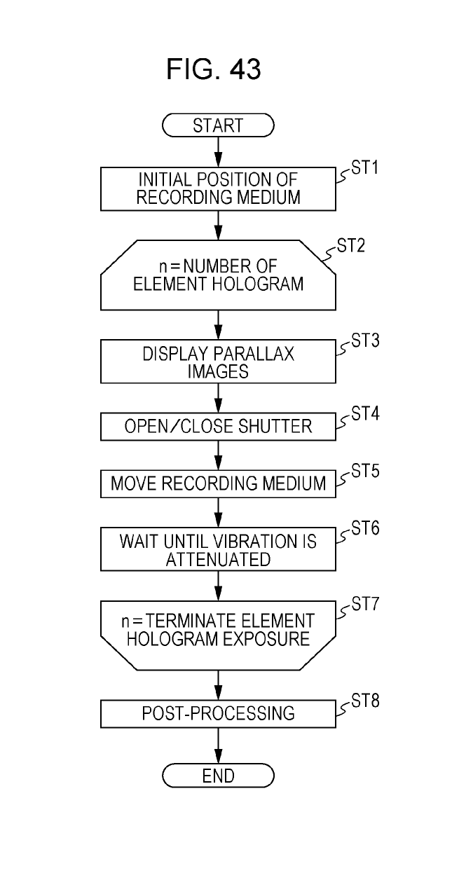

Description will be given of the operation of the holographic stereogram producing system having the above-mentioned configuration at the time of producing the holographic stereogram under the control of the control computer 602, with reference to the flowchart of FIG. 43.

In step ST1, the hologram recording medium 630 is placed at an initial position. Step ST2 is the starting step of a loop, and step ST7 is the ending step of the loop. Processing of one elementary hologram ends whenever a series of operations of steps ST3 to ST6 are executed. The steps ST3 to ST6 are repeated until processing of the entire number (n) of elementary holograms ends.

In step ST3, the control computer 602 drives the display device 641 based on the image data pieces D5 supplied from the data processing section 601 and displays the image on the display device 641. In step ST4, the control computer 602 sends the control signal S1 to the shutter 632 so that the shutter 632 is open for a predetermined time to expose the hologram recording medium 630. At this time, among the laser light beam L2 emitted from the laser light beam source 631 and transmitted through the shutter 632, a light beam L3, which is reflected by the half mirror 633, is incident on the hologram recording medium 630 as the reference light beam. At the same time, the light beam L4, which is transmitted through the half mirror 633, is changed into a projection light beam to which the image displayed on the display device 641 is projected, and is incident on the hologram recording medium 630 as the object light beam. In such a manner, one image displayed on the display device 641 is recorded on the hologram recording medium 630 as a strip-shaped elementary hologram.

Then, when recording of one image ends, in step ST5, the control computer 602 sends the control signal S2 to the stepping motor that drives the intermittent feeding roller 652 and the stepping motor that drives the discharge rollers 656 and 657. By driving the stepping motors, the hologram recording medium 630 is fed by an amount corresponding to one elementary hologram. After the hologram recording medium 630 is fed, the processing waits until vibration is absorbed (step ST6).

Subsequently, the flow returns to step ST3, and the control computer 602 drives the display device 641 based on the next image data pieces D5 supplied from the data processing section 601 and displays the next image on the display device 641. Thereafter, the same operations (ST4, ST5, and ST6) as above are sequentially repeated, whereby the images based on the image data pieces D5 supplied from the data processing section 601 are sequentially recorded on the hologram recording medium 630 as strip-shaped elementary holograms.

That is, in this holographic stereogram producing system, the images based on the image data recorded on the storage device 612 are sequentially displayed on the display device 641. At the same time, the shutter 632 is open for each image, and the images are sequentially recorded on the hologram recording medium 630 as strip-shaped elementary holograms. At this time, since the hologram recording medium 630 is fed by an amount corresponding to one elementary hologram for each image, the elementary holograms are consecutively arranged in the horizontal (lateral) direction during the viewing. As a result, images having the parallax information in the horizontal direction are recorded on the hologram recording medium 630 as a plurality of elementary holograms which are laterally consecutive. In such a manner, a holographic stereogram with the horizontal parallax can be obtained.

While the processes up to the exposure have hitherto been described, the print process may be completed after post-processing (step ST8) is performed as necessary. When a photopolymer which is necessary for illumination of ultraviolet rays and heating is used, the apparatus having a configuration as shown in FIG. 42 may be used. That is, the ultraviolet rays UV are illuminated from the ultraviolet lamp 654. In such a manner, the polymerization of the monomers M is completed. Subsequently, the hologram recording medium 630 is heated by the heat roller 655, whereby the recorded images are fixed.

Then, when all the portions where the images are recorded are ejected to the outside, the control computer 602 supplies the control signal S2 to the cutter driving mechanism to drive the cutter driving mechanism. In such a manner, the portions of the hologram recording medium 630 where the images are recorded are cut by the cutter 658 and ejected to the outside as one holographic stereogram.

Through the above processes, the holographic stereogram with the horizontal parallax is obtained.

Configuration of Replication Apparatus

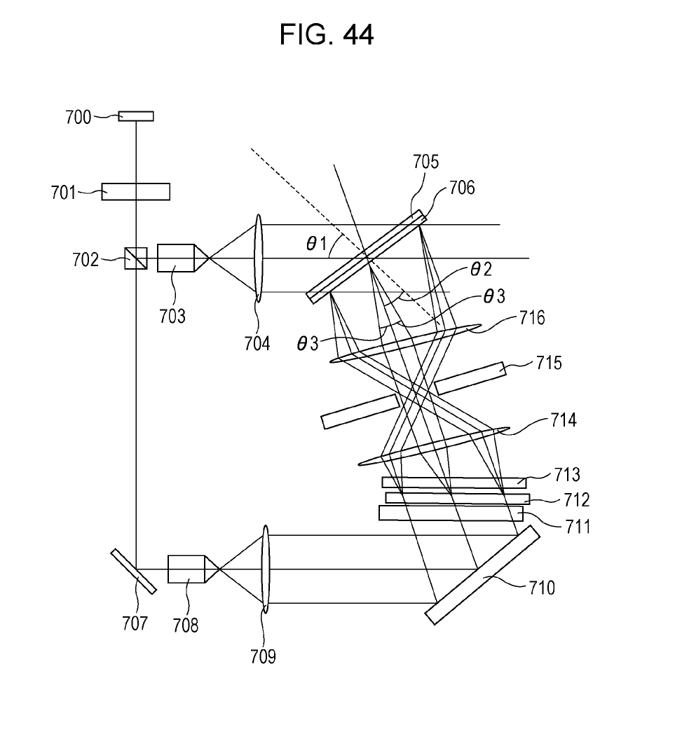

As shown in FIG. 44A, the first embodiment of the image recording medium is configured. A laser light beam emitted from a laser light beam source 700 passes through a half-wavelength plate 701 and is incident on a polarizing light beam splitter 702. The half-wavelength plate 701 rotates a polarization plane of the laser light beam by an angle of 90°. The laser light beam (S-polarized light beam) is reflected by the polarizing light beam splitter 702, and the laser light beam is spread by a spatial filter 703. The laser light beam (that is, reference light beam) from the spatial filter 703 is incident on a collimator lens 704. The laser light beam which is converted into a parallel light beam by the collimator lens 704 is illuminated onto a hologram recording medium 705 having a layer made from a photosensitive material and a hologram master 706.

The hologram master 706 is a holographic stereogram which is produced in the above-mentioned manner and which has parallax in both the horizontal and vertical directions when viewed. The hologram master 706 may be a holographic stereogram having parallax only in the horizontal direction. Further, the hologram master 706 may be a real-scene hologram which is produced by illuminating an object with a laser light beam. The hologram recording medium 705 and the hologram master 706 are directly bonded to each other, or closely bonded to each other through a refractive index adjustment liquid (referred to as an index matching liquid). On the hologram recording medium 705, interference fringes formed by light diffracted by the hologram master 706 and the reference light beam and interference fringes formed by additional information light and the reference light beam are recorded.

The laser light beam (P-polarized light beam) passed through the polarizing light beam splitter 702 is reflected by the mirror 707 and incident on a spatial filter 708. The laser light beam spread by the spatial filter 708 is converted into a parallel light beam by a collimator lens 709 and incident on the mirror 710.

The laser light beam reflected by the mirror 710 passes through a diffuser panel 711 and is incident on a liquid crystal display panel 712 serving as a spatial light modulation element. The diffuser panel 711 widens the viewing angle of a replicated holographic stereogram by diffusing the laser light beam from the mirror 710 in at least one of the width direction and the longitudinal direction of an elementary hologram. The laser light beam diffused by the diffuser panel 711 is narrowed down by a diaphragm (mask) 715, and the viewing angle is widened only when viewed from the front.

Although not shown in the drawing, a liquid crystal driving section, for example, a microcomputer is connected to the liquid crystal display panel 712. An image of the additional information is displayed on the liquid crystal display panel 712 by the liquid crystal driving section. As the additional information, identification information such as a number (serial number) unique to each hologram is used. A polarizing plate 713 is provided on a light-emitting surface of the liquid crystal display panel 712. The polarization plane is rotated by the polarizing plate 713, and P-wave is converted into S-wave.

The additional information light, which is generated by the liquid crystal display panel 712 and passes through the polarizing plate 713, is incident on the hologram master 706 through an imaging optical system which is formed of a projection lens 714, the diaphragm 715, and a projection lens 716. In the hologram recording medium 705, interference fringes are recorded, which are generated by the incident laser light beam and the light beam in which the light diffracted by the hologram master 706 and the additional information light passed through the hologram master 706 are superimposed. Accordingly, it is possible to record the additional information in a hologram area of the hologram master 706. Further, optical elements, which are arranged in the optical path extending from the mirror 710 to the hologram recording medium 705, are mounted at a prescribed position by a supporting member such as a rail.

Viewing Angle

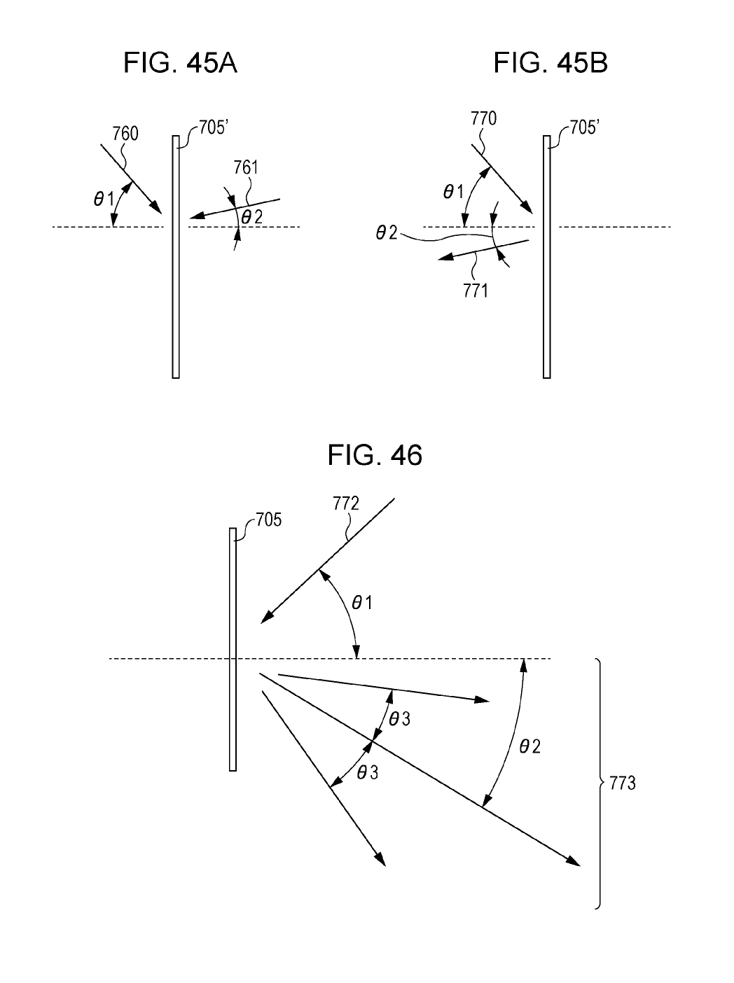

Description will be given of the general relationship between a viewing angle at the time of recording the hologram recording medium 705 and a viewing angle at the time of reproducing the recorded hologram recording medium 705, with reference to FIGS. 45A and 45B. As shown in FIG. 45A, during the recording, the reference light beam 760 is incident on the hologram recording medium 705′ at an incident angle of θ1, and the object light beam 761 is incident on the hologram recording medium 705′ from the opposite side of the hologram recording medium 705′ at an incident angle of θ2. Interference fringes, which are formed by the object light beam 761 and the reference light beam 760, are recorded on the hologram recording medium 705′.

As shown in FIG. 45B, when the hologram recording medium 705′ on which the interference fringes are recorded in the above-mentioned manner is illuminated with the illumination light beam 770 at an incident angle of θ1, the object light beam (reproduction light beam) 771 is emitted by the hologram recording medium 705′ at an exit angle of θ2. As a result, the object light beam is visible from a viewpoint in the extension direction of the object light beam 771.

In the embodiment of the image recording medium, as shown in FIG. 44, the reference light beam is incident on the hologram recording medium 705 at an incident angle of θ1, the additional information light is incident on the hologram recording medium 705 at an incident angle of θ2, and the additional information light has a diffusion angle of ±θ3 due to the diffuser panel 711 and the diaphragm 715 disposed near the liquid crystal display panel 712. During the reproduction, as shown in FIG. 46, the reference light beam 772 is incident on the replicated hologram medium 705 at the incident angle of θ1. The additional information light 773, which is reproduced by the hologram recording medium 705, has the diffusion angle of ±θ3 about the exit angle of θ2. In other words, it means that the additional information is visible only when the viewpoint is in an angular range of ±θ3 about the exit angle of θ2. In this case, the magnitude of the diffusion angle ±θ3 can be freely changed in accordance with the specification of the diffuser panel. However, generally, the additional information is reproduced with an intensity distribution in which the intensity gradually decreases as it retreats from the center portion where the intensity is at the maximum. In such a manner, it is possible to realize a vision which is different from that of a switching hologram recorded in a two-step method.

In the embodiment of the image recording medium, it is possible to set the central angle of the viewpoint, from which the additional information image is visible when the replicated hologram recording medium 705 is reproduced, on the basis of the incident angle θ2 formed between the optical axis of the additional information light and the hologram recording medium 705. Further, by controlling the spreading of the additional information light through the imaging optical system which is formed of the projection lenses 714 and 716 and the diaphragm 715, it is possible to set the range of the viewpoints from which the additional information image is visible during the reproduction.

Accordingly, the hologram recording medium 705, which is replicated by the replication apparatus according to the embodiment of the image recording medium, has the characteristics described below, whereby it is possible to view the hologram image and the additional information image independently from each other by moving the viewpoint. The viewpoint may be moved by either moving the viewer's eyes or moving the hologram recording medium.

When the hologram recording medium is illuminated at a predetermined angle, a hologram image, which has consecutive parallax at least in the horizontal direction when the viewpoint is moved in the left-right direction with respect to the normal line and of which the viewing angle is controlled in the up-down direction, is reproduced. In this case, the viewing angle in the up-down direction may not be controlled.

When the viewpoint is moved in at least one of the up-down direction and the left-right direction relative to the normal line of the hologram recording medium, a refractive index modulation is recorded on a single layer of material so that another inconsecutive image (additional information image) which is different from the hologram image is reproduced.

The hologram image is a hologram or a holographic stereogram on which an image is recorded. A hologram, which is reproduced from a different angle in at least one of the up-down direction and the left-right direction, may be a two-dimensional image that is positioned in an approximately constant plane in the depth direction. The two-dimensional image, which is positioned in an approximately constant plane in the depth direction, is the additional information image having identification information.

The depth, at which the two-dimensional image is positioned, can be freely set by image processing or by adjusting the position of the diffuser panel. By positioning the two-dimensional image at a depth different from that of the hologram or the holographic stereogram on which an image is recorded, a viewer can easily differentiate and recognize the image and the two-dimensional image (identification information). Since the sharpness of an illumination light from a diffusion light source decreases as it goes greatly away from the surface, good visibility can be obtained by positioning the two-dimensional image at an appropriate depth of, for example, about 2 mm from the surface.

In the embodiment of the image recording medium, it is possible to record an additional information image (such as a serial number or mechanically readable barcode information) in a hologram area. Further, since the range of the viewpoint from which the additional information image is visible can be defined, it is possible to prevent the additional information image from disturbing the viewing of the original hologram image.

In the embodiment of the image recording medium, a hologram obtained by the one-step holographic stereogram recording method is used as a hologram on which an image is recorded. In the image recording medium, although a so-called real-scene hologram produced by illuminating a laser light beam to a modeling object may also be used, the use of the one-step holographic stereogram is advantageous from the perspective of the authentication function. That is, when the elementary holograms of the one-step holographic stereogram have a strip shape having a width of 0.1 mm, strips having a width of 0.1 mm can be observed through a magnifying lens, and dark portions are observed between the adjacent strips. On the other hand, such strips are not observed in the two-dimensional image which is identification information. Such a configuration, in which images are divided into areas and the respective pieces of identification information are consecutive, provides distinctive features, which serve as the point that identifies the recorded hologram.

### First Modified Example of Embodiment of Image Recording Medium

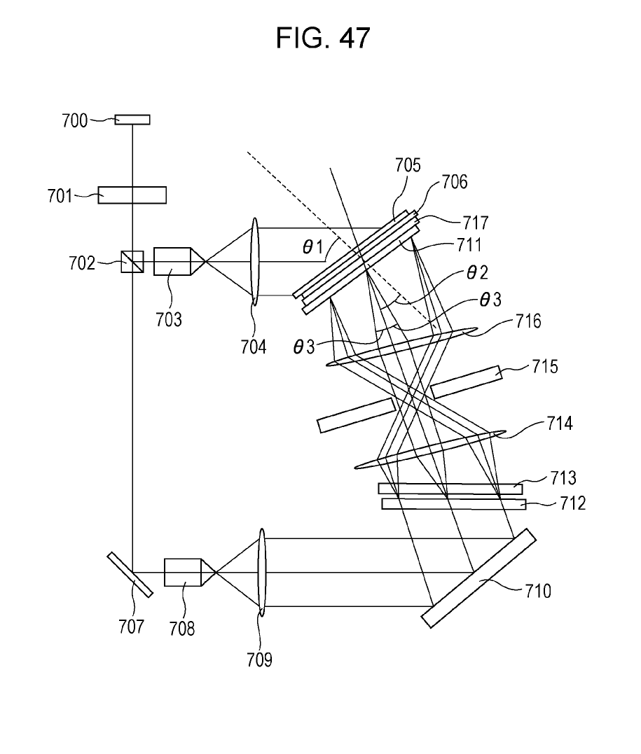

As shown in FIG. 47, the diffuser panel 711 may be disposed, for example, on an incidence side of the light from the projection lens 716 if such a position provides an optically equivalent effect. In this case, the range of the viewing angle of the additional information light can be controlled by the diffusion angle of the diffuser panel. In addition, in the configuration of FIG. 47, a louver 717 is disposed between the diffuser panel 711 and the hologram master 706. By providing the louver 717, it is possible to prevent unnecessary light such as reflection light from entering the hologram master 706. The louver 717 has a configuration in which black planar absorption layers are disposed in a transparent plate at predetermined intervals. With the absorption layers of the louver 717, the additional information light and the diffusion components pass through the louver 717, while the replication parallel light beam transmitted through the collimator lens 704 does not pass through the louver 717.

### Second Modified example of Embodiment of Image Recording Medium

As mentioned above, when the additional information image of the liquid crystal display panel 712 is imaged on the entire plane near the hologram master 706 by an optical system of which the optical axis is not disposed on the normal line, it is necessary to tilt the display surface of the liquid crystal display panel 712 with respect to the plane of the hologram master 706. Since the liquid crystal display panel 712 is not designed for oblique incidence of light, there is a problem in that light utilization efficiency uniformity may decrease and scattering may increase.

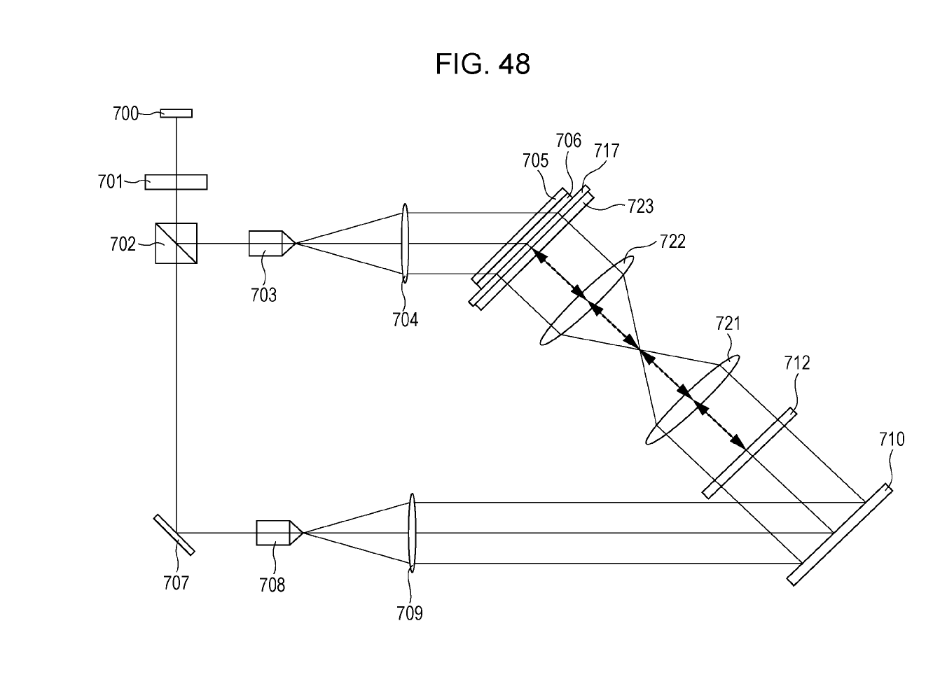

An example of a replication apparatus shown in FIG. 48 can solve such a problem. Specifically, the display surface of the liquid crystal display panel 712 (including the polarizing plate 713) is disposed so as to be in parallel to the plane of the hologram master 706. As shown in FIG. 48, the additional information light passes through a projection lens 721, a projection lens 722, and a light deflection sheet 723 and the louver 717 and is incident on the hologram master 706.

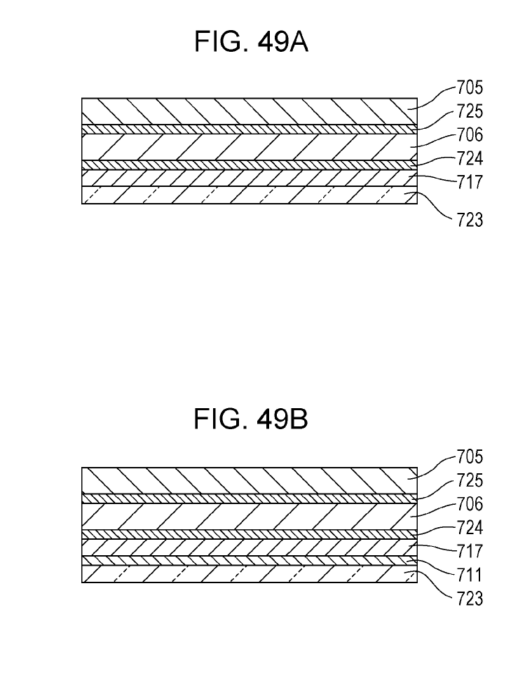

As shown in FIG. 49A, the louver 717 is coated on the hologram master 706 with a contact layer 724 disposed therebetween, and the hologram recording medium 705 is coated thereon with a contact layer 725 disposed therebetween. As the light deflection sheet 723, a holographic optical element, a diffractive optical element, a refractive angle control prism sheet, and the like can be used. The light deflection sheet 723 deflects the additional information light in a predetermined direction (incident angle). As shown in FIG. 49B, the diffuser panel 711 may be disposed near the light deflection sheet 723 so as to widen the viewing angle appropriately. The light deflection sheet 723 is provided in order to eliminate a difference in optical distance and realize a state where light is easily focused on the entire surface.

Control of Viewing Angle

Although it is described that the viewing angle can be controlled so as to have an angle as designed, in order to produce holograms that are bright and make the holograms easier to see, the viewing angle is preferably controlled so as to have an angle as below.

The angle of the reference light beam with respect to the normal line of the hologram surface is set as θ, and the angle, at which the two-dimensional image is reproduced with a maximum luminance in the vertical direction, with respect to the normal line of the hologram surface is set as φ, and the angle, at which the hologram or holographic stereogram is reproduced at a maximum luminance, is set to be approximately (θ+φ)/2.

Alternatively, the angle of the reference light beam with respect to the normal line of the hologram surface is set as θ, and the angle, at which the two-dimensional image is reproduced with a maximum luminance in the vertical direction, with respect to the normal line of the hologram surface is set as φ, and the angle, at which the hologram or holographic stereogram is reproduced at a maximum luminance, is set to be approximately (φ−θ)/2.

Further, for example, a single hologram image and a single two-dimensional image may be included. In this case, when the angle of the reference light beam with respect to the normal line of the hologram surface is set as θ, the angle, at which the two-dimensional image is reproduced at a maximum luminance in the vertical direction, with respect to the normal line of the hologram surface is set to be −θ/3±θ/3, and the angle, at which the hologram or holographic stereogram having the images recorded thereon is reproduced at a maximum luminance, with respect to the normal line of the hologram surface is similarly set to be +θ/3±θ/3. Then, the angle of the reference light beam and the maximum luminance angles of the respective images are equally separated from each other. As a result, it is possible to efficiently record the images. Similarly, when the angle of the reference light beam with respect to the normal line of the hologram surface is set as θ, the angle, at which the two-dimensional image is reproduced at a maximum luminance in the vertical direction, with respect to the normal line of the hologram surface may be set to be +θ/3±θ/3, and the angle, at which the hologram or holographic stereogram having the images recorded thereon is reproduced at a maximum luminance, with respect to the normal line of the hologram surface may be similarly set to be −θ/3±θ/3.

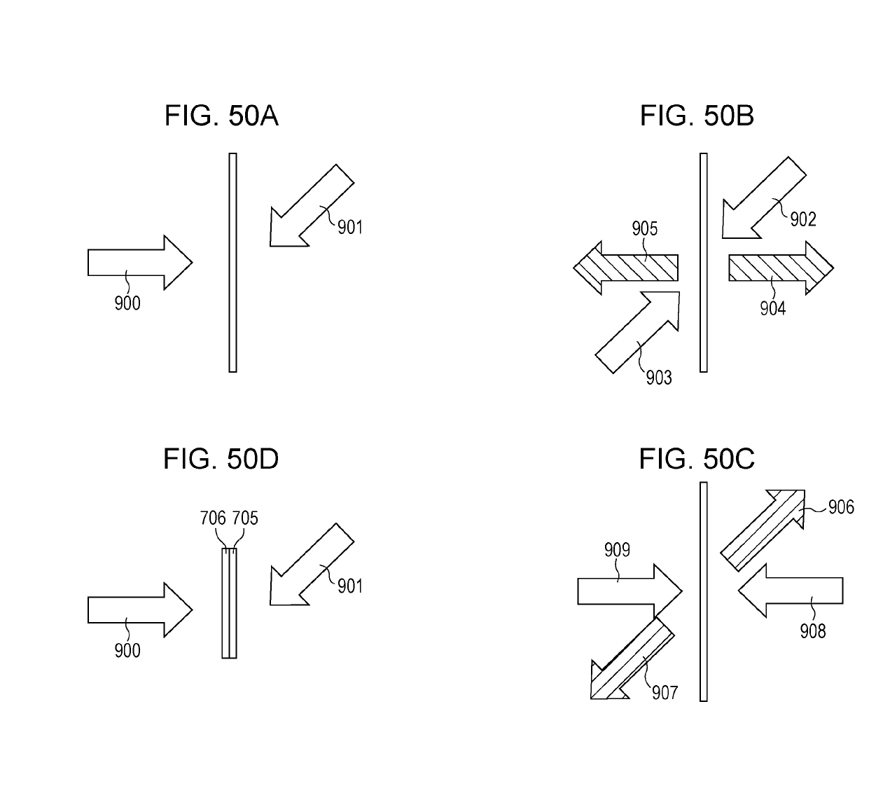

The reason why the setting of the angles is preferable will be described with reference to FIGS. 50A to 50D, FIGS. 51A to 51C, and FIGS. 52A and 52B. FIG. 50A shows an example of recording information on a reflective hologram using two parallel light beams. The incident angle of the reference light beam from a direction 901 is set to θ=45°, and the incident angle of the object light beam from a direction 900 is set to 180°.

As shown in FIG. 50B, the recorded hologram is illuminated and reproduced. Similarly to the reference light beam, when the illumination light beam is illuminated to the hologram from a direction 902, a diffraction light beam is emitted in a direction 904. When the illumination light beam is illuminated from a direction 903 which is at an angle of 180° with respect to the direction 902, a diffraction light beam is emitted in a direction 905. In this case, a pseudoscopic image (a three-dimensional image of which the depth information is reversed from that of a real object) is reproduced. As shown in FIG. 50C, when the illumination light beam is illuminated from a direction 908, a diffraction light beam is emitted in a direction 906 due to the Bragg diffraction conditions. When the illumination light beam is illuminated from a direction 909, a diffraction light beam is emitted in a direction 907, and a pseudoscopic image is reproduced.

In the image recording medium, as shown in FIG. 50D, since the hologram master 706 is replicated in a state of being optically closely bonded to the target medium (hologram recording medium) 705, it is necessary to make the reference light beam incident from the direction 901. When a two-dimensional image is recorded from a direction 900, and an image is present on the hologram master 706, a diffraction of light occurs due to a hologram of the hologram master 706 as illustrated as a diffraction light beam in FIG. 50C or 50D. As a result, sometimes, a laser light beam for recording a two-dimensional identification image (additional information) may not reach the target medium 705. Although the laser light beam reaches the target medium 705, a problem arises in that the luminance of the two-dimensional image is changed by the image on the hologram master 706. The light beam incident from the direction 900 is not a parallel light beam but is actually a certain concentrated light beam, and in some cases, the light beam may be influenced by this effect. Thus, it is necessary to select an incident angle at which the incident light beam is least affected.

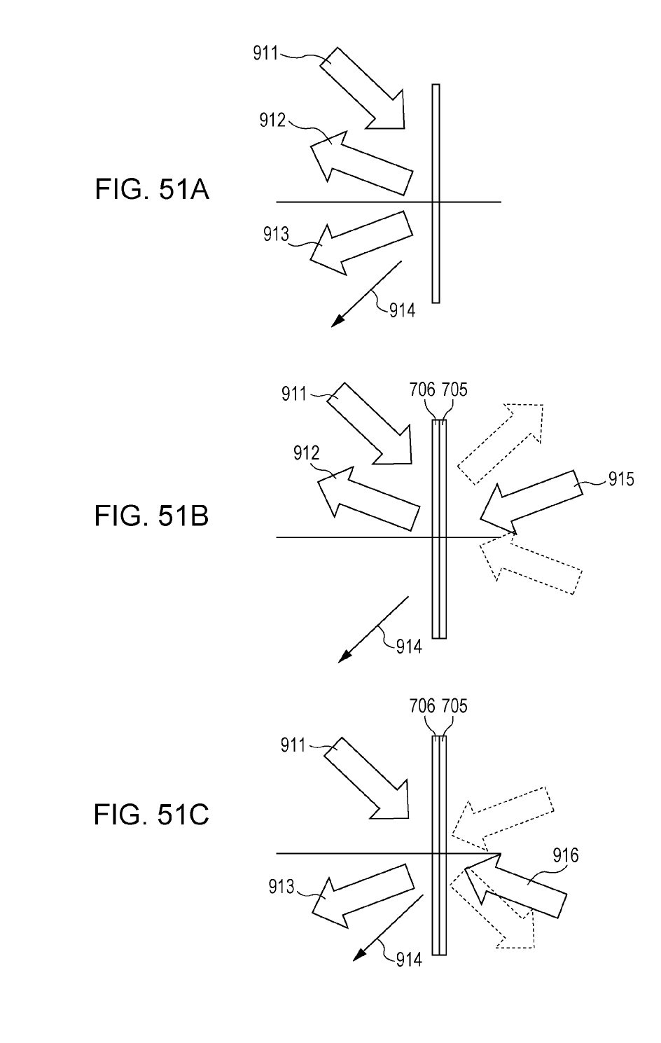

In the image recording medium, as shown in FIGS. 51A to 51C, the angles during the replication (recording) are chosen considering the above-mentioned facts. As shown in FIG. 51A, the reference light beam is incident from an obliquely upward direction 911 at an angle of 45°. When an image is switched in two up-down directions, the image reproduction angle is set to an obliquely upward direction 912 at an angle of 15° and an obliquely downward direction 913 at an angle of 15°. In this case, the angle between the incidence direction of the reference light beam and the upward switching direction is 30°, and the difference between the upper and lower image reproduction angles is also 30°, which is separated by an angle of 30° with respect to the direction 914 of the regular reflection of the reference light beam. Thus, the reproduced image can be easily viewed. The regular reflection angle is the mirror reflection angle of the reference light beam. When a hologram is illuminated with a light source light beam, the light source light beam and the hologram image may enter the eyes of a viewer at the same time. Thus, the viewer may have difficulties in viewing the hologram image.

When a first image reproduced at the angle of the obliquely upward direction 912 is used as the hologram master 706, the incident angle of the additional information light beam is set as indicated by 915 in FIG. 51B. Light beams in the directions indicated by the dashed lines are the returning diffraction light beams generated by Bragg diffraction. When a second image reproduced at the angle of the obliquely downward direction 913 is used as the hologram master 706, the incident angle of the additional information light beam is set as indicated by 916 in FIG. 51C. Light beams in the directions indicated by the dashed lines are the returning diffraction light beams generated by the Bragg diffraction.

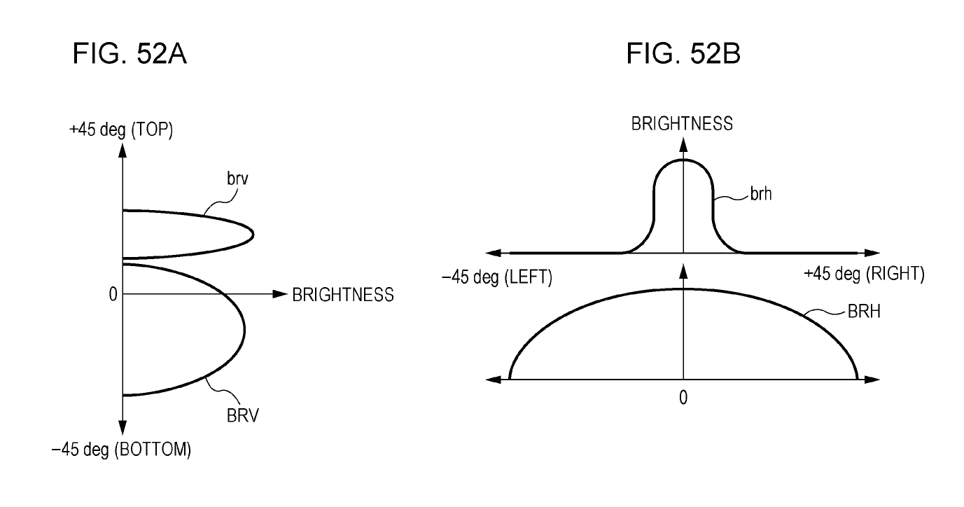

Accordingly, on the replicated hologram recording medium 705, as shown in FIGS. 52A and 52B, the hologram image and the additional information image can be viewed independently from each other by moving the viewpoint. FIG. 52A shows a case where the viewpoint is moved in the vertical direction, and FIG. 52B shows a case where the viewpoint is moved in the horizontal direction. The viewpoint can be moved by moving the viewer's eyes or rotating the hologram recording medium. For example, the movement of the viewpoint in the vertical direction can be realized by moving the viewer's eyes vertically within an angular range of ±45° with respect to the normal line of the hologram recording medium while fixing the hologram recording medium. Alternatively, the same effect can be realized by rotating the hologram recording medium within an angular range of ±45° about the horizontal axis while fixing the position of the viewer's eyes on the normal line. Further, the movement of the viewpoint in the horizontal direction can be realized by moving the viewer's eyes laterally within an angular range of ±45° with respect to the normal line of the hologram recording medium while fixing the hologram recording medium. Alternatively, the same effect can be realized by rotating the hologram recording medium within a predetermined angular range of ±45° about the vertical axis while fixing the position of the viewer's eyes on the normal line.

In FIG. 52A, the curve BRV shows a change in luminance of the hologram image when the viewpoint is moved in the vertical direction, and the curve brv shows a change in luminance of the two-dimensional image when the viewpoint is moved in the vertical direction. In FIG. 52B, the curve BRH shows a change in luminance of the hologram image when the viewpoint is moved in the horizontal direction, and the curve brh shows a change in luminance of the two-dimensional image when the viewpoint is moved in the horizontal direction. As shown in FIGS. 52A and 52B, when the hologram recording medium is illuminated at a predetermined angle, a hologram image which has continuous parallax in the horizontal direction when the viewpoint is moved in the horizontal direction, and of which the viewing angle is controlled in the up-down direction is reproduced. When the viewpoint is moved in the up-down direction relative to the normal line of the hologram recording medium, another inconsecutive image (two-dimensional image) which is different from the hologram image is reproduced. In the example mentioned above, when the angle of the reference light beam is θ=45°, and the angle of the parallax hologram image is θ=−15°, the luminance in the vertical direction of the two-dimensional image increases at a viewpoint of (θ+φ)/2=(45−15)/2=15°. In the horizontal direction, the two-dimensional image can be viewed in a range of viewing angles of 0°±15°.

When the angle of the reference light beam is θ=45°, and the angle of the parallax hologram image is θ=15°, the two-dimensional image can be easily viewed at a viewpoint of (φ−θ)/2=(15−45)/2=−15°.

Further, when the angle of the reference light beam is θ=45°, and the angle of the parallax hologram image is φ=0°, both good visibility and good producibility can be achieved by setting the viewpoint at (θ+φ)/2=(45−0)/2=22.5° or (φ−θ)/2=(0−45)/2=−22.5°.

In addition, the above-mentioned settings of the angles regarding the image recording medium are typical examples. However, the settings can be changed in various ways depending on whether which one of the hologram image and the additional information will be primarily viewed. The number of images switched in the vertical direction is not limited to two, and plural kinds of vertical parallax information may be included in the hologram master, and additional information may be recorded at an angle that does not overlap the angles of the vertical parallaxes.

For example, when the angle of the reference light beam is 45°, the angles of two parallax hologram images are +22.5° and 0°, and the two-dimensional image is recorded at an angle of −22.5°, a good hologram can be obtained. Likewise, when the angle of the reference light beam is 45°, the angles of two parallax hologram images are −22.5° and 0°, and the two-dimensional image is recorded at an angle of 22.5°, a good hologram can be obtained.

### Second Embodiment of Replication Apparatus

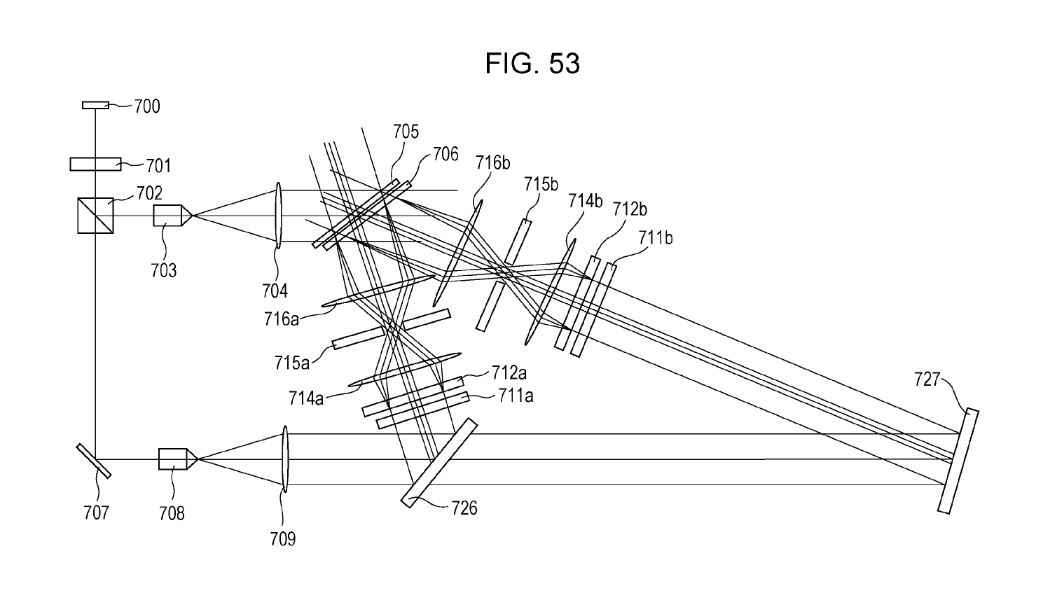

As shown in FIG. 53, the reference light beam and the laser light beam are branched by the polarizing light beam splitter 702, and the reference light beam passes through the spatial filter 703 and the collimator lens 704 and is incident on the hologram recording medium 705. The branched laser light beam is reflected by the mirror 707 and is incident on the half mirror 726 after passing through the spatial filter 708 and the collimator lens 709.

The laser light beam reflected by the half mirror 726 is a first branched laser light beam. The laser light beam transmitted through the half mirror 726 is incident on the mirror 727. The laser light beam reflected by the mirror 727 is a second branched laser light beam. Similarly to the first embodiment, the first branched laser light beam passes through a diffuser panel 711a and is incident on a liquid crystal display panel 712a (including a polarizing plate). The additional information image of the liquid crystal display panel 712a passes through an imaging optical system (including projection lens 714a and 716a and a diaphragm 715a) and the hologram master 706 and is imaged on the hologram recording medium 705.

On the other hand, the second branched laser light beam passes through a diffuser panel 711b and is incident on a liquid crystal display panel 712b (including a polarizing plate). The additional information image of the liquid crystal display panel 712b passes through an imaging optical system (including projection lenses 714b and 716b and a diaphragm 715b) and the hologram master 706 and is imaged on the hologram recording medium 705. The incident angle on the hologram recording medium 705, of the additional information light generated from the first branched laser light beam is different from the incident angle on the hologram recording medium 705, of the additional information light generated from the second branched laser light beam. Accordingly, the viewpoint from which the additional information image of the liquid crystal display panel 712a is visible can be made different from the viewpoint from which the additional information image of the liquid crystal display panel 712b is visible. As a result, two kinds of additional information images corresponding to two viewpoints are visible.

The two branched laser light beams are simultaneously illuminated on the hologram recording medium 705. However, the two branched laser light beams may be time-sequentially illuminated on the hologram recording medium 705. Further, three or more numbers of branched laser light beams may be used.

### Third Embodiment of Replication Apparatus

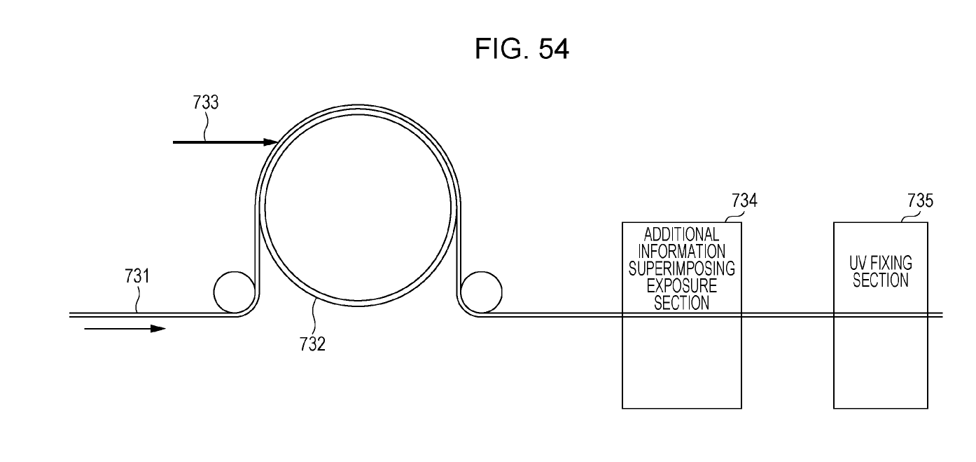

In the above-mentioned embodiment, the reference light beam for contact printing is branched and used for recording plural kinds of additional information. However, as shown in FIG. 54, the additional information may be recorded using a laser light beam different from the laser light beam used for contact printing.

In the example shown in FIG. 54, contact printing is performed, and the additional information is recorded before the hologram is fixed by a UV fixing section 735. A hologram recording film 731 continuously fed from a roller (not shown) is wound around a roller. The hologram recording film 731 is a film in which a photosensitive material is coated on a transparent base film. A hologram master 732 is bonded to the circumferential surface of the roller. The hologram master 732 is, for example, an image having continuous parallax in the horizontal direction. A replication laser light beam 733 is illuminated in a state where the hologram master 732 and the hologram recording film 731 are closely bonded to each other, whereby the hologram on the hologram master 732 is replicated on the hologram recording film 731.

The replication is performed by transferring the hologram recording film 731. The shutter of a replication laser 733 (not shown) is closed at the same time as the stopping of the transferring of the hologram recording film 731, and the replication laser 733 is illuminated. After the replication, the hologram recording film 731 is transferred to an additional information superimposing exposure section 734, and the additional information is recorded thereon. The same configuration as the above-mentioned replication apparatus can be used as a configuration for recording the additional information. The replicated hologram recording film 731 on which the additional information is recorded is transferred from the additional information superimposing exposure section 734 towards the UV fixing section 735. A procedure where the additional information is first recorded, and the contact printing of a hologram and the fixing are performed is also possible.

### Fourth Embodiment of Replication Apparatus

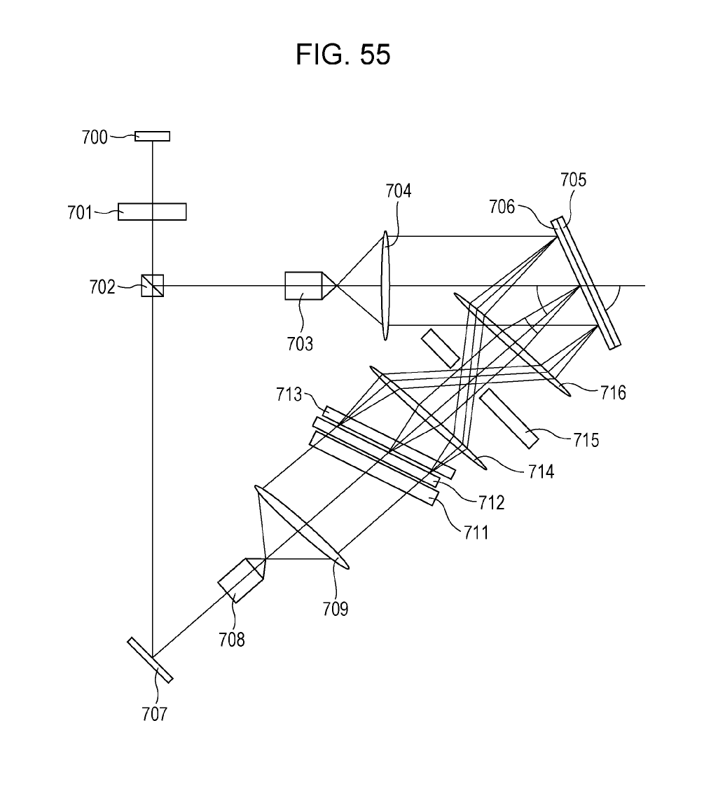

The embodiments mentioned above are directed to examples where the hologram master is a reflective hologram. However, the present technology can be applied to a case where the hologram master is a transmission hologram. As shown in FIG. 55, the hologram master 706 and the hologram recording medium 705 are closely bonded to each other. The reference light beam is separated by the polarizing light beam splitter 702 and incident on the hologram master 706 after passing through the spatial filter 703 and the collimator lens 704.

The laser light beam reflected by the mirror 707 is incident on the liquid crystal display panel 712 after passing through the spatial filter 708, the collimator lens 709, and the diffuser panel 711. The additional information light from the liquid crystal display panel 712 is incident on the hologram master 706 after passing through the polarizing plate 713 and a coupling optical system (including the projection lenses 714 and 716 and the diaphragm 715). The hologram on the hologram master 706 and the additional information image are superimposed and recorded on the hologram recording medium 705.

According to another embodiment of the image recording medium, the two-dimensional image (additional information) and the hologram image may be reproduced with different colors so that they can be easily differentiated. The results of a color separability test on 30 examinees under white light illumination showed that the colors were easily differentiated if the reproduction peak wavelengths are separated by an amount of 25 nm or more, for example.

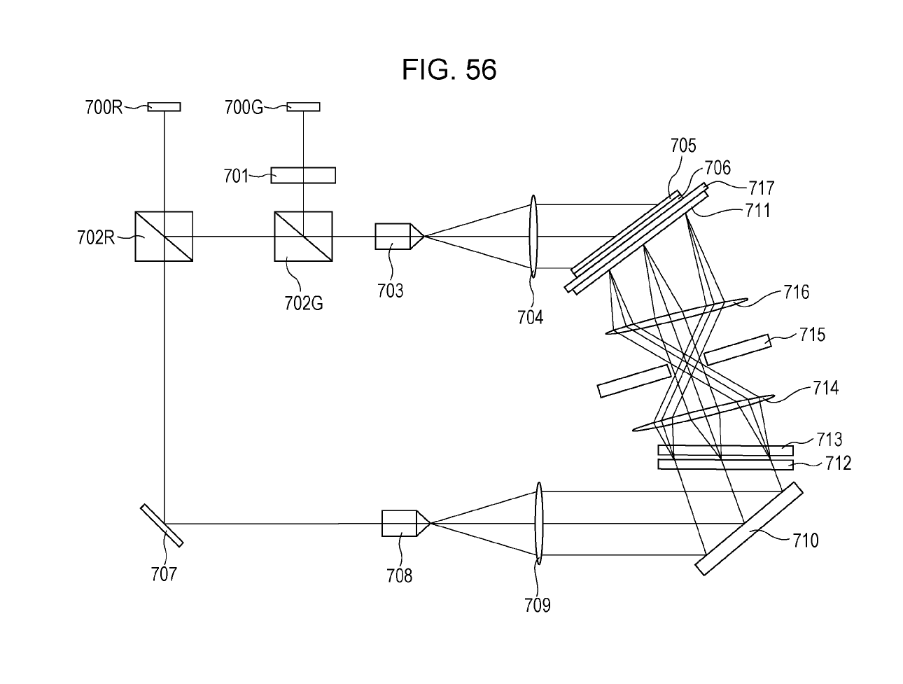

There may be a plurality of methods of changing the colors of the additional information and the image hologram. One example thereof is a multiple exposure method where the wavelengths of a recording laser light beam are changed. As shown in FIG. 56, a red laser light beam emitted from a red laser light beam source 700R (for example, HeNe laser having a wavelength of 633 nm) for recording two-dimensional images is branched by a polarizing light beam splitter 702R. A green laser light beam source 700G (for example, semiconductor excited laser using 2nd-order harmonics having a wavelength of 532 nm) for image replication is provided.

A green laser light beam is incident on a polarizing light beam splitter 702G after passing through the half-wavelength plate 701. The red laser light beam branched by the polarizing light beam splitter 702R is also incident on the polarizing light beam splitter 702G. The red laser light beam and the green laser light beam are combined by the polarizing light beam splitter 702G and incident on the spatial filter 703. The laser light beam from the spatial filter 703 is converted into a parallel light beam after passing through the collimator lens 704, and the parallel light beam is illuminated on a hologram recording medium 705 and a hologram master 706.

The red laser light beam branched by the polarizing light beam splitter 702R is reflected by the mirror 707 and incident on the spatial filter 708. A laser light beam spread by the spatial filter 708 is incident on the mirror 710 after passing through the collimator lens 709. The laser light beam reflected by the mirror 710 is incident on the liquid crystal display panel 712 serving as a spatial optical modulation element. A liquid crystal driving section (for example, a microcomputer) which is not shown is connected to the liquid crystal display panel 712. An image of the additional information is displayed on the liquid crystal display panel 712 by the liquid crystal driving section. The polarizing plate 713 is provided on a light-emitting surface of the liquid crystal display panel 712. The polarization plane is rotated by the polarizing plate 713, and P-wave is converted into S-wave.

In the configuration of FIG. 56, the diffuser panel 711 is disposed on the incidence side of the light from the projection lens 716. The additional information light transmitted through the polarizing plate 713 and generated by the liquid crystal display panel 712 is incident on the diffuser panel 711 after passing through an imaging optical system which includes the projection lens 714, the diaphragm 715, and the projection lens 716.

Further, in the configuration of FIG. 56, the louver 717 is disposed between the diffuser panel 711 and the hologram master 706. By providing the louver 717, it is possible to prevent unnecessary light such as reflection light from entering the hologram master 706. The louver 717 has a configuration in which black planar absorption layers are disposed in a transparent plate at predetermined intervals. With the absorption layers of the louver 717, the additional information light and the diffusion components pass through the louver 717, while the replication parallel light beam transmitted through the collimator lens 704 does not pass through the louver 717.

Interference fringes which are formed by light in which the light diffracted by the hologram master 706 and the additional information light passed through the hologram master 706 are superimposed and the incident laser light beam are recorded on the hologram recording medium 705. As a result, it is possible to record the green replication image and the red two-dimensional image in a hologram area of the hologram master 706. The red image and the green image may be recorded at the same time and may be recorded time-sequentially. The same configuration as the embodiments mentioned above can be used as an optical configuration for replication and recording the additional information.

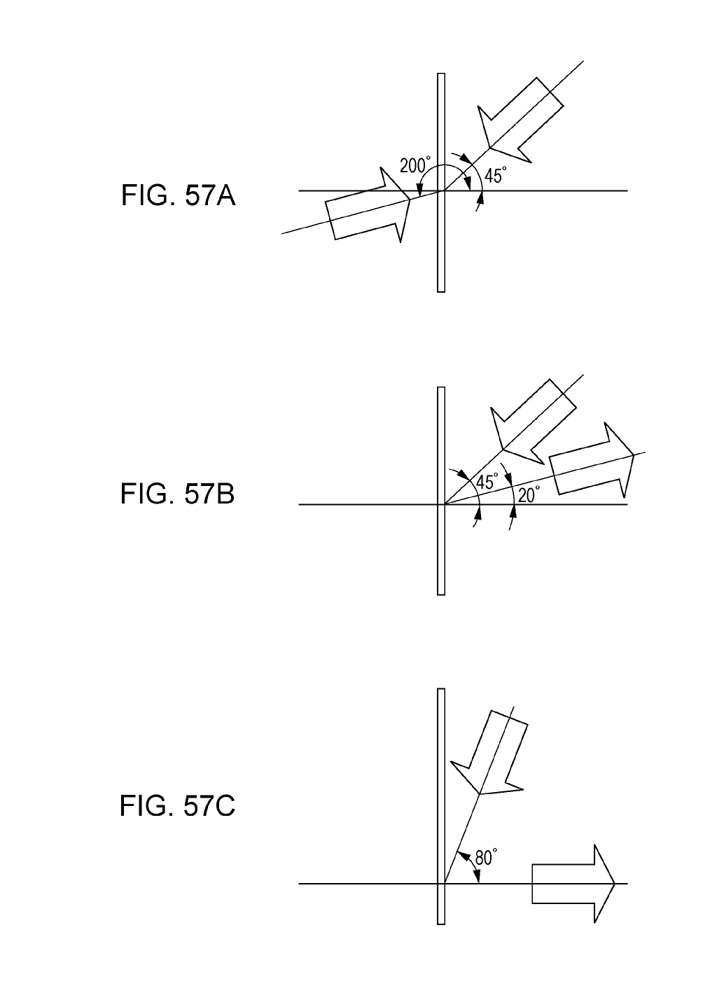

Another method of changing the colors of the additional information and the image hologram will be described with reference to FIGS. 57A to 57C. In this method, only an image replication laser is used rather than using an additional laser, and colors having wavelengths different from that of the original laser are produced and recognized as different colors. As shown in FIG. 57A, during the recording, a green laser having a wavelength of 532 nm, for example, is used, and the angle of the reference light beam is set to 45°, and the incident angle of the object light beam is set to 200°.

As shown in FIG. 57B, during the reproduction, when the illumination light is incident at an incident angle of 45°, the reproduced light beam which is emitted at an angle of 20° appears green. On the other hand, as shown in FIG. 57C, when the illumination light is incident at an incident angle of 80°, the reproduced light beam which is emitted at an angle of 0° (the front) appears bluish with a wavelength of about 500 nm. Although actually such changes in the colors of the reproduced light beams may depend on a change in thickness of a holographic recording material, the mobility of the material, and the like, the changes result from the shift of the reproduction wavelength under the Bragg diffraction conditions. By using this principle, the color of the replicated image can be made different from the color of the additional information image at an intended diffraction angle. Thus, the two kinds of information can be easily differentiated.

While specific embodiments of the image recording medium have been described, the present technology is not limited to these embodiments but may be modified in various ways. For example, image information other than identification information such as a serial number, a manufacturer name, a lot number, a one-dimensional barcode, or a two-dimensional barcode may be recorded as the additional information. Although the additional information was projected at a magnification of 1 using a spatial optical modulation element, the additional information may be projected at a magnification of larger or smaller than 1. Further, two or more kinds of additional information may be recorded. A film-shaped hologram recording medium may be used as the hologram recording media of other embodiments. In the above description, although the liquid crystal display panel was used as a spatial optical modulation element, other elements other than the liquid crystal display panel may be used.

The present application contains subject matter related to that disclosed in Japanese Priority Patent Application JP 2011-031670 filed in the Japan Patent Office on Feb. 17, 2011, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A hologram-mounted medium comprising:
visually readable identification information that is holographically formed to be visible within a predetermined angular range when illuminated at a predetermined angle; and
mechanically readable identification information that is holographically formed to be visible within a predetermined angular range when illuminated at a predetermined angle,
wherein the visually readable identification information and the mechanically readable identification information are associated with each other.

2. The hologram-mounted medium according to claim 1, wherein the visually readable identification information and the mechanically readable identification information are recorded in the same hologram.

3. The hologram-mounted medium according to claim 1, wherein the visually readable identification information and the mechanically readable identification information are respectively visible within predetermined angular ranges including a same angular direction when illuminated with a same reproduction illumination light beam.

4. The hologram-mounted medium according to claim 1, wherein the visually readable identification information and the mechanically readable identification information are respectively visible within predetermined angular ranges centered on angular directions different from each other when illuminated with reproduction illumination light beams different from each other.

5. The hologram-mounted medium according to claim 1, wherein the visually readable identification information and the mechanically readable identification information are visible within predetermined angular ranges centered on angular directions different from each other when illuminated with a same reproduction illumination light beam.

6. The hologram-mounted medium according to claim 1, wherein the visually readable identification information and the mechanically readable identification information are respectively visible within predetermined angular ranges including a same angular direction when illuminated with reproduction illumination light beams different from each other.

7. A roll-shaped medium having a plurality of holograms disposed on a same separator,
wherein the holograms include
visually readable identification information that is holographically formed to be visible within a predetermined angular range when illuminated at a predetermined angle, and
mechanically readable identification information that is holographically formed to be visible within a predetermined angular range when illuminated at a predetermined angle and that is associated with the visually readable identification information.

8. An information determination method comprising:
reading visually readable identification information and mechanically readable identification information from a hologram that includes the visually readable identification information, which is holographically formed to be visible within a predetermined angular range when illuminated at a predetermined angle, and the mechanically readable identification information which is holographically formed to be visible within a predetermined angular range when illuminated at a predetermined angle and that is associated with the visually readable identification information;
determining whether or not it is possible to recover the visually readable identification information, which is read, from the mechanically readable identification information, which is read, on the basis of the association between the visually readable identification information and the mechanically readable identification information; and
checking whether or not the visually readable identification information which is read is correct data.

9. A determination device comprising:
a light source that illuminates a reproduction illumination light beam at a predetermined angle onto a hologram that includes visually readable identification information, which is holographically formed to be visible within a predetermined angular range when illuminated at a predetermined angle, and mechanically readable identification information which is holographically formed to be visible within a predetermined angular range when illuminated at a predetermined angle and that is associated with the visually readable identification information;
an imaging device that captures an image, which is reproduced from the hologram, from a predetermined direction;
a recognition section that performs character recognition and/or image recognition on the image captured by the imaging device;
a determination section that determines whether or not it is possible to recover the visually readable identification information from the mechanically readable identification information which is obtained from the recognition section; and
a sorting section that separates a hologram, through which the determination section determines that the visually readable identification information is unrecoverable from the mechanically readable identification information, from a group of holograms through which the determination section determines that the visually readable identification information is recoverable from the mechanically readable identification information.

10. The determination device according to claim 9, further comprising
a data transceiving section that communicates with database in which the visually readable identification information recorded in the hologram is registered in advance,
wherein the determination section further determines whether or not the visually readable identification information obtained from the recognition section coincides with the visually readable identification information registered in the database, and
wherein the sorting section separates a hologram, through which the determination section determines that the visually readable identification information obtained from the recognition section does not coincide with the visually readable identification information registered in the database, from a group of holograms through which the determination section determines that the visually readable identification information obtained from the recognition section coincides with the visually readable identification information registered in the database.

11. A hologram-mounted medium producing apparatus comprising:
a light source that illuminates a reproduction illumination light beam at a predetermined angle onto a hologram that includes visually readable identification information, which is holographically formed to be visible within a predetermined angular range when illuminated at a predetermined angle, and mechanically readable identification information which is holographically formed to be visible within a predetermined angular range when illuminated at a predetermined angle and that is associated with the visually readable identification information;
an imaging device that captures an image, which is reproduced from the hologram, from a predetermined direction;
a recognition section that performs character recognition and/or image recognition on the image captured by the imaging device;
a determination section that determines whether or not it is possible to recover the visually readable identification information from the mechanically readable identification information which is obtained from the recognition section;
a sorting section that separates a hologram, through which the determination section determines that the visually readable identification information is unrecoverable from the mechanically readable identification information, from a group of holograms through which the determination section determines that the visually readable identification information is recoverable from the mechanically readable identification information; and
a bonding section that bonds and integrates the hologram, through which it is determined that the visually readable identification information is recoverable from the mechanically readable identification information, onto a medium on which identification information associated with the mechanically readable identification information or the visually readable identification information is recorded.

12. The hologram-mounted medium producing apparatus according to claim 11, further comprising
a data transceiving section that communicates with database in which the visually readable identification information recorded in the hologram is registered in advance,
wherein the determination section further determines whether or not the visually readable identification information obtained from the recognition section coincides with the visually readable identification information registered in the database, and
wherein the sorting section separates a hologram, through which the determination section determines that the visually readable identification information obtained from the recognition section does not coincide with the visually readable identification information registered in the database, from a group of holograms through which the determination section determines that the visually readable identification information obtained from the recognition section coincides with the visually readable identification information registered in the database.
